(19) United States
(12) Patent Application Publication
(10) Pub. No.: US 2026/0314643 A1
(43) Pub. Date: Oct. 15, 2026

(54) CRUDE TAHINI WITH EXTENDED SHELF LIFE AND COMPOSITIONS THEREOF

(71) Applicant: G. NOFAR FOOD AGENCY LTD., Haifa (IL)

(72) Inventor: Gil NOFAR, Haifa (IL)

(21) Appl. No.: 19/720,533

(22) Filed: Jun. 25, 2026

Related U.S. Application Data
(63) Continuation-in-part of application No. 18/260,603, filed on Jan. 6, 2022.
(60) Provisional application No. 63/134,592, filed on Jan. 7, 2021.
(60) Provisional application No. 63/221,499, filed on Jul. 14, 2021.

(51) Int. Cl. A23L 25/00

(52) U.S. Cl. CPC A23L 25/30

(57) ABSTRACT

An oily seed product, e.g., a crude tahini including a whole grain crude tahini, or processed olive product, includes a fiber-like particle population having curled structures characterized by a specific maximal straightness s50 value. A composition includes the oily seed product and probiotic bacteria, as well as a food product, additive or supplement, and medical food including the composition.

### CROSS REFERENCE TO RELATED APPLICATIONS

The present application is a continuation-in-part of U.S. patent application Ser. No. 18/260,603, filed Jul. 6, 2023, which is a 371 national stage application of PCT/IL2022/050022, filed Jan. 6, 2022, and claims the benefit of U.S. Provisional Patent Application No. 63/134,592, filed Jan. 7, 2021, and U.S. Provisional Patent Application No. 63/221,499, filed Jul. 14, 2021, now expired, the entire contents of each and all these applications being herewith incorporated by reference in their entirety as if fully disclosed herein.

### TECHNICAL FIELD

The present invention is in the field of food technology, and relates to an oily seed product, e.g., a crude tahini including a whole grain crude tahini, or processed olive product, comprising a fiber-like particle population having curled structures characterized by a specific maximal straightness s50 value, and compositions thereof.

### BACKGROUND

Sesame seeds are valued for their emulsifying qualities. Alternatively, or additionally, sesame seeds are valued for their amino acid profile, calcium and iron content, oil, polyphenols, and vitamins, which contribute to health benefit. As a result of these emulsifying qualities and/or health benefits, ground sesame seeds and/or sesame oil seeds are a common ingredient in cuisines of the middle east, USA and the far east.

Ground hulled sesame seeds are typically processed into a paste known as tahini. Tahini paste, which will be referred to hereinbelow as crude tahini, is often mixed with water to prepare a dip or spread which is also called tahini. In order to avoid confusion, this application will refer to the product prepared by mixing water with crude tahini as prepared tahini. In many cases, prepared tahini includes additional ingredients such as lemon juice, salt, pepper, and other seasonings, and/or antioxidants, anticaking agents and/or stabilizers.

Crude tahini contains essential nutrients, such as calcium, copper, manganese, protein, omega-3, omega-6, and fibers, yet relatively low in levels of sugar and saturated fats. Crude tahini is typically made by first separating the hulls from the seeds. In some cases, the hulls are left on the seeds or added back to the hulled seeds, and the resultant paste is referred to as whole crude tahini. The seeds are then roasted, and ground to produce crude tahini (in some cases, roasting is omitted and the resultant crude tahini is referred to as raw crude tahini).

Because tahini paste has a high oil content, oiling off (resulting from sedimentation of suspended solids in the tahini paste, and also referred to as “oil separation”) occurs during storage. When oiling off occurs, the paste separates into an oil phase and a solid sediment. Recombining the oil phase and the solid sediment after oiling off occurs is difficult.

### SUMMARY OF INVENTION

One aspect of some embodiments of the invention relates to microfluidization of oily seeds. In some embodiments, microfluidization produces a paste with a low viscosity (compared to a similar paste made by conventional grinding). In some embodiments, microfluidization is conducted after conventional grinding. In some exemplary embodiments of the invention, a leftward shift in a Particle Size Distribution (PSD) plot (compared to a similar paste made by conventional grinding) contributes to the reduction in viscosity. In other exemplary embodiments of the invention, the reduction in viscosity is independent of a change in PSD. According to various exemplary embodiments of the invention, microfluidization of oily seeds produces products specific to the type of oily seed employed. For example, one category of products is crude tahini. In some embodiments, microfluidized tahini has lower viscosity than tahini with a similar PSD. Another category of products is liquefied olives.

Another aspect of some embodiments of the invention relates to a method to produce tahini paste with an unusual PSD. According to various exemplary embodiments of the invention, the size below which 50%; 90%; 95%; 99% or 100% of particles fall is adjusted downwards. In some embodiments, microfluidization contributes to a decrease in particle size. In some embodiments, a shift in PSD slows down the oiling off process during storage and/or contributes to a reduction in viscosity. For purposes of this specification and the accompanying claims, the term “shelf life” indicates an amount of time before 12% of total volume of the crude tahini is separated oil at room temperature.

An additional aspect of some embodiments of the invention relates to preparing tahini by soaking the sesame seeds for an extended period of time before removing the hulls. According to various exemplary embodiments of the invention, the seeds are soaked for 1, 2, 4, 6, 8, 10, 12, 24, 16, 18, 20, 22, 24 or intermediate or greater number of hours. In some exemplary embodiments of the invention, soaking contributes to sprouting and/or production of GABA. In some embodiments, hulls are removed and then the peeled seeds are soaked.

A further additional aspect of some embodiments of the invention relates to drying crude tahini and/or prepared tahini to produce a powdered tahini product. In some embodiments, the powdered tahini product contains rice bran extract (RBE) or another emulsifier. According to various exemplary embodiments of the invention, the drying is carried out in a spray dryer, drum dryer, freeze dryer, infrared (IR) dryer, microwave, oven, vacuum oven, or vacuum spray dryer. According to various exemplary embodiments of the invention which employ RBE, the amount of RBE <12%, <11%, <10%, <9%, <8%, <7%, <6%, <5%, <4%, <3%, <2%, <1%, <0.1% or intermediate or lower percentages relative to the weight of crude tahini. Alternatively, or additionally, according to various exemplary embodiments of the invention which employ RBE, the amount of RBE >12%, >11%, >10%, >9%, >8%, >7%, >6%, >5%, >4%, >3%, >2%, >1%, >0.1% or intermediate or higher percentages relative to the weight of crude tahini.

Yet another aspect of some embodiments of the invention relates to the microfluidization of an emulsion prepared from crude tahini or a paste made from any nut or oily seed. In some embodiments, RBE contributes to a reduction in separation of the emulsion and/or to a shift in PSD. Alternatively, or additionally, in some embodiments the emulsion is dried to form a powder.

Still another aspect of some embodiments of the invention relates to a powderized paste prepared from any nut or oily seed via drying. In some embodiments, the drying is spray drying. In some embodiments, addition of water to the paste makes it more amenable to spray drying. In some exemplary embodiments of the invention, the nut or oily seed paste is microfluidized prior to drying. According to various exemplary embodiments of the invention, a PSD of the microfluidized product is determined by laser diffraction using water or ISOPAR G as a dispersant.

According to various exemplary embodiments, various aspects which are described individually for clarity are combined in pairs, triplets, quadruplets or combinations of greater numbers.

It will be appreciated that the various aspects described above relate to solution of technical problems associated with oiling off. Alternatively, or additionally, it will be appreciated that the various aspects described above relate to solution of technical problems associated with undesirable rheology characteristics of tahini among many consumers. Alternatively, or additionally, it will be appreciated that the various aspects described above relate to solution of technical problems related to bacterial contamination in crude tahini.

In some exemplary embodiments of the invention there is provided a crude tahini composition characterized by a PSD of 90% of less than 46 μm as measured by laser diffraction using a Malvern-Mastersizer 3000 Wet dispersion with Hydro EV cell with water as dispersant. In some embodiments, the crude tahini composition is characterized by a PSD of 90% of less than 55 μm as measured using a Malvern-Mastersizer 3000 Wet dispersion with Hydro EV cell with Isopar G as dispersant by laser diffraction. Alternatively, or additionally, in some embodiments the crude tahini composition is characterized by a PSD of 95% of less than 90 μm as measured by laser diffraction using water as a dispersant. Alternatively, or additionally, in some embodiments the crude tahini composition is characterized by a PSD of 95% of 80 μm or less as measured by laser diffraction using Isopar G as a dispersant. Alternatively, or additionally, in some embodiments the crude tahini composition is characterized by a PSD of 99% of less than 179 μm as measured by laser diffraction using water as a dispersant. Alternatively, or additionally, in some embodiments the crude tahini composition is characterized by a PSD of 99% of 180 μm or less as measured by laser diffraction using Isopar G as a dispersant. Alternatively, or additionally, in some embodiments the crude tahini composition is characterized by a PSD of 100% of less than 272 μm as measured by laser diffraction using water as a dispersant. Alternatively, or additionally, in some embodiments the crude tahini composition is characterized by a PSD of 100% of 98 μm or less as measured by laser diffraction using Isopar G as a dispersant. Alternatively, or additionally, in some embodiments the crude tahini composition is characterized by a viscosity cp SC4-21 at 5 RPM of 2110 or less. Alternatively, or additionally, in some embodiments the crude tahini composition is characterized by a viscosity cp SC4-21 at 11 RPM of less than 1770.

In some exemplary embodiments of the invention there is provided a whole grain (with hulls) crude tahini composition characterized by a PSD of 90% of less than 46 μm as measured by laser diffraction using a Malvern-Mastersizer 3000 Wet dispersion with Hydro EV cell with water as dispersant. In some embodiments the whole grain crude tahini composition is characterized by a PSD of 90% of 40 μm or less as measured by laser diffraction using water as a dispersant. Alternatively, or additionally, in some embodiments the whole grain crude tahini composition is characterized by a PSD of 95% of less than 117 μm as measured by laser diffraction using water as a dispersant. Alternatively, or additionally, in some embodiments the whole grain crude tahini composition is characterized by a PSD of 95% of 90 μm or less as measured by laser diffraction using water as a dispersant. Alternatively, or additionally, in some embodiments the whole grain crude tahini composition is characterized by a PSD of 99% of less than 181 μm as measured by laser diffraction using water as a dispersant. Alternatively, or additionally, in some embodiments the whole grain crude tahini composition is characterized by a PSD of 99% of 150 μm or less as measured by laser diffraction. Alternatively, or additionally, in some embodiments the whole grain crude tahini composition is characterized by a PSD of 100% of 270 μm or less as measured by laser diffraction using water as a dispersant. Alternatively, or additionally, in some embodiments the whole grain crude tahini composition is characterized by a PSD of 100% of 185 μm or less as measured by laser diffraction using water as a dispersant. Alternatively, or additionally, in some embodiments the whole grain crude tahini composition is characterized by a viscosity cp SC4-21 at 11 RPM of 1400 or less.

In some exemplary embodiments of the invention there is provided a crude tahini composition characterized by a PSD of 90% of less than 55 μm as measured by laser diffraction using a Malvern-Mastersizer 3000 Wet dispersion with Hydro EV cell with Isopar G as dispersant. In some embodiments the crude tahini composition is characterized by a PSD of 90% of 40 μm or less as measured by laser diffraction using Isopar G as a dispersant. Alternatively, or additionally, in some embodiments the crude tahini composition is characterized by a PSD of 95% of less than 80 μm as measured by laser diffraction using Isopar G as a dispersant. Alternatively, or additionally, in some embodiments the crude tahini composition is characterized by a PSD of 95% of 70 μm or less as measured by laser diffraction using Isopar G as a dispersant. Alternatively, or additionally, in some embodiments the crude tahini composition is characterized by a PSD of 99% of less than 117 μm as measured by laser diffraction using Isopar G as a dispersant. Alternatively, or additionally, in some embodiments the crude tahini composition is characterized by a PSD of 99% of 90 μm or less as measured by laser diffraction using Isopar G as a dispersant. Alternatively, or additionally, in some embodiments the crude tahini composition is characterized by a PSD of 100% of less than 160 μm as measured by laser diffraction using Isopar G as a dispersant. Alternatively, or additionally, in some embodiments the crude tahini composition is characterized by a PSD of 100% of 120 μm μm or less as measured by laser diffraction using Isopar G as a dispersant. Alternatively, or additionally, in some embodiments the crude tahini composition is characterized by a viscosity cp SC4-21 at 5 RPM of less than 2100. Alternatively, or additionally, in some embodiments the crude tahini composition is characterized by a viscosity cp SC4-21 at 11 RPM of less than 1700.

In some exemplary embodiments of the invention there is provided a whole grain (with hulls) crude tahini composition characterized by a PSD of 90% of less than 72 μm as measured by laser diffraction using a Malvern-Mastersizer 3000 Wet dispersion with Hydro EV cell with ISOPAR G as dispersant. In some embodiments the whole grain crude tahini composition is characterized by a PSD of 90% of 55 μm or less as measured by laser diffraction using ISOPAR G as dispersant. Alternatively, or additionally, in some embodiments the whole grain crude tahini composition is characterized by a PSD of 95% of less than 101 μm as measured by laser diffraction using ISOPAR G as dispersant. Alternatively, or additionally, in some embodiments the whole grain crude tahini composition is characterized by a PSD of 95% of 80 μm or less as measured by laser diffraction using ISOPAR G as dispersant. Alternatively, or additionally, in some embodiments the whole grain crude tahini composition is characterized by a PSD of 99% of less than 143 μm as measured by laser diffraction using ISOPAR G as dispersant. Alternatively, or additionally, in some embodiments the whole grain crude tahini composition is characterized by a PSD of 99% of 120 μm or less as measured by laser diffraction using ISOPAR G as dispersant. Alternatively, or additionally, in some embodiments the whole grain crude tahini composition is characterized by a PSD of 100% of less than 184 μm as measured by laser diffraction using ISOPAR G as dispersant. Alternatively, or additionally, in some embodiments the whole grain crude tahini composition is characterized by a PSD of 100% of 165 μm or less as measured by laser diffraction using ISOPAR G as dispersant. Alternatively, or additionally, in some embodiments the whole grain crude tahini composition is characterized by a viscosity cP SC4-21 at 11 RPM of less than 1417.

In some exemplary embodiments of the invention there is provided a method including microfluidizing crude tahini at a pressure of at least 5,000 PSI. In some embodiments the crude tahini includes whole crude tahini (with hulls). Alternatively, or additionally, in some embodiments the method includes preparing the crude tahini from sesame seeds. Alternatively, or additionally, in some embodiments the preparing crude tahini includes grinding in a ball mill. Alternatively, or additionally, in some embodiments the preparing crude tahini includes grinding with millstones or Macintyre (as used in the chocolate industry) or a Reifiner Conche. According to various exemplary embodiments of the invention, the crude tahini is ground sufficiently fine so that it can be processed by microfluidizing machinery (a cold-pressed oil derived from sesame seeds or other oily seeds may optionally be added prior to, during, or after grinding).

In some exemplary embodiments of the invention there is provided method of producing crude tahini including soaking sesame seeds in water for a minimum of 1 hours; and grinding to produce tahini paste. In some embodiments the method includes removing hulls from the sesame seeds. Alternatively, or additionally, in some embodiments, sesame hulls are added prior to grinding.

Alternatively, or additionally, in some embodiments the method includes roasting the sesame seeds. Alternatively, or additionally, in some embodiments the method includes microfluidizing the tahini paste. Alternatively, or additionally, in some embodiments grinding must produce particle sizes in conformity with an entrance of the first microfluidization tube.

In some exemplary embodiments of the invention there is provided a method including: (a) mixing crude tahini and water to produce an emulsion; and (b) microfluidizing said crude tahini or said emulsion at a pressure of at least 5,000 PSI. In some embodiments, the method includes: (c) spray drying the emulsion to produce powderized tahini. In some exemplary embodiments of the invention there is provided a method including: (a) mixing crude tahini and water to produce an emulsion; and (b) spray drying the emulsion to produce powderized tahini. In some embodiments of these methods, the method includes dissolving RBE <12% of the weight of the crude tahini in the water. Alternatively, or additionally, in some embodiments of these methods the spray drying employs a Niro dryer with a height of 3M and an entrance temperature of 200° C. to 210° C. Alternatively, or additionally, in some embodiments of these methods the spray drying employs a Niro dryer with a height of 3M and an exit temperature of 110° C. or less. Alternatively, or additionally, in some embodiments the spray drying employs a vacuum spray dryer and/or drum dryer.

The method covers four separate possibilities. The first possibility is microfluidization of crude tahini followed by mixing with water to form an initial emulsion, which is then microfluidized again and then dried to produce powderized tahini. The second possibility is mixing crude tahini with water to produce emulsion, followed by microfluidization and drying to produce powderized tahini. The third possibility is microlfluidizing crude tahini and (in parallel or before) mixing water with RBE <12% of the weight of crude tahini. In some embodiments, another emulsifier is used instead of RBE. In some embodiments, this mixture of water and RBE is heated, optionally boiled, and then cooled. The microfluidized tahini is then mixed with the water/RBE solution to produce an emulsion. In some embodiments, the emulsion is microfluidized then dried. In other exemplary embodiments of the invention, emulsion is dried directly. In either case, the result is powderized tahini. The fourth possibility is mixing RBE <12% of the weight of crude tahini with water. In some embodiments, another emulsifier is used instead of RBE. In some embodiments, this mixture of water and RBE is heated, optionally boiled, and then cooled. Crude tahini is then added to the water/RBE mixture to produce an emulsion which is either dried directly, or microfluidized and then dried. In either case, the result is powderized tahini.

In some exemplary embodiments of the invention there is provided a powder composition including a spray-dried microfluidized emulsion comprising crude tahini and water. In some exemplary embodiments of the invention there is provided a powder composition including a spray-dried emulsion comprising crude tahini and water. In some embodiments, these compositions include RBE. Alternatively, or additionally, in some embodiments these compositions include seasonings and/or antioxidants and/or anticaking agents and/or stabilizers and/or acids.

In some exemplary embodiments of the invention there is provided method including: (a) grinding seeds to produce a paste; (b) mixing the paste and water to produce a pre-mix; (c) microfluidizing the paste and/or emulsion at a pressure of at least 5,000 PSI; and (d) spray drying to produce a powderized oily seed composition. In some exemplary embodiments of the invention, both the paste and the emulsion are microfluidized.

In some exemplary embodiments of the invention there is provided a method including: (a) grinding oily seeds to produce a paste; (b) mixing the paste and water to produce a pre-mix; and (c) spray drying the pre-mix to produce a powderized oily seed composition. In some embodiments these methods include dissolving RBE <12% of the weight of the oily seeds in the water. In other exemplary embodiments of the invention, other emulsifiers such as lecithin or monoglycerides or diglycerides or TWEEN or saponin or polysorbate are used instead of RBE.

According to various exemplary embodiments of the invention other emulsifiers are used in place of RBE.

In some exemplary embodiments of the invention there is provided a powder composition including a spray-dried microfluidized homogenate, said homogenate including oily seeds and water. In some exemplary embodiments of the invention there is provided a powder composition including a spray-dried homogenate, wherein said homogenate comprises oily seeds and water. In some embodiments these compositions include RBE. In other exemplary embodiments of the invention, other emulsifiers such as monoglycerides or diglycerides or TWEEN or saponin or polysorbate are used instead of RBE. Alternatively, or additionally, in some embodiments these compositions include seasonings and/or antioxidants and/or anticaking agents.

The method covers four separate possibilities. The first possibility is microfluidization of paste followed by mixing with water to form a premix which is then microfluidized and then dried to produce powderized oily seeds. The second possibility is mixing paste with water to produce premix followed by microfluidization and drying. The third possibility is microfluidizing paste and (in parallel or before) mixing water with RBE <12% of the weight of paste. In some embodiments, another emulsifier is used instead of RBE. In some embodiments, this mixture of water and RBE is heated, optionally boiled, and then cooled. The microfluidized paste is then mixed with the water/RBE solution to produce premix. In some embodiments, the premix is microfluidized then dried. In other exemplary embodiments of the invention, premix is dried directly. In either case, the result is powderized oily seeds. The fourth possibility is mixing RBE <12% of the weight of paste with water. In some embodiments, another emulsifier is used instead of RBE. In some embodiments, this mixture of water and RBE is heated, optionally boiled, and then cooled. Paste is then added to the water/RBE mixture to produce premix which is either dried directly, or microfluidized and then dried. In either case, the result is powderized oily seeds.

In some exemplary embodiments of the invention there is provided a crude tahini composition with a viscosity cp SC4-21 at 5 RPM of 2050 or less or 2000 or less. In some embodiments viscosity cP SC4-21 at 5 RPM is 1700 or less or 1500 or less. Alternatively, or additionally, in some embodiments the viscosity cp SC4-21 at 11 RPM is less than 1796, less than 1750, less than 1633, less than 1400, less than 1000 or intermediate or lower values.

In some exemplary embodiments of the invention there is provided a whole grain crude tahini composition having a viscosity cp SC4-21 at 11 RPM of 1795, 1633 or less, 1400 or less, 1300 or less or intermediate or lower values.

In some exemplary embodiments of the invention there is provided a method including: (a) mixing a paste of oily seeds and water to produce a pre-mix; and (b) microfluidizing said paste and/or said premix at a pressure of at least 5,000 PSI. In some embodiments, the method includes grinding the oily seeds to produce a paste. Alternatively, or additionally, in some embodiments the method includes spray drying to produce a powderized oily seed composition. Alternatively, or additionally, in some embodiments the oily seeds include sesame seeds.

In some exemplary embodiments of the invention there is provided a method including: (a) treating pitted fresh olives with an alkaline reagent; (b) rinsing the olives with water to reduce the pH; and (c) microfluidizing the olives to produce a paste. In some embodiments, the method includes adding oil to the paste. Alternatively, or additionally, in some embodiments the method includes grinding the olives. Alternatively, or additionally, in some embodiments the method includes adding oil prior to microfluidizing.

In some exemplary embodiments of the invention there is provided a method including: (a) removing seed fragments from olive pomace to produce smooth pomace; (b) heating the smooth pomace to produce dried smooth pomace; and (c) microfluidizing the dried smooth pomace. In some embodiments, the method includes adding oil to the microfluidized dried smooth pomace. Alternatively, or additionally, in some embodiments the method includes grinding the smooth pomace or the dried smooth pomace. Alternatively, or additionally, in some embodiments the method includes adding oil prior to the microfluidizing.

In some exemplary embodiments of the invention there is provided a processed olive composition characterized by a PSD of 90% of less than 50 μm as measured by laser diffraction using a Malvern-Mastersizer 3000 Wet dispersion with Hydro EV cell with Isopar G as dispersant.

In some exemplary embodiments of the invention there is provided a processed olive composition characterized by a PSD of 50% of less than 20 μm as measured by laser diffraction using a Malvern-Mastersizer 3000 Wet dispersion with Hydro EV cell with Isopar G as dispersant. In some embodiments, the processed olive composition(s) as described above is characterized by a viscosity cp SC4-21 at 5 RPM of 490 or less. Alternatively, or additionally, in some embodiments the processed olive composition(s) as described above is characterized by a viscosity cp SC4-21 at 11 RPM of 400 or less.

In some exemplary embodiments of the invention there is provided a whole grain crude tahini composition having at least 13% crude fiber in a proximate analysis and characterized by a PSD of 90% of less than 100 μm as measured by laser diffraction using a Malvern-Mastersizer 3000 Wet dispersion with Hydro EV cell with ISOPAR G as dispersant. In some embodiments, the whole grain crude tahini composition is characterized by a PSD of 50% of less than 7.8 μm as measured by laser diffraction. Alternatively, or additionally, in some embodiments the whole grain crude tahini composition is characterized by a viscosity cP SC4-21 at 11 RPM of less than 3000 and/or by a viscosity cP SC4-21 at 5 RPM of less than 3800.

In some exemplary embodiments of the invention there is provided a crude tahini composition which is perceived in organoleptic testing as not sticky or not grabbing the mouth even after mixing with saliva.

In some exemplary embodiments of the invention there is provided a method including: (a) microfluidizing crude tahini to produce microfluidized crude tahini; and (b) removing oil from the microfluidized crude tahini. In some embodiments, removing oil includes centrifuging the microfluidized crude tahini. Alternatively, or additionally, in some embodiments the removing oil removes at least 10% of the oil.

In some exemplary embodiments of the invention there is provided a reduced fat microfluidized crude tahini composition having a viscosity cp SC4-21 at 11 RPM of 2268 or less. Alternatively, or additionally, in some exemplary embodiments of the invention there is provided a reduced fat microfluidized crude tahini composition having a viscosity CP SC4-21 at 5 RPM of or less. According to various exemplary embodiments of the invention, the reduced fat tahini composition has 10%, 15%, 20%, 25% or 30%, or intermediate or higher percentages, less fat compared to standard tahini from which it is prepared.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Percentages (%) and/or ratios of crude tahini and water are expressed in terms of weight unless otherwise indicated.

### BRIEF DESCRIPTION OF DRAWINGS

In order to understand the invention and to see how it may be carried out in practice, embodiments will now be described, by way of non-limiting example only, with reference to the accompanying figures. In the figures, identical and similar structures, elements, or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1A is a simplified flow diagram of an analysis scheme according to some exemplary embodiments of the invention.

FIG. 1B is a plot of volume density % as a function of size in μm for “Har Bracha” crude tahini analyzed by laser diffraction (details of assay conditions are provided herein below) using Isopar G as a dispersant.

FIG. 1C is a plot of volume density % as a function of size in μm for crude tahini Har Bracha 0 after microfluidization according to an exemplary embodiment of the invention as in FIG. 1B analyzed by laser diffraction using ISOPAR G as a dispersant.

FIG. 2A is a plot of volume density % as a function of size in μm for “Nesher” whole crude tahini analyzed by laser diffraction (details of assay conditions are provided hereinbelow) using Isopar G as a dispersant.

FIG. 2B is a plot of volume density % as a function of size in μm for “Nesher” whole crude tahini after microfluidization according to an exemplary embodiment of the invention as in FIG. 2A.

FIG. 3A is a plot of volume density % as a function of size in μm for “Har Bracha” crude tahini analyzed by laser diffraction (details of assay conditions are provided hereinbelow) using water as a dispersant.

FIG. 3B is a plot of volume density % as a function of size in μm for “Har Bracha” crude tahini after microfluidization according to an exemplary embodiment of the invention as in FIG. 3A.

FIG. 4A is a plot of volume density % as a function of size in μm for “Nesher” whole crude tahini analyzed by laser diffraction (details of assay conditions are provided hereinbelow) using water as a dispersant.

FIG. 4B is a plot of volume density % as a function of size in μm for “Nesher” whole crude tahini after microfluidization according to an exemplary embodiment of the invention as in FIG. 4A.

FIG. 5A is a plot of volume density % as a function of size in μm for “RIBUS rice bran extract” analyzed by laser diffraction (details of assay conditions are provided hereinbelow) using water as a dispersant.

FIG. 5B is a plot of volume density % as a function of size in μm for “RIBUS rice bran extract” whole crude tahini (mixed with water 1:10, with the water containing the RBE) after microfluidization according to an exemplary embodiment of the invention as in FIG. 5A.

FIG. 6 is a plot of volume density % as a function of size in μm for “powdered tahini” according to an exemplary embodiment of the invention analyzed by laser diffraction (details of assay conditions are provided hereinbelow) using water as a dispersant.

FIG. 7 is a simplified flow diagram of a method according to some exemplary embodiments of the invention.

FIG. 8 is a simplified flow diagram of a method according to some exemplary embodiments of the invention.

FIG. 9 is a photograph of samples of prepared tahini made from microfluidized crude tahini according to an exemplary embodiment of the invention and prepared tahini made from control crude tahini after heating.

FIG. 10 is a photograph of samples of microfluidized crude tahini according to an exemplary embodiment of the invention and control crude tahini at room temperature illustration their interaction with a glass container.

FIG. 11A is a plot of volume density % as a function of size in μm for whole grain crude tahini (Har Bracha) analyzed by laser diffraction (details of assay conditions are provided hereinbelow) using ISOPAR G as a dispersant.

FIG. 11B is a plot of volume density % as a function of size in μm using ISOPAR G as a dispersant for the same whole crude tahini (Har Bracha) as in FIG. 11A after microfluidization according to an exemplary embodiment of the invention.

FIG. 11C is a plot of volume density % as a function of size in μm using laser diffraction with ISOPAR G as a dispersant for the same whole crude tahini (Har Bracha) as in FIG. 11A after microfluidization according to another exemplary embodiment of the invention.

FIG. 11D is a plot of volume density % as a function of size in μm using laser diffraction with ISOPAR G as a dispersant for the same whole crude tahini (Har Bracha) as in FIG. 11A after microfluidization according to still another exemplary embodiment of the invention.

FIG. 12 is a plot of volume density % as a function of size in μm using laser diffraction with ISOPAR G as a dispersant for liquefied pitted olives after microfluidization according to an exemplary embodiment of the invention.

FIG. 13 is a plot of volume density % as a function of size in μm for crude tahini Har Bracha 2 after microfluidization according to an exemplary embodiment of the invention analyzed by laser diffraction using ISOPAR G as a dispersant.

FIG. 14 is a plot of volume density % as a function of size in μm analyzed by laser diffraction using ISOPAR G as a dispersant for “Har Bracha 1” crude tahini after microfluidization according to an exemplary embodiment of the invention.

FIG. 15 is a plot of volume density % as a function of size in μm for microfluidized crude tahini Har Bracha 3 as in FIG. 13 analyzed by laser diffraction using ISOPAR G as a dispersant.

FIG. 16 is a simplified flow diagram of a method according to some exemplary embodiments of the invention.

FIG. 17 is a simplified flow diagram of a method according to some exemplary embodiments of the invention.

FIG. 18 is a plot of volume density % as a function of size in μm for “RGM SQUEEZE 3 supersal” crude tahini analyzed by laser diffraction (details of assay conditions are provided herein below) using Isopar G as a dispersant.

FIG. 19 is a plot of volume density % as a function of size in μm for “With hulls ROSHDI 2 SQUEEZE crude tahini analyzed by laser diffraction (details of assay conditions are provided herein below) using Isopar G as a dispersant.

FIG. 20 is a plot of volume density % as a function of size in μm for “ROSHDI 1 SQUEEZE” crude tahini analyzed by laser diffraction (details of assay conditions are provide herein below) using Isopar G as a dispersant. Source data for plots of volume density % as a function of size in μm is provided in an appendix at the end of the specification. This appendix is an integral part of the application.

FIGS. 21A-21B show the cumulative PSD curves Q₃ (×) in % for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7” (21A), and for the whole grain crude tahini samples referred to herein as “M21” and “M6 21” (21B), where particle size is expressed as LEFI (the length of the particle).

FIGS. 22A-22B show the density distribution curves q_{31g} (×) for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7” (22A), and for the whole grain crude tahini samples referred to herein as “M21” and “M6 21” (22B), where particle size is expressed as LEFI (the length of the particle).

FIGS. 23A-23B show the cumulative PSD curves Q₃(×) in % for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7” (23A), and for the whole grain crude tahini samples referred to herein as “M21” and “M6 21” (23B), where particle size is expressed as DIFI (the thickness of the particle).

FIGS. 24A-24B show the density distribution curves q_{31g} (×) for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7” (24A), and for the whole grain crude tahini samples referred to herein as “M21” and “M6 21” (24B), where particle size is expressed as DIFI (the thickness of the particle).

FIGS. 25A-25B show the cumulative distribution of straightness values observed for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7”, together with an example illustrating the straightness value at 40% of the particle volume for one sample (25A); and the straightness over particle size (LEFI) observed for said samples (25B; the X axis is logarithmic and increases in increments of 20, from 20 to 200).

FIGS. 26A-26C show the cumulative distribution of straightness values for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7” (26A), and for the whole grain crude tahini samples referred to herein as “M21” and “M6 21” (26B), with a horizontal reference line at 40% particle volume and vertical reference lines indicating corresponding straightness values for selected samples; as well as the straightness over particle size (LEFI) observed for said whole grain crude tahini samples (26C; the X axis is logarithmic and increases in increments of 20, from 20 to 200).

FIGS. 27A-27B show the cumulative distribution of elongation values for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7” (27A), and for the whole grain crude tahini samples referred to herein as “M21” and “M6 21” (27B).

FIGS. 28A-28B shows elongation over particle size (LEFI) for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7” (28A), and for the whole grain crude tahini samples referred to herein as “M21” and “M6 21” (28B). In both figures, the X axis is logarithmic and increases in increments of 20, from 20 to 200.

FIGS. 29-34 demonstrate excerpts from the particle gallery, showing fiber-like particles observed in the crude tahini samples referred to herein as “From 2021 Process 1”, “Homogenaze Processing End 2 Homo No MFL”, “MFL 87 4”, “Regular Tahini 5”, “MFL Homo 6”, and “Before MFL USA Homo (1) 7”, respectively.

FIGS. 35-36 demonstrate excerpts from the particle gallery, showing fiber-like particles observed in the crude tahini samples referred to herein as “M21” and “M6 21”, respectively.

### DETAILED DESCRIPTION

Embodiments of the invention relate to improved crude tahini compositions and methods of producing them, as well as to products and methods which employ other oily seeds (e.g., olives). Microfluidization is a common technical feature of many embodiments of the invention. Specifically, some embodiments of the invention can be used to produce tahini characterized by a leftward shift in PSD and/or an exceptionally long shelf life. The principles and operation of compositions and/or methods according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

TABLE 1
PSD of Microfluidized and control crude tahini using Isopar
G as a dispersant with corresponding viscosities
CONTROL

| | No Hulls | | | | | | | | |
|---|---|---|---|---|---|---|---|---|---|
| | | | | | | Viscosity CP SC4-21 (cP) | | | |
| | Particle Size Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |
| Har Bracha | 6.62 | 108 | 141 | 188 | 239 | 5750 | 2780 | 2268 | 2002 |
| Nesher Dak | 7.59 | 90 | 116 | 155 | 186 | ND | ND | ND | ND |
| Roshdi 1 squeeze | 7.21 | 64.9 | 91.5 | 128 | 163 | 3800 | 2110 | 1777 | 1602 |
| RGM 3 squeeze | 6.49 | 55.2 | 80.2 | 118 | 162 | 5900 | 3380 | 2845 | EEE |
| supersal | | | | | | | | | |
| MEAN | 6.98 | 79.53 | 107.2 | 147.3 | 187.5 | 5183.3 | 2756.7 | 2296.7 | 1802 |
| HIGH | 7.59 | 108 | 141 | 188 | 239 | 5750 | 3380 | 2875 | 2002 |
| LOW | 6.49 | 55.2 | 80.2 | 118 | 162 | 3800 | 2110 | 1777 | 1602 |
| | With Hulls | | | | | | | | |
| | | | | | | Viscosity CP SC4-21 (cP) | | | |
| | Particle Size Distribution (PSD) μm | | | | | 1 rpm | 5 rpm | 11 rpm | 22 rpm |
| | 50% | 90% | 95% | 99% | 100% | Shear1 | shear 5 | shear10 | shear20 |
| Nesher R | 8.24 | 107 | 140 | 188 | 239 | 10250 | 5480 | 4350 | EEE |
| Roshdi 2 squeeze | 7.18 | 72.4 | 102 | 143 | 185 | 3250 | 1730 | 1418 | 1259 |
| MEAN | 7.71 | 89.7 | 121 | 165.5 | 212 | 6750 | 3605 | 2884 | NA |
| HIGH | 8.24 | 107 | 140 | 188 | 239 | 10250 | 5480 | 4350 | NA |
| LOW | 7.18 | 72.4 | 102 | 143 | 185 | 3250 | 1730 | 1418 | NA |

Microfluidized

| | | | | | | Viscosity CP SC4-21 (cP) | | | |
|---|---|---|---|---|---|---|---|---|---|
| | Particle Size Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |

No Hulls

| | | | | | | | | | |
|---|---|---|---|---|---|---|---|---|---|
| ***Har Bracha 0 | 4.72 | 23.5 | 36.9 | 55.8 | 75.9 | 3700 | 1610 | 1232 | 1057 |
| **Har Bracha 1 | 5 | 29.5 | 46.8 | 72.5 | 97.9 | 2000 | 900 | 700 | 662.5 |
| *Har Bracha 2 | 3.75 | 10.2 | 12.3 | 15.9 | 18.7 | ND | ND | ND | ND |
| *Har Bracha 3 | 3.7 | 7.25 | 8.24 | 9.8 | 11.2 | 2950 | 1260 | 940 | 790 |
| MEAN | 4.30 | 17.61 | 26.06 | 38.5 | 50.933 | 2883 | 1257 | 957 | 837 |
| | | | | | | N = 3 | N = 3 | N = 3 | N = 3 |
| HIGH | 5 | 23.5 | 46.8 | 72.5 | 97.9 | 3700 | 1610 | 1232 | 1057 |
| LOW | 3.7 | 7.25 | 8.24 | 9.8 | 11.2 | 2000 | 900 | 700 | 662.5 |

With Hulls

| | | | | | | | | | | |
|---|---|---|---|---|---|---|---|---|---|---|
| Nesher | YES | 5.66 | 39.9 | 54.5 | 75.1 | 98 | 4100 | 1820 | 1295 | ND |

*Microfluidization in LAB-PILOT m110-EH3 2X (200 μm entrance/200 μm exit) followed by 2X (200 μm entrance/100 μm exit) at 20,000-25,000 PSI. The difference between the machines is only in their processing rate.
**Microfluidization in LAB-PILOT m110-EH3 2X (200 μm entrance/200 μm exit) followed by 1X (200 μm entrance/100 μm exit) at 20,000-25,000 PSI.
***Microfluidization in LAB-PILOT M-110P 1X (400 μm entrance/200 μm exit) followed by 2X (200 μm entrance/200 μm exit) followed by 3X (200 μm entrance/87μm exit)at 20,000-25,000 PSI. The difference between the machines is only in their processing rate.

### Overview

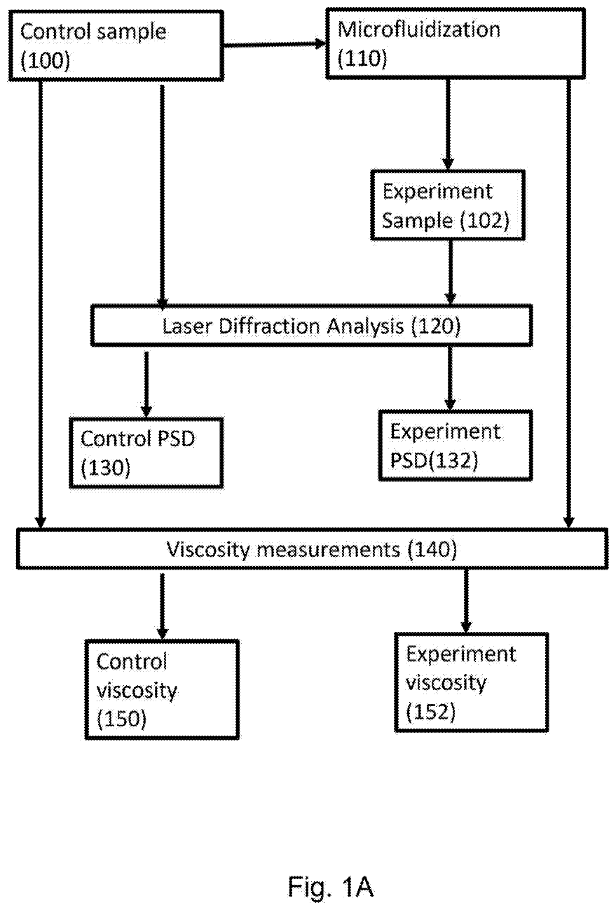

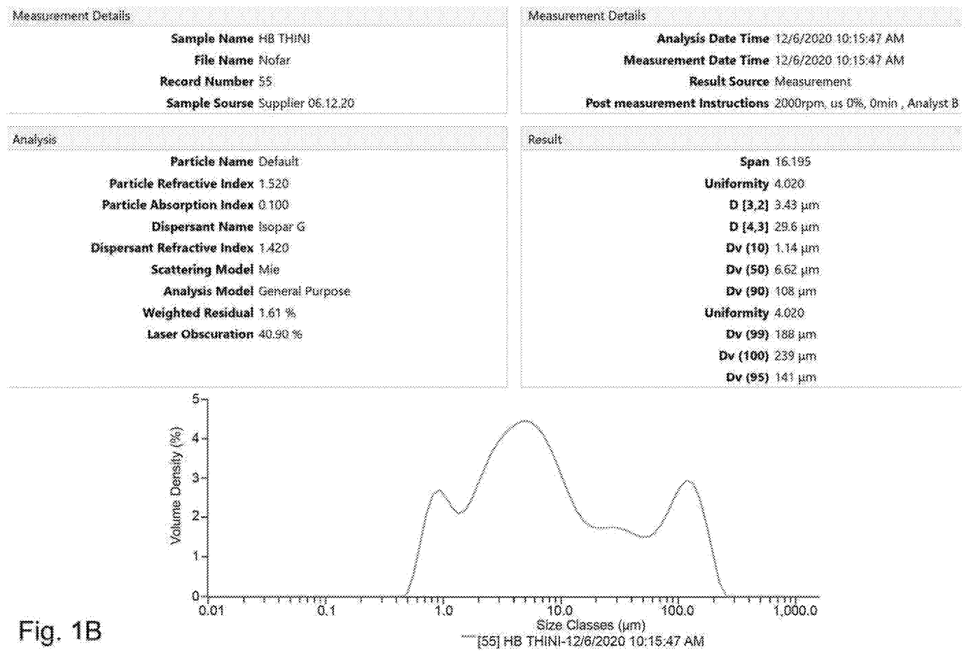

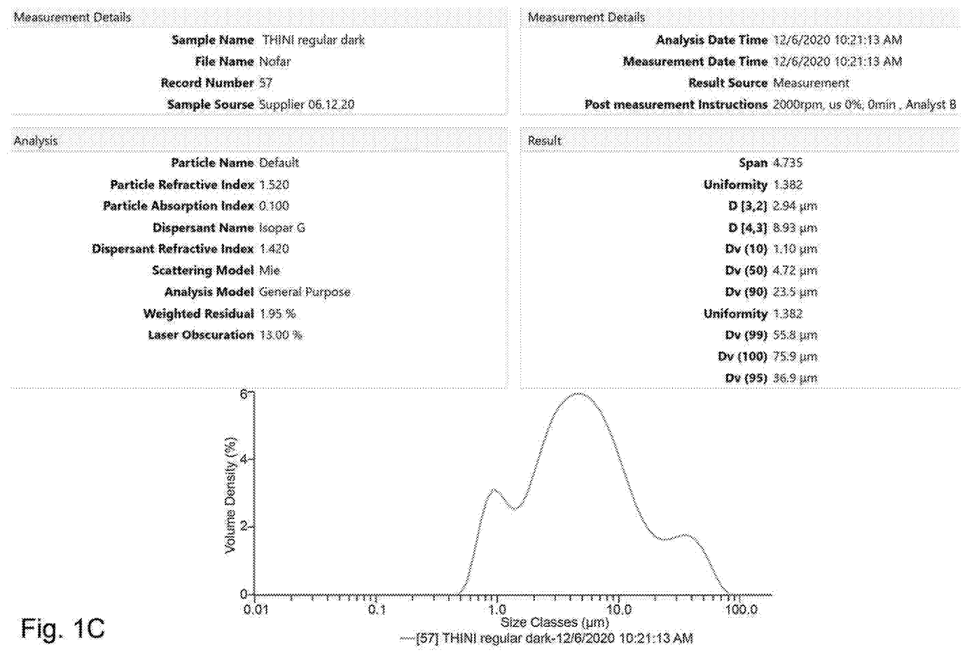

FIG. 1A is a simplified flow diagram of an analysis scheme according to some exemplary embodiments of the invention. FIG. 1A shows that a control sample 100 is microfluidized 110 to produce an experimental sample 102. Samples 100 and 102 are each subjected to laser diffraction analysis 120 to produce control and experimental PSD (130 and 132 respectively). An exemplary microfluidization protocol 110 and the laser diffraction analysis protocol 120 are presented hereinbelow. In the Figure set: FIGS. 1B, 2A, 3A, 4A, 5A, 11A, 18, 19, and 20 depict control PSDs 130; and FIGS. 1C, 2B, 3B, 4B, 5B, 6, 11B, 11C, and 11D depict experimental PSDs 132. Samples 100 and 102 were also subjected to viscosity measurements 140 to produce control viscosity data 150 and experimental viscosity data 152. PSD and viscosity data are summarized in Tables 1-4.

TABLE 1B
Viscosity of some of the samples referred to in Table 1A, determined
by HR-2 Discovery Hybrid Rheometer

| | Viscosity [pascal seconds | | |
|---|---|---|---|
| Sample | (Pa · sec)] | Rate index | R² |
| RGM 3 squeeze supersal | 3.01832 | 0.89979 | 0.99977 |
| Roshdi 1 squeeze | 2.97389 | 0.92450 | 0.99967 |

### Exemplary Crude Tahini

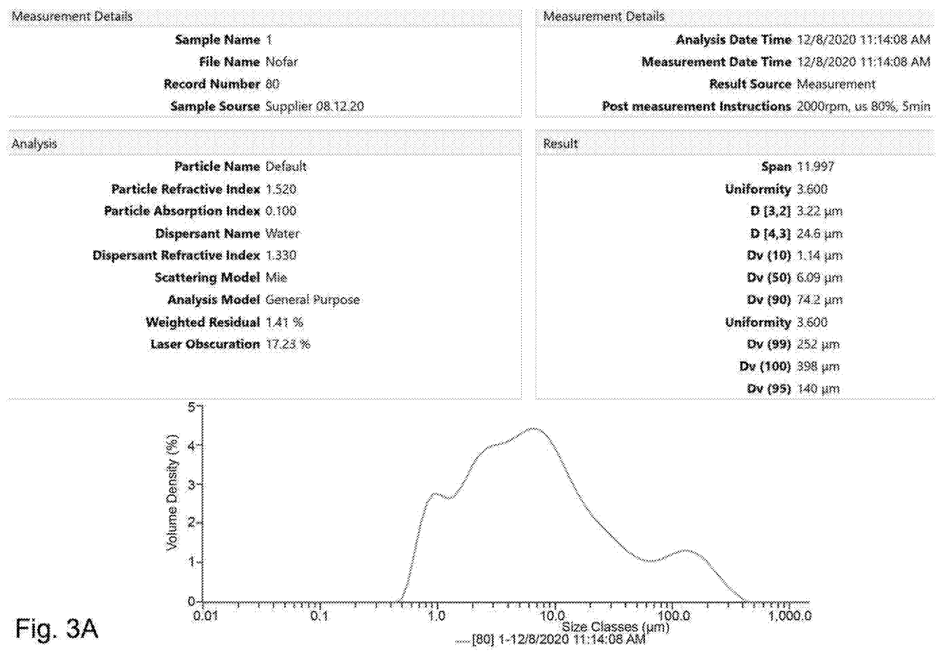

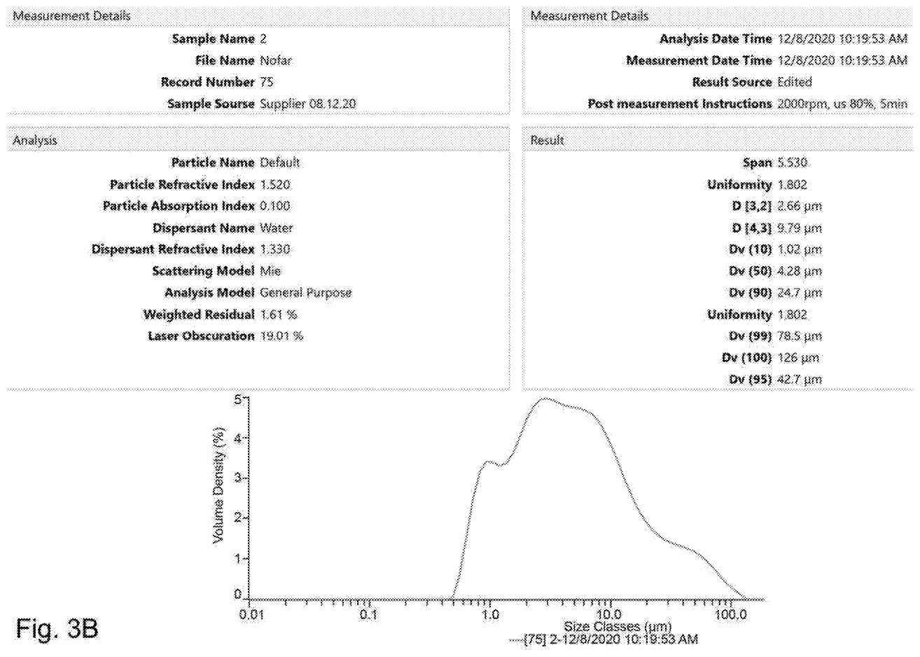

FIG. 3A and FIG. 3B illustrate graphically the effect of microfluidization (110 in FIG. 1) on PSD of crude tahini as measured by laser diffraction using water as a dispersant. Results are summarized numerically in Table 2.

Some exemplary embodiments of the invention relate to a crude tahini composition characterized by a PSD of 90% of less than 46 μm as measured by laser diffraction using a Malvern-Mastersizer 3000 Wet dispersion with Hydro EV cell with water as the dispersant. In some exemplary embodiments of the invention, the crude tahini composition is characterized by a PSD of 90% of less than 36 μm, of less than 33 μm, of less than 30 μm, of less than 27 μm, of less than 25 μm, or lesser or intermediate sizes as measured by laser diffraction.

Alternatively, or additionally, in some embodiments, the crude tahini composition is characterized by a PSD of 95% of less than 90 μm as measured by laser diffraction. According to various exemplary embodiments of the invention, the crude tahini composition is characterized by a PSD of 95% of 60 μm or less; 56 μm or less; 52 μm or less; 47 μm or less; 43 μm or less or intermediate or smaller sizes as measured by laser diffraction.

TABLE 2
PSD of Microfluidized and control crude tahini using
water as a dispersant with corresponding viscosities

| | | | | | | Viscosity CP SC4-21 (cP) | | | |
|---|---|---|---|---|---|---|---|---|---|
| | Particle Sized Distribution (PSD) μm | | | | | 1 rpm | 5 rpm | 11 rpm | 22 rpm |
| material | 50% | 90% | 95% | 99% | 100% | Shear1 | shear 5 | shear10 | shear20 |

Control

| | No Hulls | | | | | | | | |
|---|---|---|---|---|---|---|---|---|---|
| Har Bracha | 6.09 | 74.2 | 140 | 252 | 398 | 5750 | 2780 | 2268 | 2002 |
| Nesher Dak R | 5.82 | 51.9 | 99.5 | 196 | 309 | ND | ND | ND | ND |
| Roshdi R1 squeeze | 6.31 | 53.5 | 95.8 | 179 | 308 | 3800 | 2110 | 1777 | 1602 |
| RGM R 3 squeeze | 6.32 | 46.7 | 90.7 | 179 | 272 | 5900 | 3380 | 2845 | EEEE |
| supersal | | | | | | | | | |
| MEAN | 6.14 | 56.58 | 106.5 | 201.5 | 321.75 | 5183.3 | 2756.67 | 2296.67 | 1802 |
| HIGH | 6.32 | 74.2 | 140 | 252 | 398 | 5900 | 3380 | 2875 | 2002 |
| LOW | 5.82 | 46.7 | 90.7 | 179 | 272 | 3800 | 2110 | 1777 | 1602 |
| | With Hulls | | | | | | | | |
| Roshdi Whole | 6.43 | 68.6 | 117 | 182 | 271 | 3200 | 1730 | 1418 | 1259 |
| Grain 2 squeeze | | | | | | | | | |
| Nesher Whole | 9.51 | 315 | 472 | 746 | 1100 | 10250 | 5480 | 4350 | EEEE |
| Grain | | | | | | | | | |
| MEAN | 7.97 | 191.8 | 294.5 | 464 | 685.5 | 6725 | 3605 | 2884 | NA |
| HIGH | 9.51 | 315 | 472 | 746 | 1100 | 10250 | 5480 | 4350 | NA |
| LOW | 6.43 | 68.6 | 117 | 182 | 271 | 3200 | 1730 | 1418 | NA |

Microfluidized

| | | | | | | | | | |
|---|---|---|---|---|---|---|---|---|---|
| Har Bracha Regular | 4.28 | 24.7 | 42.7 | 78.5 | 126 | 2000 | 900 | 700 | 662.5 |
| Nesher Whole grain | 5.47 | 39.6 | 68.6 | 113 | 163 | 4100 | 1820 | 1295 | ND |

Alternatively, or additionally, in some embodiments the crude tahini composition is characterized by a PSD of 99% of less than 179 μm as measured by laser diffraction. According to various exemplary embodiments of the invention the crude tahini composition is characterized by a PSD of 99% of 120 μm or less; 115 μm or less; 110 μm or less; 105 μm or less; 100 μm or less; 95 μm or less; 90 μm or less; 85 μm or less; 80 μm or less; 79 μm or less; or lesser or intermediate sizes as measured by laser diffraction.

TABLE 3
PSD of powdered Microfluidized crude
tahini using water as a dispersant

| | 50% | 90% | 95% | 99% | 100% |
|---|---|---|---|---|---|
| material | μm | μm | μm | μm | μm |
| Tahini | 6.00 | 24.4 | 34.1 | 49.9 | 66.7 |
| Powder | | | | | |

No hulls

TABLE 4
PSD of rice bran extract with and without microfluidization

| material | Microfluidized? | 50% μm | 90%μ | 95% | 99% | 100% |
|---|---|---|---|---|---|---|
| Rice bran | NO | 21.4 | 78.3 | 121 | 298 | 583 |
| before | | | | | | |
| rice bran | YES | 20.7 | 68.9 | 92 | 156 | 239 |
| after | | | | | | |

Alternatively, or additionally, in some embodiments the crude tahini composition is characterized by a PSD of 100% of less than 272 μm as measured by laser diffraction. According to various exemplary embodiments of the invention, the crude tahini composition is characterized by a PSD of 100% of 200 μm or less; 190 μm or less; 180 μm or less; 170 μm or less; 160 μm or less; 150 μm or less; 140 μm or less; 130 μm or less; 127 μm or less or intermediate or smaller sizes as measured by laser diffraction.

Alternatively, or additionally, in some embodiments the crude tahini composition is characterized by a viscosity cp SC4-21 at 5 RPM of 2000; 1900; 1800; 1700; 1600; 1500; 1400; 1300; 1200; 1100; 1000; 900 or intermediate or smaller number of cP (centipoise).

Alternatively, or additionally, in some embodiments the crude tahini composition is characterized by a viscosity cp SC4-21 at 11 RPM of less than 1776; 1700; 1600; 1500; 1400; 1300; 1200; 1100; 1000; 900; 800; 700 or intermediate or smaller numbers of cP.

### Exemplary Whole Crude Tahini

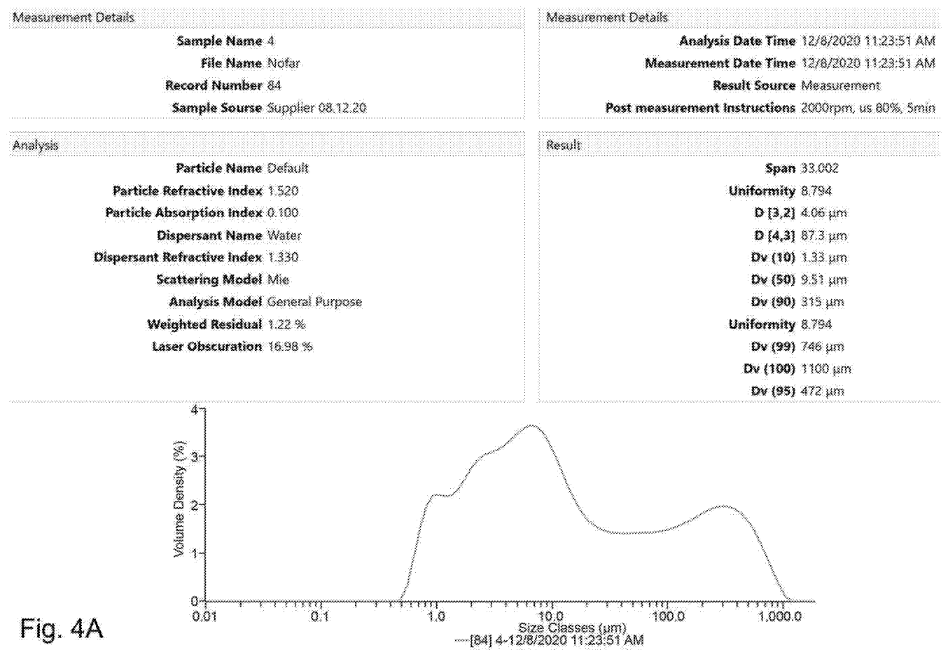

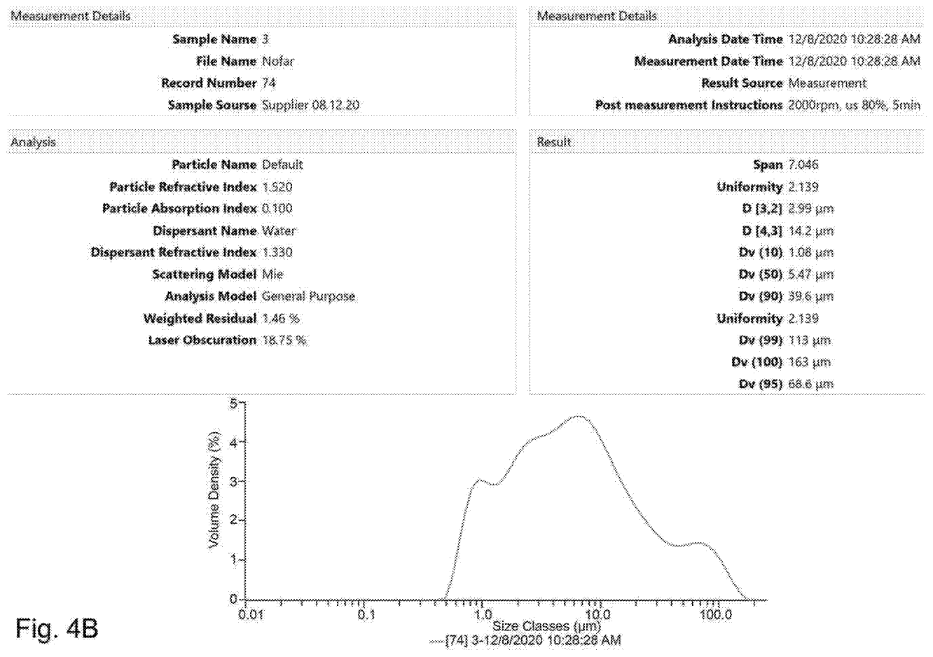

FIGS. 4A and 4B illustrate graphically the effect of microfluidization (110 in FIG. 1) on PSD of crude tahini as measured by laser diffraction using water as the dispersant. Results are summarized numerically in Table 2.

Some exemplary embodiments of the invention relate to a whole grain crude tahini composition characterized by a PSD of 90% of less than 68 μm as measured by laser diffraction using a Malvern-Mastersizer 3000 Wet dispersion with Hydro EV cell with water as the dispersant. According to various exemplary embodiments of the invention, the whole grain crude tahini composition is characterized by a PSD of 90% of 50 μm; 48 μm; 46 μm; 44 μm; 42 μm; 40 μm or intermediate or smaller sizes.

Some exemplary embodiments of the invention relate to a whole grain crude tahini composition characterized by a PSD of 95% of less than 117 μm as measured by laser diffraction. According to various exemplary embodiments of the invention, the whole grain crude tahini composition is characterized by a PSD of 95% of 90 μm; 85 μm; 80 μm; 75 μm; 70 μm; 69 μm or intermediate or smaller sizes.

Some exemplary embodiments of the invention relate to a whole grain crude tahini composition characterized by a PSD of 99% of less than 181 μm as measured by laser diffraction. According to various exemplary embodiments of the invention, the whole grain crude tahini composition is characterized by a PSD of 99% of 150 μm; 145 μm; 140 μm; 135 μm; 130 μm; 125 μm; 120 μm; 115 μm; 113 μm or smaller or intermediate sizes.

Some exemplary embodiments of the invention relate to a whole grain crude tahini composition characterized by a PSD of 100% of 270 μm or less as measured by laser diffraction. According to various exemplary embodiments of the invention, the whole crude tahini composition is characterized by a PSD of 100% of 200 μm; 190 μm; 180 μm; 170 μm; 165 μm; 163 μm or intermediate or smaller sizes.

Some exemplary embodiments of the invention relate to a whole grain crude tahini composition characterized by a viscosity cp SC4-21 at 11 RPM of 1795, 1632, 1400; 1380; 1360; 1340; 1320; 1310; 1300; 1295 or intermediate or lower values.

Exemplary Crude Tahini with Different Dispersants

FIGS. 1B and 1C illustrate graphically the effect of microfluidization (110 in FIG. 1) on PSD of crude tahini as measured by laser diffraction using Isopar G as the dispersant. Results are summarized numerically in Table 1A.

Some exemplary embodiments of the invention relate to a crude tahini composition characterized by a PSD of 90% of less than 55 μm as measured by laser diffraction using a Malvern-Mastersizer 3000 Wet dispersion with Hydro EV cell with Isopar G as the dispersant. According to various exemplary embodiments of the invention, the crude tahini composition is characterized by a PSD of 90% of 40 μm; 35 μm; 30 μm; 28 μm; 26 μm; 24 μm or intermediate or smaller sizes.

Some exemplary embodiments of the invention relate to a crude tahini composition characterized by a PSD of 95% of less than 80 μm as measured by laser diffraction. According to various exemplary embodiments of the invention, the crude tahini composition is characterized by a PSD of 95% of 60 μm; 55 μm; 50 μm; 45 μm; 40 μm; 37 μm or intermediate or smaller sizes.

Some exemplary embodiments of the invention relate to a crude tahini composition characterized by a PSD of 99% of less than 117 μm as measured by laser diffraction. According to various exemplary embodiments of the invention, the crude tahini composition is characterized by a PSD of 99% of 90 μm; 80 μm; 70 μm; 60 μm; 56 μm; 55 μm or intermediate or smaller sizes.

Some exemplary embodiments of the invention relate to a crude tahini composition characterized by a PSD of 100% of less than 160 μm as measured by laser diffraction. According to various exemplary embodiments of the invention, the crude tahini composition is characterized by a PSD of 100% of 120 μm; 110 μm; 100 μm; 90 μm; 80 μm; 76 μm or intermediate or smaller sizes.

Some exemplary embodiments of the invention relate to a crude tahini composition characterized by a viscosity cp SC4-21 at 5 RPM of less than 2100; less than 2000; less than 1900; less than 1800; less than 1700; less than 1600; less than 1500; less than 1400; less than 1300; less than 1200; less than 1100; less than 1000; less than 900 or intermediate or lower values.

Some exemplary embodiments of the invention relate to a crude tahini composition characterized by a viscosity cp SC4-21 at 11 RPM of less than 1770; less than 1700; less than 1600; less than 1500; less than 1400; less than 1300; less than 1200; less than 1100; less than 1000; less than 900; less than 800; less than 700 or intermediate or lower values.

Exemplary Whole Crude Tahini with Different Dispersants

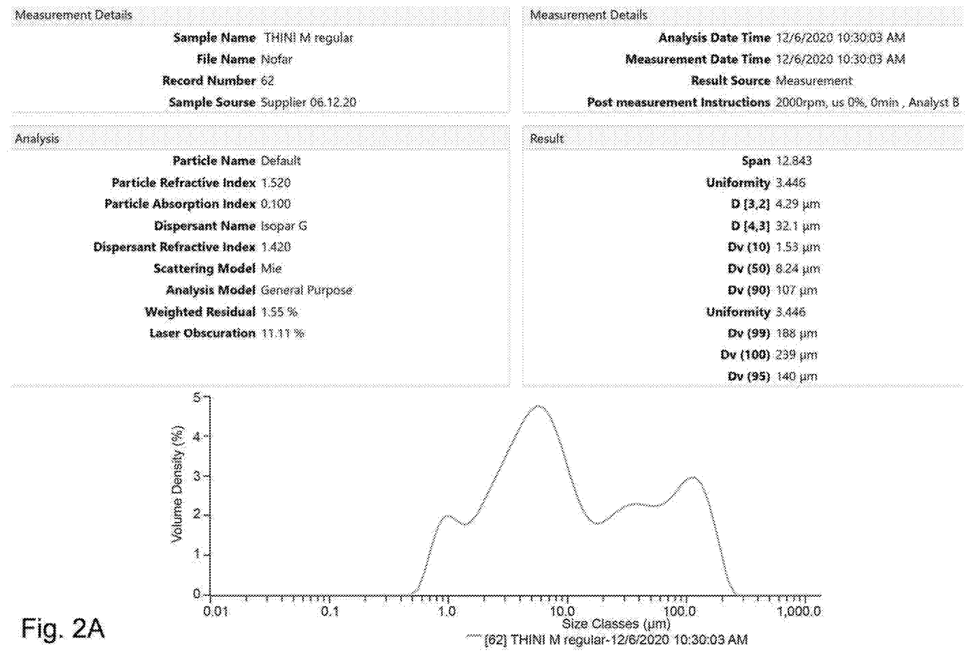

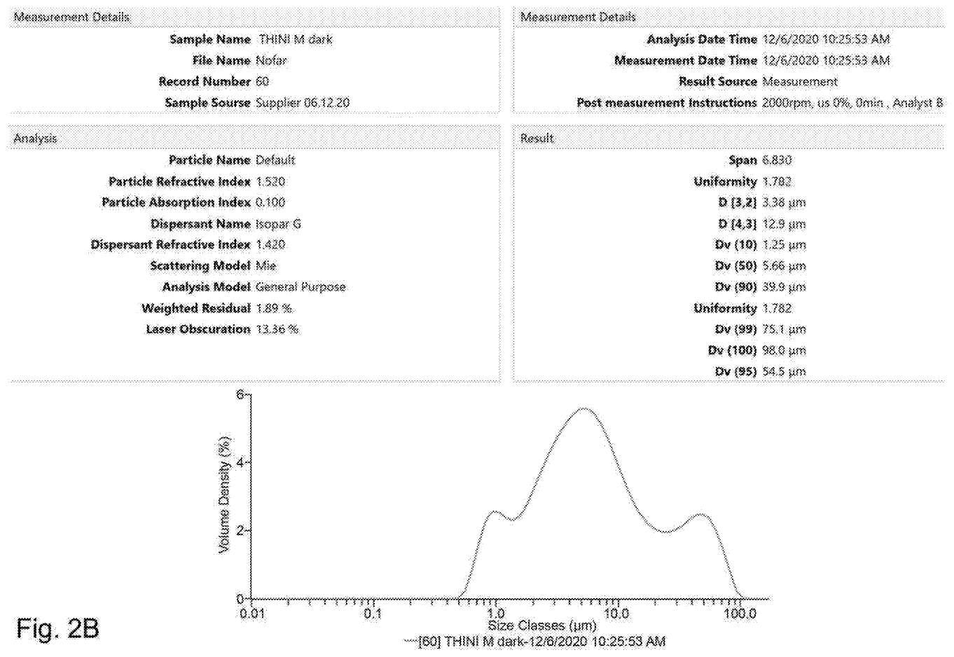

FIGS. 2A and 2B illustrate graphically the effect of microfluidization (110 in FIG. 1) on PSD of whole crude tahini as measured by laser diffraction using Isopar G as dispersant. Results are summarized numerically in Table 1A.

Some exemplary embodiments of the invention relate to a whole grain crude tahini composition characterized by a PSD of 90% of less than 72.4 or less as measured by laser diffraction using a Malvern-Mastersizer 3000 Wet dispersion with Hydro EV cell with Isopar G as the dispersant. According to various exemplary embodiments of the invention, the whole grain crude tahini composition is characterized by a PSD of 90% of 65 μm; 60 μm; 55 μm; 50 μm; 48 μm; 45 μm; 42 μm; 40 μm or intermediate or smaller sizes.

Some exemplary embodiments of the invention relate to a whole grain crude tahini composition characterized by a PSD of 50% of less than 7 μm as measured by laser diffraction using a Malvern-Mastersizer 3000 Wet dispersion with Hydro EV cell with Isopar G as the dispersant. According to various exemplary embodiments of the invention, the whole grain crude tahini composition is characterized by a PSD of 50% of 6.5 μm; 6.0 μm; 5.5 μm; 5.0 μm; 4.8 μm; 4.5 μm; 4.2 μm; 4.0 μm or intermediate or smaller sizes.

Some exemplary embodiments of the invention relate to a whole grain crude tahini composition characterized by a PSD of 95% of less than 101 μm as measured by laser diffraction. According to various exemplary embodiments of the invention, the whole grain crude tahini composition is characterized by a PSD of 95% of 80 μm; 75 μm; 70 μm; 65 μm; 60 μm; 55 μm or intermediate or smaller sizes.

Some exemplary embodiments of the invention relate to a whole grain crude tahini composition characterized by a PSD of 99% of less than 143 μm as measured by laser diffraction. According to various exemplary embodiments of the invention, the whole grain crude tahini composition is characterized by a PSD of 130 μm; of 120 μm; of 110 μm; of 100 μm; of 90 μm; of 80 μm; of 75 μm or intermediate or smaller sizes.

Some exemplary embodiments of the invention relate to a whole grain crude tahini composition characterized by a PSD of 100% of less than 184 μm as measured by laser diffraction. According to various exemplary embodiments of the invention, the whole grain crude tahini composition is characterized by a PSD of 100% of 165 μm; 160 μm; 150 μm; 140 μm; 130 μm; 120 μm; 110 μm; 105 μm; 100 μm; 98 μm or intermediate or smaller sizes.

Some exemplary embodiments of the invention relate to a whole grain crude tahini composition characterized by a viscosity cp SC4-21 at 11 RPM of less than 1417; less than 1400; less than 1350; less than 1325; less than 1300; less than 1295 or intermediate or lower values.

Results presented in Table 1A relate to commercially available tahini labelled “whole grain”. However, it is believed that many of these products do not contain the full amounts of hulls naturally present in sesame seeds. See Table 5B for an analysis of “real” whole grain tahini with at least 13% crude fiber.

Exemplary Crude Tahini Prepared with an Alternate Microfluidization Protocols

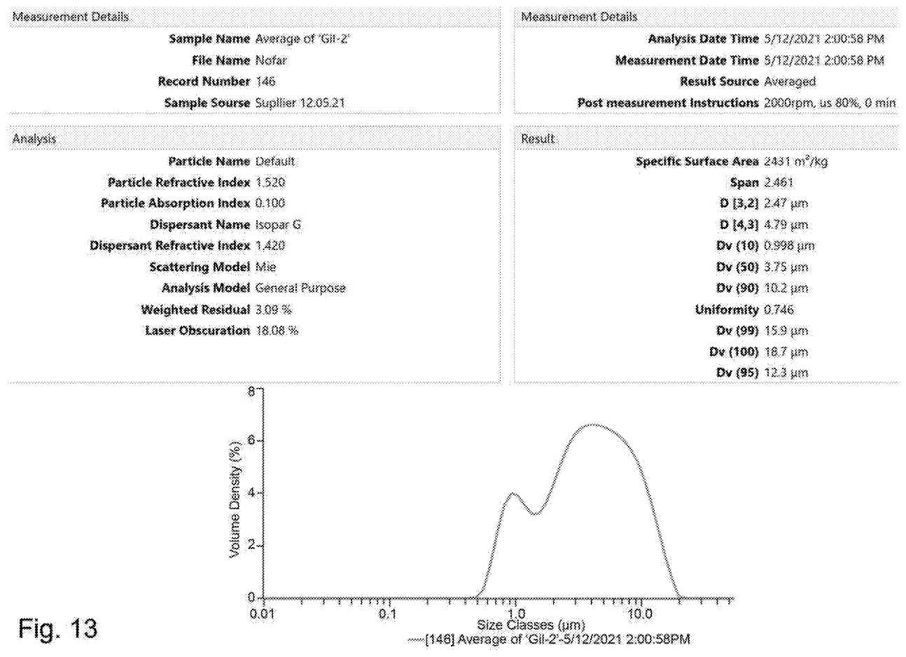

FIG. 13 is a plot of volume density % as a function of size in μm for crude tahini Har Bracha 2 after microfluidization according to an exemplary embodiment of the invention analyzed by laser diffraction using ISOPAR G as a dispersant.

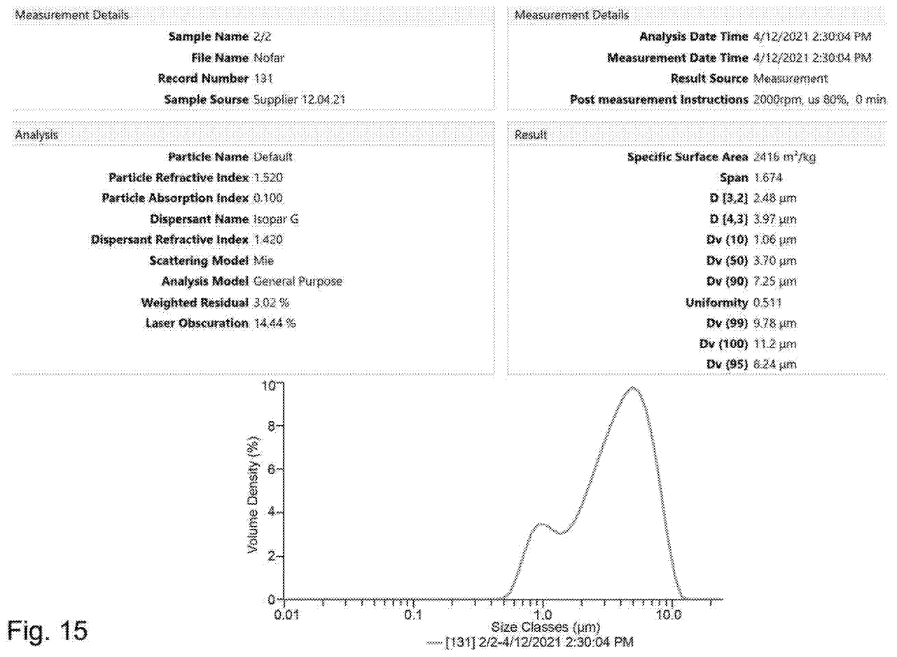

FIG. 15 is a plot of volume density % as a function of size in μm for another sample of the same microfluidized crude tahini Har Bracha 3 as in FIG. 13 analyzed by laser diffraction using ISOPAR G as a dispersant.

Har Bracha tahini was homogenized using a lab pilot m110EH30 at 22,00 PSI using 200 μm entrance/200 μm exit (2×) followed by 200 μm entrance/100 μm exit (2×).

PSD data from FIG. 13 is summarized numerically in Table 1A as Har Bracha 2. PSD data from FIG. 15 is summarized numerically in Table 1A as Har Bracha 3, compared to pre-homogenization data for Har Bracha in Table 1A.

FIG. 1C is a plot of volume density % as a function of size in μm for crude tahini Har Bracha (FIG. 1B) after microfluidization according to an exemplary embodiment of the invention analyzed by laser diffraction using ISOPAR G as a dispersant.

Har Bracha tahini was homogenized using a lab pilot m110EH30 at 22,00 PSI using 200 μm entrance/200 μm exit (2×) followed by 200 μm entrance/100 μm exit (1×).

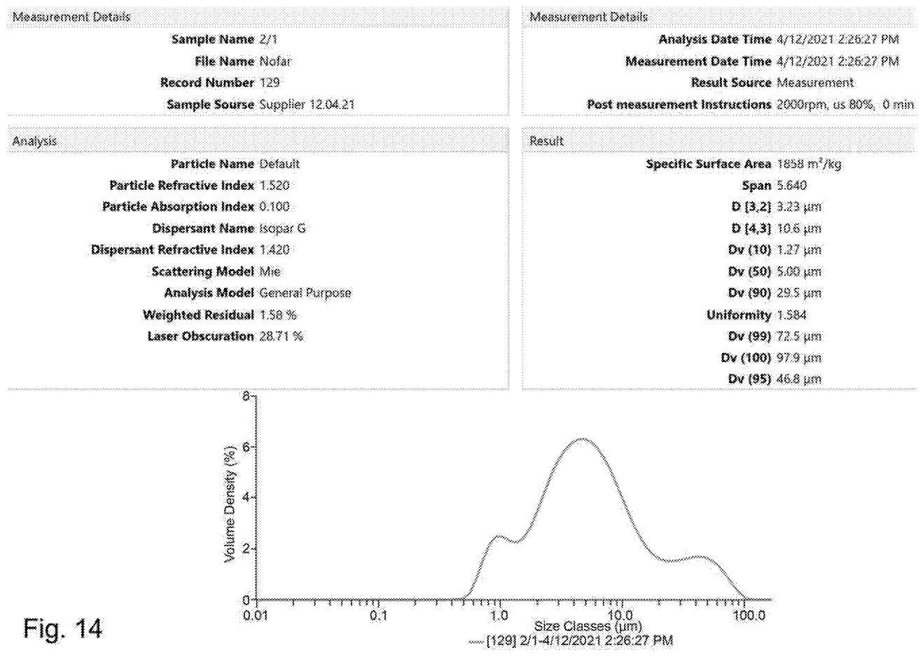

PSD data from FIG. 14 is summarized numerically in Table 1A as Har Bracha 1, compared to pre-homogenization data for Har Bracha in Table 1A and the results of Har Bracha 2 in Table 1A (FIG. 13). The PSD in FIG. 14 has larger particle sizes than in FIG. 13 because the homogenization protocol included only 1 passage via 200 μm entrance/100 μm exit tube.

### Exemplary Method

Some exemplary embodiments of the invention relate to a method including microfluidizing crude tahini and/or whole grain crude tahini. According to various exemplary embodiments of the invention microfluidization is conducted at a pressure of 5,000 PSI (pounds per square inch); 10,000 PSI; 15,000 PSI; 20,000 PSI; 25,000 PSI; 30,000 PSI; 35,000 PSI, 40,000 PSI, or intermediate or higher pressures. In some exemplary embodiments of the invention, the crude tahini includes whole crude tahini and/or regular crude tahini.

In some exemplary embodiments of the invention, the method includes preparing the crude tahini from sesame seeds. According to various exemplary embodiments of the invention preparing the crude tahini includes, but is not limited to, grinding using a ball mill, homogenizer (including rotor-stator homogenizer often called a high-shear mixer or colloid mill), millstones, Macintyre grinder, ultrasonic grinder, and/or Reifiner Conche.

### Additional Exemplary Method

Some exemplary embodiments of the invention relate to a method of producing crude tahini including soaking sesame seeds in water for a minimum of 1 hour and grinding to produce tahini paste. According to various exemplary embodiments of the invention, the soaking continues 2 hours; 3 hours; 4 hours; 5 hours; 6 hours; 7 hours; 8 hours; 9 hours; 10 hours or intermediate or longer times. In some embodiments, soaking continues until sprouting is observed. Alternatively, or additionally, in some embodiments soaking for an extended period of time contributes to production of GABA and/or sprouting.

In some exemplary embodiments of the invention, the method includes removing hulls from the sesame seeds. Alternatively, or additionally, in some embodiments the method includes roasting said sesame seeds. Alternatively, or additionally, in some embodiments the method includes microfluidizing the tahini paste. Alternatively, or additionally, in some embodiments the method includes grinding the sesame seeds.

### Further Additional Exemplary Method

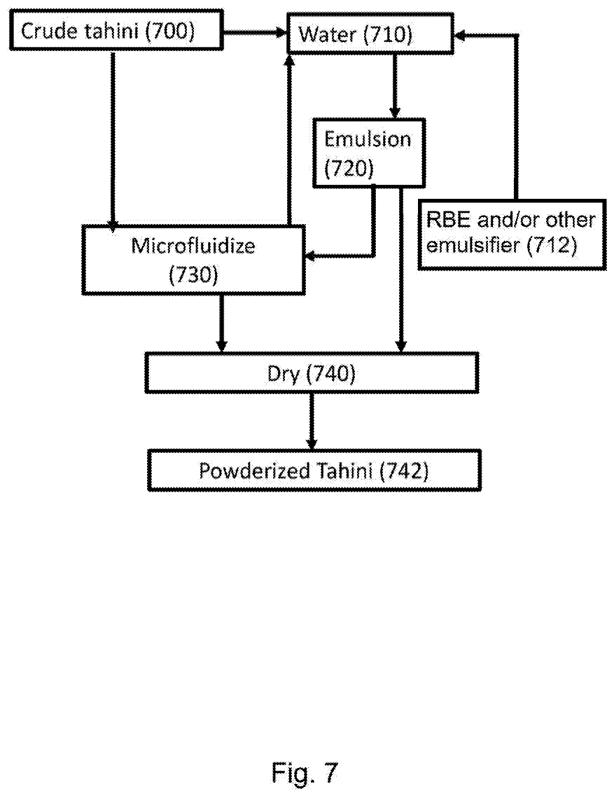

FIG. 7 is a simplified flow diagram of a method for powderizing tahini according to some exemplary embodiments of the invention. According to various exemplary embodiments of the invention the tahini is prepared from whole grain crude tahini or regular crude tahini.

Some exemplary embodiments of the invention relate to a method including mixing crude tahini 700 and water 710 to produce an emulsion 720 and microfluidizing 730. According to various exemplary embodiments of the invention the microfluidization employs a pressure of 5000 PSI, 10,000 PSI, 15,000 PSI, 20,000 PSI, 25,000 PSI, 30,000 PSI, 35,000 PSI, 40,000 PSI, or intermediate or greater pressures.

In some embodiments, tahini 700 is mixed with water 710 to produce an emulsion 720 which is dried 740 without microfluidization 730. In the depicted embodiment, the method includes drying 740 emulsion 720 to produce powderized tahini 742.

In some embodiments, the method includes dissolving RBE (712) ≤12%, ≤5%, ≤4%, ≤3%, ≤2% or intermediate or lower percentages of the weight of crude tahini 700 in water 710. In some exemplary embodiments of the invention, the RBE 712 is mixed with water 710. In some embodiments, the mixing is at high speed. In some embodiments water, 710 is heated, e.g., to 60° C., 65° C., 70° C., or intermediate or higher temperatures. In some embodiments, the RBE solution is cooled. This RBE solution is then mixed with crude tahini 700.

In some embodiments, drying 740 is spray drying. In some exemplary embodiments of the invention, the spray drying employs a dryer with an entrance temperature of 200° C. to 210° C. Alternatively, or additionally, in some embodiments the spray drying employs a dryer with an exit temperature of 95° C. to 110° C. See “exemplary spray drying equipment” hereinbelow for a discussion of how different parameters influence selection of spray drying temperatures.

Alternatively, or additionally, in some embodiments drying 840 uses vacuum dryer or vacuum spray dryer. Alternatively, or additionally, in some embodiments drying 740 uses a vacuum dryer or vacuum spray dryer or Drum drier. According to various exemplary embodiments of the invention, the vacuum dryer or vacuum spray dryer or drum dryer operates at an entrance temperature of 70° C., 60° C., 55° C., or intermediate or lower temperatures.

The method depicted in FIG. 7 covers four separate possibilities. The first possibility is microfluidization 730 of crude tahini 700 followed by mixing with water 710 to form an initial emulsion 720 which is then microfluidized 730 again and then dried 740 to produce powderized tahini 742. The second possibility is mixing crude tahini 700 with water 710 to produce emulsion 720 followed by microfluidization 730 and drying 740. The third possibility is microlfluidizing 730 crude tahini and (in parallel or before) mixing water 710 with RBE (712) <12% of the weight of crude tahini 700. In some embodiments, this mixture of water 710 and RBE 712 is heated, optionally boiled, and then cooled. The microfluidized tahini is then mixed with the water/RBE solution to produce an emulsion 720. In some embodiments, the emulsion 720 is microfluidized 730 then dried 740. In other exemplary embodiments of the invention, emulsion 720 is dried 740 directly. In either case, the result is powderized tahini 740. The fourth possibility is mixing RBE (712) <12% of the weight of crude tahini 700 with water 710. In some embodiments, this mixture of water 710 and RBE 712 is heated, optionally boiled, and then cooled. Crude tahini 700 is then added to the water/RBE mixture to produce an emulsion 720 which is either dried 740 directly, or microfluidized 730 and then dried 740. In either case, the result is powderized tahini 742.

In some exemplary embodiments of the invention, a decrease in temperature contributes to an improvement in rheology characteristics of powderized tahini 742. According to various exemplary embodiments of the invention, the rheology characteristics include flavor and/or aroma.

See “exemplary spray drying equipment” herein below.

### Exemplary Powdered Composition

Some exemplary embodiments of the invention relate to a powder composition including a spray-dried emulsion of crude tahini and water. In some embodiments the crude tahini and/or the emulsion are microfluidized. As described hereinabove in the context of FIG. 7, the composition is often powderized or granulated. In some embodiments, the composition includes RBE. Alternatively, or additionally, in some embodiments the composition includes seasonings and/or antioxidants and/or anticaking agents.

### Further Additional Exemplary Method

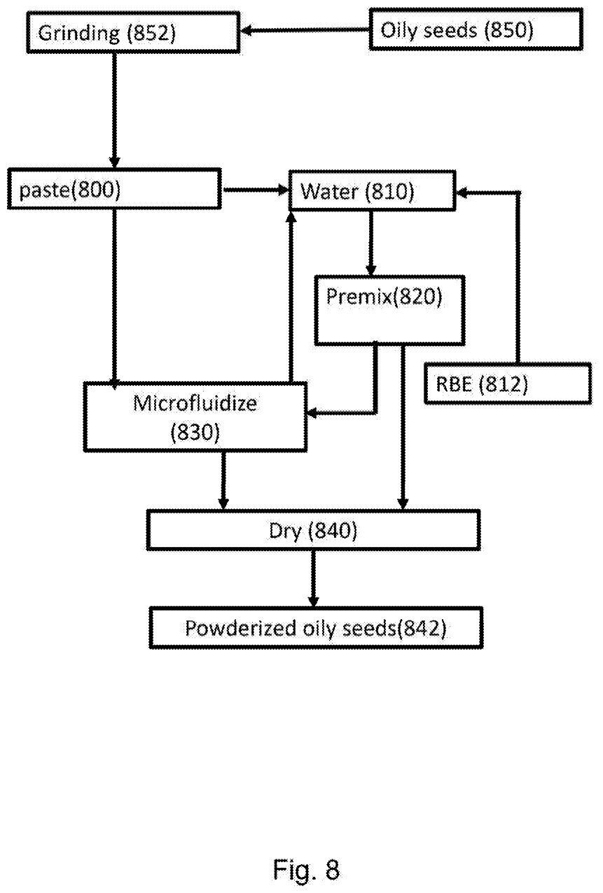

FIG. 8 is a simplified flow diagram of a method to produce powderized oily seeds according to an exemplary embodiment of the invention. According to various exemplary embodiments of the invention the seeds are provided with or without hulls.

In some exemplary embodiments of the invention, paste 800 is mixed with water 810 to produce a pre-mix 820 and microfluidizing 830 paste 800 (either alone or as part of premix 820). According to various exemplary embodiments of the invention, the microfluidization 830 employs a pressure as described for microfluidization 730. In the depicted embodiment, the method includes grinding 852 the oily seeds 850 to produce a paste 800. In some embodiments the seeds are dried and/or roasted.

In some exemplary embodiments of the invention, paste 800 and water 810 are combined to form premix 820 which is dried 840 directly without microfluidization 830. In the depicted embodiment, the method includes drying 840 premix 820 to produce powderized oily seeds 842.

In some embodiments, the method includes dissolving RBE (812) ≤12%; ≤5%, ≤4%, ≤3%, ≤2%, or intermediate or lower percentages of the weight of paste 800 in water 810. In some exemplary embodiments of the invention, the RBE 812 is mixed with water 810 at high speed. In some embodiments water 810 is heated, e.g., to 60° C., 65° C., 70° C., or intermediate or greater temperatures. In some embodiments the RBE solution is cooled. This RBE solution is then mixed with crude paste 800.

In some embodiments, drying 840 is spray drying. In some exemplary embodiments of the invention, the spray drying employs a dryer with an entrance temperature of 200° C. to 210° C. Alternatively, or additionally, in some embodiments the spray drying employs a dryer with an exit temperature of 95° C. to 110° C. See “exemplary spray drying equipment” hereinbelow.

Alternatively, or additionally, in some embodiments drying 840 uses a vacuum dryer, vacuum spray dryer, or drum dryer. According to various exemplary embodiments of the invention, the vacuum dryer operates at an entrance temperature of 70° C., 60° C., 55° C., or intermediate or lower temperatures. In some exemplary embodiments of the invention, a decrease in temperature contributes to an improvement in rheology characteristics of powderized oily seeds 842. According to various exemplary embodiments of the invention, the rheology characteristics include flavor and/or aroma. See “exemplary spray drying equipment” hereinbelow.

The method depicted in FIG. 8 covers four separate possibilities. The first possibility is microfluidization 830 of paste 800 followed by mixing with water 810 to form a premix 820, which is then microfluidized 830 and then dried 840 to produce powderized oily seeds 842. The second possibility is mixing paste 800 with water 810 to produce premix 820, followed by microfluidization 730 and drying 740. The third possibility is microfluidizing 830 paste 800 and (in parallel) mixing water 810 with RBE (812) <12% of the weight of paste 800. In some embodiments, this mixture of water 810 and RBE 812 is heated, optionally boiled, and then cooled. The microfluidized paste 800 is then mixed with the water/RBE solution to produce premix 820. In some embodiments, the premix 820 is microfluidized 830 then dried 840. In other exemplary embodiments of the invention, premix 820 is dried 740 directly. In either case, the result is powderized oily seeds 842. The fourth possibility is mixing RBE (712) <12% of the weight of paste 800 with water 810. In some embodiments, this mixture of water 810 and RBE 812 is heated, optionally boiled, and then cooled. Paste 800 is then added to the water/RBE mixture to produce premix 820, which is either dried 840 directly, or microfluidized 830 and then dried 840. In either case, the result is powderized oily seeds 842.

### Further Additional Exemplary Composition

Some exemplary embodiments of the invention relate to a powder composition including a spray-dried homogenate of oily seeds and water. In some embodiments, the homogenate is microfluidized prior to drying. In some embodiments, the powder composition includes RBE and/or another emulsifier. Alternatively, or additionally, in some embodiments the powder composition includes seasonings and/or antioxidants and/or anticaking agents.

### Characterization by Viscosity

In some exemplary embodiments of the invention there is provided a crude tahini composition with a viscosity cp SC4-21 at 5 RPM of 2000, 1700, 1500 or intermediate or lower values or less. Alternatively, or additionally, in some embodiments there is provided a crude tahini composition having a viscosity cp SC4-21 at 11 RPM of less than 1796, less than 1700, less than 1633, less than 1400, less than 1000 or intermediate or lower values. In some exemplary embodiments of the invention there is provided a whole grain crude tahini composition having a viscosity cp SC4-21 at 11 RPM of 1400 or less, 1300 or less or intermediate or lower values. Viscosity data for conventional tahini as well as tahini according to exemplary embodiments of the invention is presented hereinabove in Table 1A and Table 2.

Adding 100 g of water to 100 g of microfluidized tahini will produce a much lower viscosity than similar dilution of tahini which was not microfluidized. One possible explanation for this observation is that the lower viscosity of the microfluidized crude tahini contributes to a lower viscosity of the emulsion. As a result, in some embodiments the microfluidized tahini is characterized by a lower starchiness as perceived by human tasting panels relative to conventional crude tahini. This lower viscosity of the water: tahini emulsion persists for only a few seconds to a few minutes after mixing.

### Exemplary Rheology Considerations

Rheology panels indicate that many people perceive micro fluidized tahini paste sweeter than comparable tahini paste which was not subject to micro fluidization.

Microfluidized crude tahini exhibits different properties than standard tahini during emulsion preparation. This is apparent when mixing 50 g crude tahini with 30 g water. Standard tahini becomes viscous almost immediately upon mixing. Microfluidized tahini remains thin for 5 to 6 seconds after mixing and then increases in viscosity. A tasting panel of 10 people indicated microfluidized crude tahini does not become viscous in the mouth when mixed with saliva as regular tahini does.

In some exemplary embodiments of the invention there is provided a crude tahini composition which is perceived in organoleptic testing as not becoming sticky in the mouth even after mixing with saliva.

### Exemplary Microfluidization Equipment

In sharp contrast to high-pressure homogenization (HPH), which uses a high-pressure pump to force a fluid/paste) through a narrow, adjustable (variable geometry) valve (the “channel” is a tiny, adjustable gap between a valve seat and a valve plug; the adjustable valve makes it more flexible for very thick pastes but may lead to inconsistent pressure and “dead zones” where some particles do not get fully broken), microfluidization forces a fluid/paste through fixed geometry microchannels at extremely high velocities. This process subjects the fluid/paste to intense shear, impact, and cavitation forces, resulting in particles that are often in the nanometer range with a very narrow size distribution, and in the case of oily seeds paste—with a substantially more uniform, stable, and fine-textured paste. In practice, while HPH may result in up to 700,000 Shear l/sec, a microfluidizer processor reaches up to 10,000,000 Shear l/sec.

The core differentiator of microfluidization is the interaction chamber, which is a block of a durable material (either polycrystalline diamond or a ceramic) encased in a steel housing. While standard homogenizers use a moving valve, microfluidizers use a fixed channel with a specific geometry (typically “Y” or “Z” shaped) to create turbulence. Practically, an intensifier pump (a specialized hydraulic pump acting as a pressure amplifier and allowing the system to convert relatively low-pressure hydraulic power into the ultra-high pressure) pushes the fluid into the system at constant pressures, often reaching up to 40,000 PSI or more; and the fluid is then forced through microscopic channels (defined within the interaction chamber) at velocities exceeding 400 m/s (in the case of “Y type” interaction chamber, the stream is split into two, which then collide head-on; and in the case of “Z type” interaction chamber, the stream is forced to change direction abruptly, causing it to impact the channel walls). Due to the high energy input (i.e., the mechanical energy supplied by the intensifier pump to the fluid), the fluid heats up rapidly and is immediately passed through a heat exchanger to cool it down. Since the interaction chamber has a fixed geometry, every microliter of the fluid introduced into the system experiences the exact same shear force, which results in a remarkably uniform particle size distribution (PSD), which is significantly smaller than those achievable by conventional homogenizers, and often down to 50-100 nm.

In view of the above, and as shown herein, the microfluidization process to which the oily seeds paste is subjected results in a product that is completely different from a corresponding product obtained by HPH, inter alia in terms of PSD and viscosity, as well as rheology and organoleptic uniqueness.

Microfluidization equipment suitable for use in the context of various exemplary embodiments of the invention is available from MICROFLUIDICS INTERNATIONAL CORPORATION (Westwood MA, USA). For example, model LM 10 provides up to 23,000 PSI, LM 20, LV1, M110P, M110-EH-30, M110-EH-30S, M815 Pilot Scale and M 700 each provide up to 30,000 PSI. The M 710 provides up to 40,000 PSI. B.E.E. International Inc. (Easton, MA, USA) also makes microfluidization equipment suitable for use in the context of various exemplary embodiments of the invention, such as the “Micro DeBEE” model.

### Exemplary Microfluidization Protocol

A microfluidization machine as described above is rinsed with propanol then flushed with sunflower oil at 20,000 PSI. An additional wash with cold-pressed sesame oil at 20,000 PSI is conducted. Crude tahini (or another sample) is mixed by rolling the container and 2× 200CC samples are taken in cups. Each sample is mixed with a blender until it appears homogenized to produce an initial homogenate.

A sample of the initial homogenate is loaded into the microfluidizer. A homogenization channel with a 400-micron inlet and 200-micron outlet is fitted and several, e.g., three, passages are performed at 25000 PSI. Then, a homogenization channel with a 200-micron inlet, and 200-micron, 100-micron, or 87-micron outlet is fitted, and several additional passages are performed at 25000 PSI. For the purposes of this specification and the accompanying claims, the term “homogenization channel” indicates a straight channel. The processed material is cooled in a heat diffuser submerged in cold water. Exit temperature is 50° C.±5 degrees.

For whole grain crude tahini samples, the microfluidizer is first fitted with a homogenization channel featuring a 400-micron inlet and 200-micron outlet, and five additional passages are then performed with a homogenization channel featuring a 200-micron inlet and 200-micron outlet (2 passages), and with a homogenization channel featuring a 200-micron inlet and either 100- or 87-micron outlet (3-4 passages). The microfluidization process of crude tahini (not-whole grain) is similar; however, the number of passages through the microfluidizer may be lower. Processing the crude tahini (regardless of whether whole grain or not) to very small particles prior to the microfluidization step may help in passing the crude tahini through a homogenization channel featuring a 200-micron inlet and 100- or 87-micron outlet, without the need to first pass it through homogenization channels featuring wider inlet and/or outlet, and/or in reducing the number of passages through the homogenization channel as exemplified herein with respect to “MFL Homo 6” (see “The nature of the fibrous material in microfluidized-process tahini and in tahini processed without microfluidization”).

In some embodiments, the paste may be heated to a temperature not exceeding 80° C., e.g., to a temperature in the range of 30-75° C., 35-70° C., 40-65° C., 45-60° C., or 50-55° C., thereby facilitating introduction of the paste into the homogenization channel.

Resultant microfluidized crude tahini (e.g., 102 in FIG. 1A) is watery in consistency and does not stick to the walls of containers. It appears like a nano-liquid and not like conventional crude tahini.

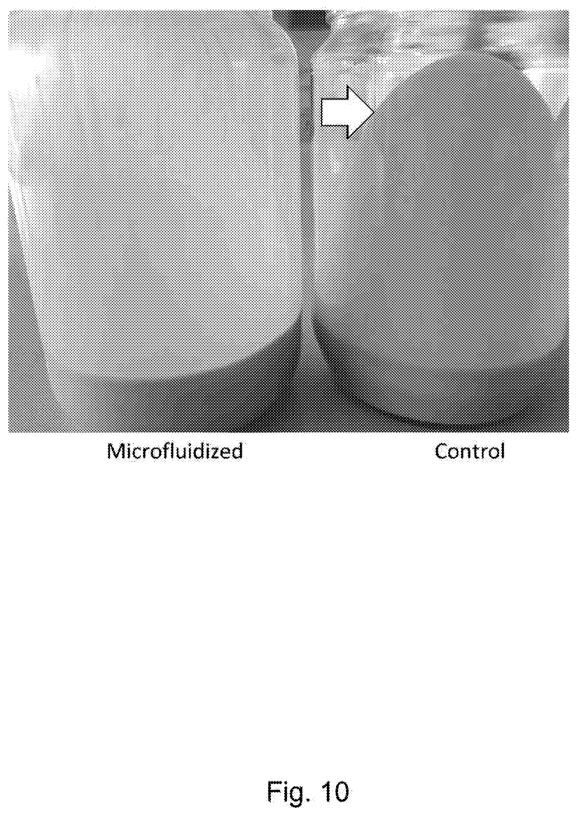

FIG. 10 is a photograph of samples of microfluidized crude tahini according to an exemplary embodiment of the invention and control crude tahini at room temperature illustrating their interaction with a glass container. Prior to acquisition of the photograph the glass containers were laid on their sides then raised again to standing position. The control crude tahini in the right container left a thick layer (indicated by white arrow) adhering to the glass. In comparison, the microfluidized crude tahini appears more uniform, smooth, and homogeneous throughout the entire height of the container, and left only a very thin film (e.g., of 0.70 mm or less, such as up to 0.65, 0.60, 0.55, 0.50, 0.45, 0.40, 0.35, 0.30, 0.25, or 0.20 mm) on the glass.

### Processing of Whole Grain Tahini Using Additional Exemplary Microfluidization Protocols

Whole grain sesame seeds were soaked in water for 3 hours then roasted and ground into tahini using a ball mill. A stone mill or chach or Macintyre could be substituted. This preserves the natural ratio of hulls:seeds of 7% to 17% (hulls in whole grain crude tahini) on a dry matter basis. In contrast, tahini indicated as “with hulls” in Table 1A and Table 2 is labeled as “whole grain” by the manufacturer but may not contain the natural ratio of hulls:seeds. The resulting whole grain tahini was processed in a MICROFLUIDICS M-110-P homogenizer as described in the preceding section with the changes presented in Table 5A and analyzed for PSD and viscosity using protocols presented hereinbelow.

TABLE 5A
exemplary microfluidization protocols

| | | channel | Number | |
|---|---|---|---|---|
| | Prev. | Inlet/outlet | of | |
| Protocol | Protocol | (microns) | passages | Pressure PSI |
| A | none | 400/200 | 2 | 20,000 |
| B | A | 200/100 | 3 | 20,000 |
| C | B | 200/100 | 3 | 20,000-22,000 |
| D | C | 200/100 | 3 | 20,000-22,000 |

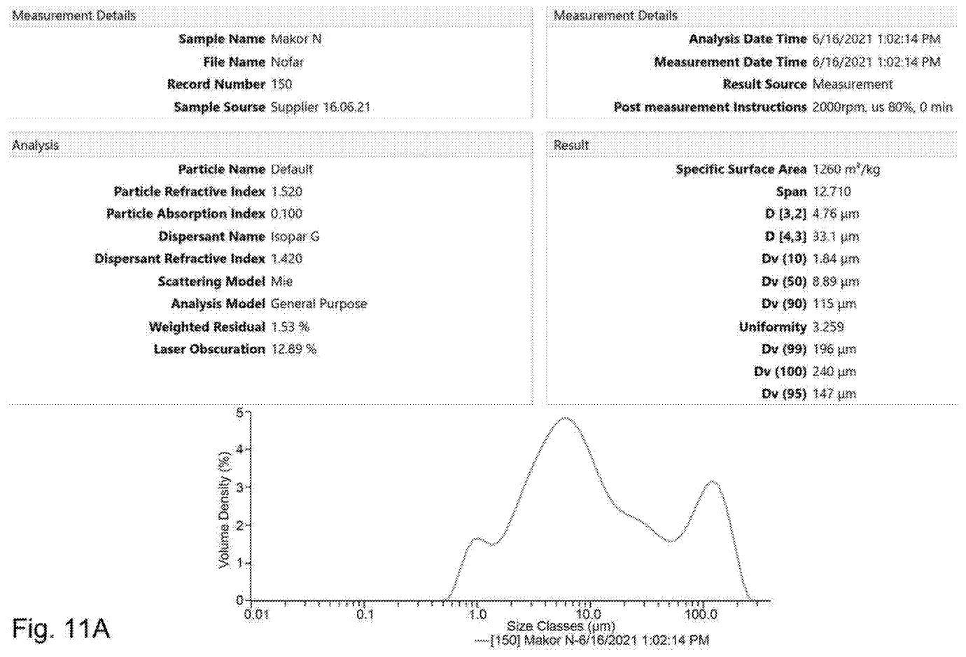

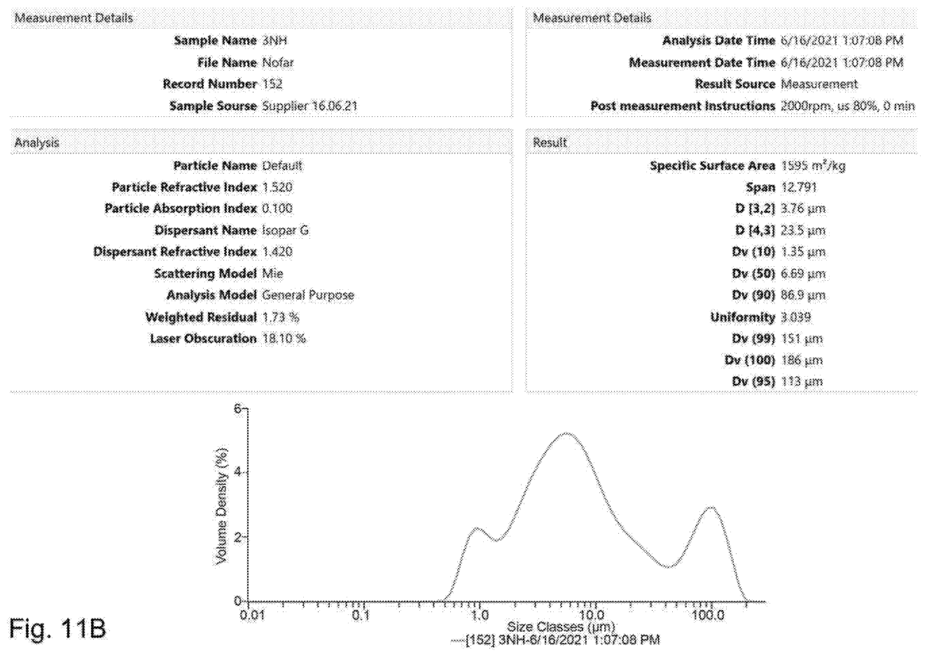

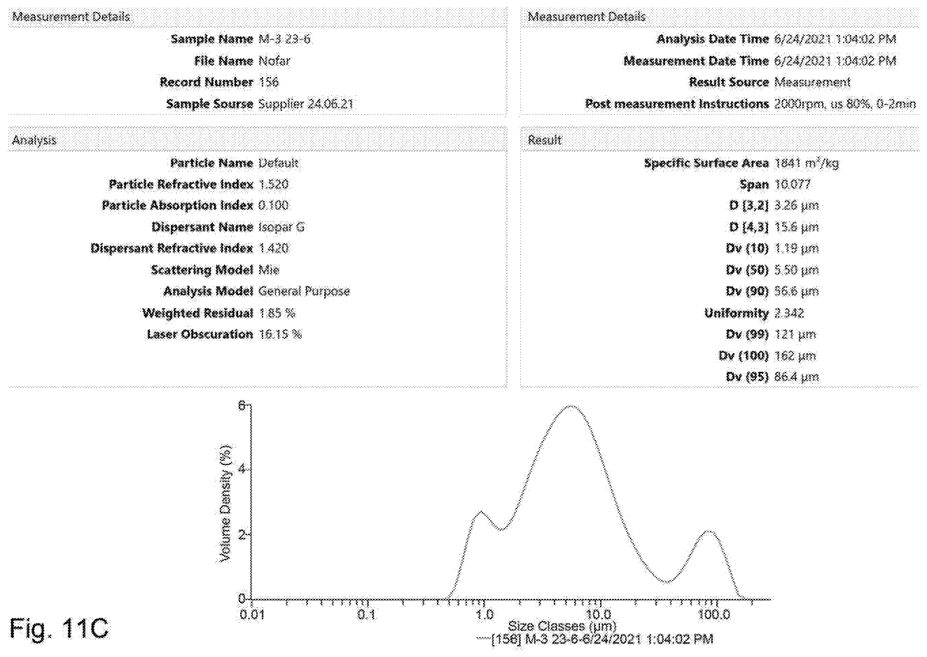

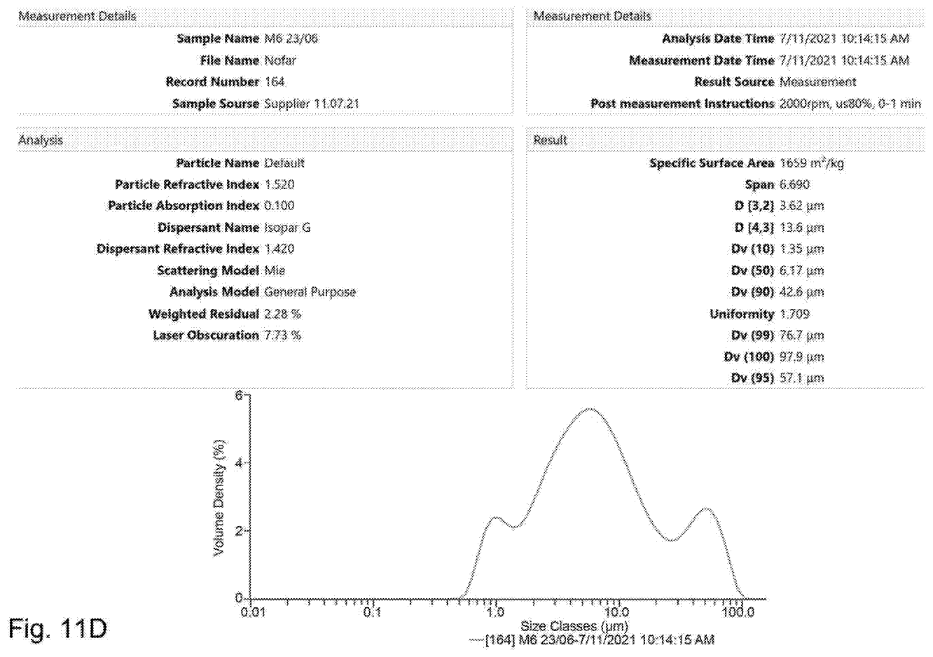

FIG. 11A shows PSD of the tahini before microfluidization; and FIGS. 11B, 11C and 11D show PSD of the tahini after microfluidization according to protocol B, C and D (Table 5A), respectively. PSD data from FIGS. 11A, 11B, 11C, and 11D are summarized in Table 5B together with corresponding viscosity data.

TABLE 5B
PSD of crude Tahini with full hulls before and after Microfluidization
according to the protocols presented in Table 5A using Isopar G
as a dispersant and corresponding Viscosity CP SC4-21 (cP) data.

| | | | | | | | Viscosity CP SC4-21 (cP) | | | |
|---|---|---|---|---|---|---|---|---|---|---|
| | | Particle Size Distribution (PSD) μm | | | | | 1 rpm | 5 rpm | 11 rpm | 22 rpm |
| Figure | Protocol | 50% | 90% | 95% | 99% | 100% | Shear1 | shear 5 | shear10 | shear20 |
| 11A | None | 8.9 | 115 | 147.2 | 196.8 | 240 | 10250 | 4940 | 4005 | unreadable |
| | (—) control | | | | | | | | | |
| 11B | B | 6.7 | 87.0 | 112.7 | 151.1 | 186 | 5900 | 2430 | 1795 | 1489 |
| 11C | C | 5.5 | 56.6 | 86.4 | 121 | 162 | 6200 | 2310 | 1632 | 1300 |
| 11D | D | 6.17 | 42.6 | 57.1 | 76.6 | 97.9 | 6100 | 2300 | 1320 | 1295 |

The apparent viscosity (a term especially used for non-Newtonian fluids, whose viscosity changes depending on how fast they are stirred, pumped, or sheared)) of each one of the crude tahini with full hulls samples referred to in Table 5B, before and after microfluidization, was further checked using HR-2 Discovery Hybrid Rheometer (TA Instruments, USA) equipped with a 40 mm diameter parallel plate geometry at a gap of 1000 μm, at room temperature (e.g., 20° C.), with a linear ramp of shear rate from 0.001 to 200 s⁻¹ (l/s) and a total duration of 200 second, wherein the sample was manually trimmed at a trim gap of 1050 μm while rotating at 0.4 radians per second (rad/sec; s⁻¹) for approximately 10 seconds and allowed to rest for 60 seconds before testing. The results obtained are summarized in Table 5C.

TABLE 5C
Apparent viscosity of crude tahini with full hulls, before and after
microfluidization according to the protocols presented in Table 5A,
determined by HR-2 Discovery Hybrid Rheometer

| | Viscosity [pascal seconds | | |
|---|---|---|---|
| Sample | (Pa · sec)] | Rate index | R² |
| 11A | 5.8878 | 0.8284 | 0.99979 |
| 11B | 1.84644 | 0.9027 | 0.9027 |
| 11C | 2.03858 | 0.8604 | 0.999986 |
| 11D | 1.285 | 0.8924 | 0.999993 |

As will be known to any person skilled in the art, the viscosity of the crude tahini (regardless of whether whole grain or not), which is analyzed using HR-2 Discovery Hybrid Rheometer under the conditions recited above, is in fact extracted from a graph (plot) formed by said viscosity analyzer utilizing the Power Law model, based on a series of measurements carried out with a linear ramp of shear rate from 0.001 to 200 s⁻¹ and a total duration of 200 second (sampling interval 1 s/pt). In other words, the HR-2 Discovery Hybrid Rheometer is the tool that generates the raw rheological data, wherein R² is a statistical measure used in the subsequent data analysis to evaluate how well a chosen mathematical model (e.g., the Power Law model utilized in the present case) describes the data collected by the rheometer, which helps determining the validity and appropriateness of the rheological model applied.

The Power Law model is a widely used two-parameter rheological model for characterizing the behavior of non-Newtonian fluids, particularly those that exhibit shear-thinning or shear-thickening behavior, which describes the relationship between shear stress (τ) and shear rate (γ′):

τ=Kγ′n

where: τ is the shear stress (in Pa), γ′ is the shear rate (du/dy [a velocity gradient describing how quickly the fluid's velocity changes as you move perpendicular to the direction of flow], in reciprocal seconds, s⁻¹), K is the flow consistency index (in Pa·sⁿ), and n is the flow behavior index (dimensionless). The effective or apparent viscosity (n) can be derived from this relationship: η=Kγ·n−1 (if n=1, the fluid is Newtonian, meaning its viscosity is constant regardless of the shear rate. In this case, the Power Law model reduces to Newton's law of viscosity, and K becomes the viscosity; if n<1, the fluid is pseudoplastic or shear-thinning. Its apparent viscosity decreases as the shear rate increases. This is the most common type of non-Newtonian behavior, often seen in polymer solutions or suspensions where molecules align or aggregates break down under shear; and if n>1, the fluid is dilatant or shear-thickening. Its apparent viscosity increases as the shear rate increases. This is less common and can occur in highly concentrated particle dispersions).

Yet, it should be clear that the crude tahini's viscosity may also be determined by a viscosity analyzer other than the one referred to above, e.g., the Brookfield's DV-II+Pro EXTRA viscometer, following the manufacturer's instructions and under appropriate conditions. In such cases, the procedure might be different, and values other than those obtained by the HR-2 Discovery Hybrid Rheometer may be obtained.

In some exemplary embodiments of the invention there is provided a whole grain crude tahini composition having at least 13% crude fiber in a proximate analysis and characterized by a PSD of 90% of less than 115 μm as measured by laser diffraction using a Malvern-Mastersizer 3000 Wet dispersion with Hydro EV cell with ISOPAR G as dispersant. According to various exemplary embodiments of the invention, the whole grain crude tahini composition having at least 13% crude fiber in a proximate analysis is characterized by a PSD of 90% of less than 80 μm, less than 70 μm, less than 60 μm, less than 50 μm, less than 43 μm, or intermediate or smaller sizes. Alternatively, or additionally, in some embodiments this whole grain crude tahini composition is characterized by a PSD of 50% of less than 8.9 μm as measured by laser diffraction. According to various exemplary embodiments of the invention this whole grain crude tahini composition is characterized by a PSD of 50% of less than 6 μm, less than 5.5 μm. Alternatively, or additionally, according to various exemplary embodiments of the invention this whole grain crude tahini composition is characterized by a viscosity cP SC4-21 at 11 RPM of less than 4000, less than 3000, less than 2500, less than 2000, less than 1795, less than 1700, less than 1600, less than 1500, less than 1400, less than 1320 or intermediate or lower viscosities.

Alternatively, or additionally, in some embodiments this whole grain crude tahini composition is characterized by a viscosity cp SC4-21 at 5 RPM of less than 4900, less than 4000, less than 3500, less than 3000, less than 2500, less than 2430, less than 2300, or intermediate or lower viscosities.

### Exemplary Microfluidization of Olives

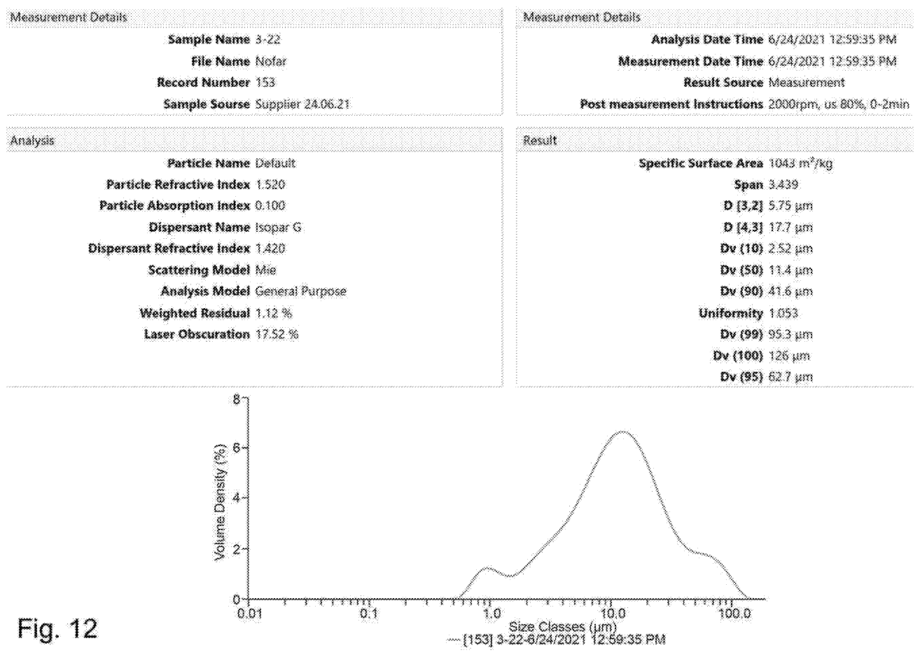

Pitted sliced green olives were alkaline processed (NaOH) then cured in 6% brine for three weeks then soaked in water 4 times (2 hours per time) to remove salt. The sliced olives were then dried at 55° C. for 10 hours with a fan at high speed to dry them. Dry matter yield was 13-15%. This material was ground in a 500-micron grinder prior to microfluidization. The resultant product was microfluidized according to protocol C in Table 5A. The microfluidized liquefied whole olive product was analyzed for PSD and viscosity. PSD results are presented graphically in FIG. 12 and summarized numerically in Table 6A, together with corresponding viscosity data.

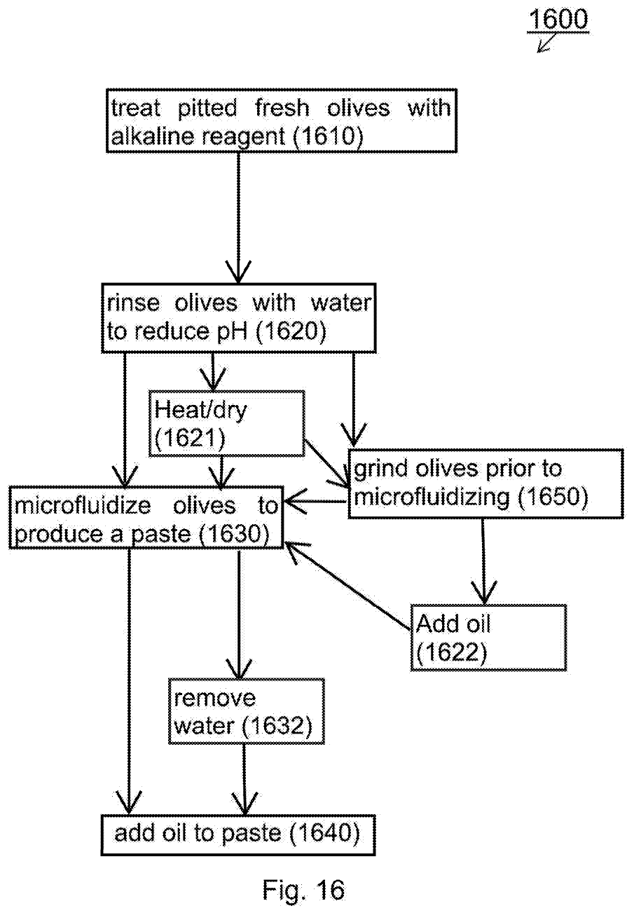

FIG. 16 is a simplified flow diagram of a method for producing an olive product, indicated generally as 1600 according to some exemplary embodiments of the invention.

Depicted exemplary method 1600 includes treating 1610 pitted fresh olives with an alkaline reagent (e.g., a hydroxide solution) rinsing 1620 the olives with water to reduce the pH. In some exemplary embodiments of the invention, the rinsing reduces the pH to 6 to 8.

Alternatively, or additionally, in some embodiments the olives are heated 1621. In some exemplary embodiments of the invention, heating 1621 dries the olives. In some embodiments, the olives are pre-ground 1650 at this stage. In some embodiments, oil is added 1622 to the pre-ground olives before, during or after grinding 1650. At 1630, the olives are microfluidized to produce a paste. In some exemplary embodiments of the invention, oil is added 1640 to the paste. In some embodiments, addition of oil contributes to a desired viscosity of the final product. According to various exemplary embodiments of the invention the final product has a consistency between oil and balsamic vinegar.

Alternatively, or additionally, in some embodiments the method includes spray drying, vacuum spray drying, freeze drying, oven drying, oven vacuum drying, or infrared drying the paste (not depicted).

The viscosity of the olive product referred to in Table 6A, before and after microfluidization, was further checked using HR-2 Discovery Hybrid Rheometer, under the condition recited above. Prior to that, the olive products were mixed 50:50 with olive oil, such that they may pass through the microfluidizer fitted with a homogenization channel featuring a 200-micron inlet and 100-micron outlet. The microfluidized olive product has a viscosity of 0.66687 Pa·sec, rate index: 0.86246, and R²: 0.99989. While the viscosity rheometer graph (0-200) of the olive product before microfluidization has a sawtooth shape (pattern), the graph obtained after the microfluidization is a normal apparent viscosity graph (0-200).

TABLE 6
PSD of liquefied whole olive product after Microfluidization according to the
protocol presented above using Isopar G as a dispersant and corresponding
Viscosity CP SC4-21 (cP) data.
Microfluidized real olive

| | | | | | Viscosity CP SC4-21 (cP) | | | | | |
|---|---|---|---|---|---|---|---|---|---|---|
| Particle Sized Distribution (PSD) μm | | | | | 1 rpm | 5 rpm | 11 rpm | 22 rpm | 50 rpm | 100 rpm |
| 50% | 90% | 95% | 99% | 100% | Shear 1 | Shear 5 | Shear 10 | Shear 20 | Shear 46 | Shear 93 |
| 11.4 | 41.6 | 62.7 | 95.3 | 126 | 950 | 490 | 400 | 350 | 316 | 301 |

TABLE 6B
Viscosity of some of the samples referred to in Table 6A, determined
by HR-2 Discovery Hybrid Rheometer

| | Viscosity [pascal | | |
|---|---|---|---|
| | seconds | | |
| Sample | (Pa · sec)] | Rate index | R² |
| Olive before microfluidizer | 13.3114 | 0.655174 | 0.921863 |
| (Not in Table 6A) | | | |
| Olive after microfluidizer | 0.666871 | 0.862465 | 0.9999898 |
| (in Table 6A) | | | |

This experiment demonstrates the possibility of producing a liquefied whole olive product without pit fragments. The resultant microfluidized product is dark in color and evocative of balsamic vinegar. The product is delicious with vegetables, and the flavor and aroma are characteristic of olives. This product retains the fiber, protein, and antioxidants of whole olives.

In other exemplary embodiments of the invention, olive press pomace is used as an input for the method. According to these embodiments, seed fragments are removed from the pomace. Seed fragments can be removed from pomace, e.g., by using a colloid mill. Colloid mills suitable for this purpose are available commercially, e.g., from OFM Food Machinery (Sevilla, Spain; www.ofmsl.com)

In some exemplary embodiments of the invention, drying of the pomace contributes to a reduction in bitterness. In some exemplary embodiments of the invention, drying is to about 12% to 32% dry matter by weight.

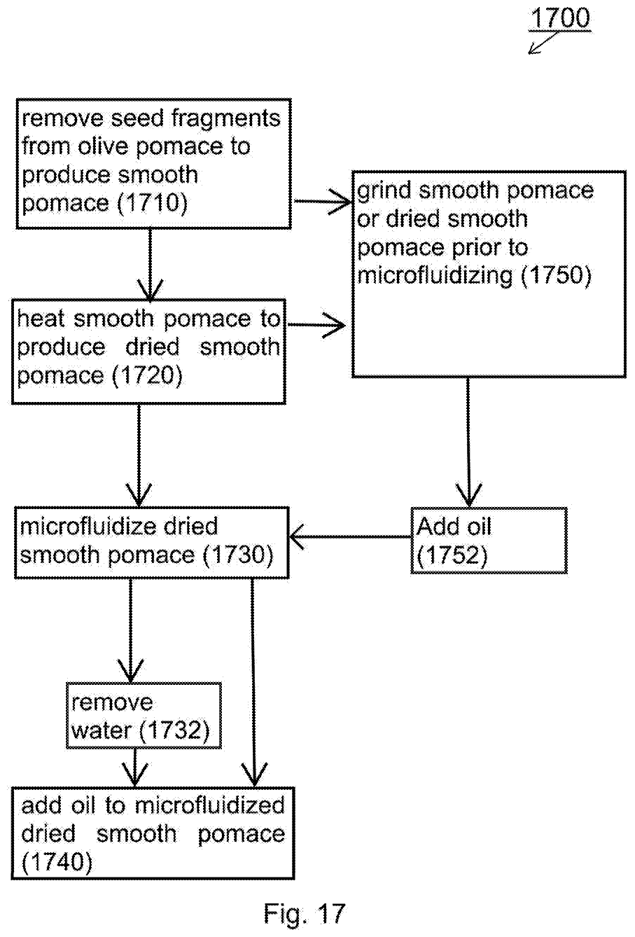

FIG. 17 is a simplified flow diagram of a method for producing an olive product, indicated generally as 1700 according to some exemplary embodiments of the invention. Depicted exemplary method 1700 includes removing 1710 seed fragments from olive pomace to produce smooth pomace and heating 1720 the smooth pomace to produce dried smooth pomace. In the depicted embodiment, the dried smooth pomace is then microfluidized 1730. In some exemplary embodiments of the invention, method 1700 includes adding 1740 oil to the microfluidized dried smooth pomace. In some exemplary embodiments of the invention, method 1700 includes grinding 1750 the smooth pomace or the dried smooth pomace prior to microfluidizing. In some embodiments, oil is added 1752 before, during, or after grinding 1750.

### Exemplary Microfluidized Olive Product

In some exemplary embodiments of the invention there is provided a processed olive composition characterized by a PSD of 90% of less than 41.6 μm as measured by laser diffraction using a Malvern-Mastersizer 3000 Wet dispersion with Hydro EV cell with Isopar G as dispersant. Alternatively, or additionally, in some embodiments there is provided a processed olive composition characterized by a PSD of 50% of less than 11.4 μm as measured by laser diffraction using a Malvern-Mastersizer 3000 Wet dispersion with Hydro EV cell with Isopar G as dispersant. Alternatively, or additionally, in some embodiments the processed olive composition is characterized by a viscosity cp SC4-21 at 5 RPM of 490 or less. Alternatively, or additionally, in some embodiments the processed olive composition is characterized by a viscosity cp SC4-21 at 11 RPM of 400 or less.

### Exemplary Microfluidization of Peanut Butter

To demonstrate the possibility of microfluidizing a paste made of oily seeds other than sesame or olive, B&D Natural Peanut Butter (B&D, Israel) was taken as an example. Prior to microfluidization, the peanut butter was heated to a temperature of 45° C., to facilitate introduction thereof into the homogenization channel. The PSD and viscosity of the product, prior to and after microfluidization, were measured using the methods and apparatus referred to herein with respect to crude tahini and olive paste. The decrease in viscosity was significant throughout the entire process in 6 different processing's. The results are shown in Table 7, indicating an absolute decrease in viscosity of about 4 times.

TABLE 7
PSD of peanut butter after microfluidization according to the protocol
presented above using Isopar G as a dispersant and corresponding viscosity cp SC4-28
(cP) data
CONTROL

| | PSD (μm) | | | | | Viscosity CP SC4-28 (cP) | | | |
|---|---|---|---|---|---|---|---|---|---|
| material | 50% | 90% | 95% | 99% | 100% | 1 rpm | 5 rpm | 11 rpm | 22 rpm |
| | | | | | | shear 1 | shear 5 | shear 10 | shear 20 |
| Regular peanut | | | | | | 48500 | 23694 | ND | ND |
| butter | | | | | | 20.3 °C | 20.3 °C | | |
| | | | | | | 1.12 1/sec | 5.05 1/sec | | |
| | | | | | | 4 rpm | 18 rpm | | |
| Regular peanut | 6.17 | 42.6 | 57.1 | 76.7 | 97.9 | 14125 | 5806 | 4208 | 3324 |
| butter after | | | | | | | | | |
| microfluidization, | | | | | | | | | |
| system 6x 200/100 | | | | | | | | | |
| | | | | | | 20.8 °C | 5.04 1/sec | 20.8 °C | 20.8 °C |
| | | | | | | 1.12 1/sec | 20.8 °C 18 rpm | 10.08 | 19.88 1/sec |
| | | | | | | 4 rpm | | 1/sec | 71 rpm |
| | | | | | | | | 36 rpm | |

### Protocol for Particle Size Distribution Analysis by Laser Diffraction

Particle Size Distribution (PSD) was analyzed by laser diffraction analysis in a wet dispersion, more specifically, utilizing a Malvern-Mastersizer 3000 Wet dispersion with Hydro EV cell, using either water or a non-aqueous, isoparaffinic hydrocarbon fluid (more specifically Isopar G) as a dispersant. PSD is expressed as a series of percentages. Each percentage indicates what proportion of particles are below the indicated size (in μm). For example, 99% μm of 49.9 indicates that 99% of particles are 49.9 μm or less.

Operational parameters of the 42-Nasus-isopar were set as follows:
Optical model: Default, particles RI=1.52, particles absorption index=0.1, Isopar GRI=1.42
Measurement: 3 measurements of 10 seconds
Pump/stirrer speed=2000 rpm
Obscuration level range-2-12 percent.
Samples were prepared by rolling the container gently for 30 seconds.

For the laser diffraction measurement, the Hydro EV cell was filled with 350 cc of the carrier. Pump speed was set to 2000 RPM and the pump was activated.

A manual measurement window was opened and requested optical model, and the sample name, source and type, bulk lot reference, and operator notes were entered. Alignment of the laser was conducted and the background was measured.

Mixed sample was added into the measuring cell, filled with blank until the obscuration is in the range specified in the obscuration window.

A waiting time of 20-30 seconds allowed sample dispersion.

The “start” button was pressed for the first measurement. Measurements were repeated after 1 and 3 min. At the end of the measurement, the measurement window was closed, the best result was selected and the report was printed.

Unless otherwise indicated, all reference to “laser diffraction” in this specification and the accompanying claims refer to this protocol. Unless otherwise indicated all measurements of PSD in this specification and the accompanying claims refer to this protocol.

### Protocol for Viscosity Measurement

All viscosity measurements referred to throughout this specification were performed using a rotational viscometer having a small sample adapter with a spindle having coaxial cylinder geometry, at the indicated number of RPMs, and the results are expressed as centipoise (cP). As specifically exemplified, viscosity measurements were performed using a BROOKFIELD viscometer RV DV-PRO WXTRA having type SC4-21 spindle, and the results are thus expressed as cP (SC4-21).
1. All tests were conducted at room temperature.
2. The sample container, composing the sample adaptor, was provided with the viscometer as a kit and has a depth of about 60 mm and an internal diameter of about 18 mm. Internal volume is about 24 ml. After insertion of the weight, sample volume is about ~7.5 ml.
3. The liquid tahini, olive processed, or peanut butter product was added in sufficient volume to cover to top of the cylinder.
4. The viscometer model was DV-II+Pro EXTRA RV
5. The spindle was type SC4-21
6. The number of RPM is as indicated in Tables 1 and 2 hereinabove.
7. The amount of time needed before viscosity was recorded was selected automatically by the viscometer.
8. Samples were prepared by mixing with a high shear mixer to homogeneity. Claimed viscosity values result from implementation of this protocol.

### Exemplary Spray Drying Equipment

Spray drying is a common procedure in the food industry, and a wide variety of spray drying equipment is commercially available. One spray drying machine suitable for use in the context of various exemplary embodiments of the invention is the NIRO Atomizer (NIRO; Copenhagen Denmark). In general, spray dryers include a rotating atomizer which produces drops. These drops dry as they fall. A higher height for the atomizer contributes to increased drying capacity and/or decreased entrance temperature and/or decreased exit temperature. Alternatively, or additionally, an increase in temperature of drops exiting above the atomizer contributes to increased drying efficiency. According to various exemplary embodiments of the invention, the temperature of air entering above the atomizer is 200° C., 160° C., 130° C., 100° C., 90° C., 80° C., 70° C., 60° C., or intermediate or lower temperatures. Alternatively, or additionally, in some embodiments the entrance temperature of the dryer is 130° C., 140° C., 150° C., 160° C., or intermediate or lower temperatures.

In some exemplary embodiments of the invention, a vacuum spray dryer as described in U.S. Pat. No. 8,966,783 (fully incorporated herein by reference) is employed. Dryers of this type are available from Tanabe Engineering Corporation, Japan. In other exemplary embodiments of the invention, other types of vacuum spray dryers are employed. In some exemplary embodiments of the invention, a vacuum spray dryer or drum dryer with an operating temperature of 70° C., 60° C., 55° C., or intermediate or lower temperatures contributes to an improvement in rheology characteristics of the spray dried material or products which contain them.

### Exemplary Spray Drying Protocol

In some exemplary embodiments of the invention, crude tahini is mixed with water to produce a prepared tahini emulsion and dried in a spray dryer.

In some embodiments, prepared tahini emulsion is microfluidized at a pressure of at least 5000 PSI and then dried in a spray dryer. In some embodiments, crude tahini is microfluidized at a pressure of at least 5000 PSI and then mixed with water to produce a prepared tahini emulsion and dried in a spray dryer. In some exemplary embodiments of the invention, the prepared tahini emulsion is microfluidized at a pressure of at least 5000 PSI prior to the spray drying.

In some exemplary embodiments of the invention, RBE is added to the water at up to 12% by weight of the crude tahini and the solution is mixed. In some exemplary embodiments of the invention, the mixing is under heating. In some embodiments, the heating includes boiling for several minutes. In some embodiments, the heated solution is then cooled. In some exemplary embodiments of the invention, the resultant solution of RBE in water is used instead of water in the spray drying protocols above. In some exemplary embodiments of the invention, the resultant solution of RBE in water is microfluidized with mixing with tahini or without mixing with tahini before drying. In some exemplary embodiments of the innovation, the result solution of RBE in water is microfluidized. In some exemplary embodiments of the invention, the mixture of tahini and water (with or without RBE) is cooled to aid in formation and/or stabilization of an emulsion.

### Exemplary Rice Bran Extract

In some embodiments, RBE is added to prepared tahini or other finely ground oily seed suspensions containing water prior to spray drying. One example of RBE suitable for use in various exemplary embodiments of the invention is Nu-RICE/Nu-BAKE from RIBUS INC. (St. Louis; MO, USA).

### Exemplary Oily Seed Types

Microfluidization to produce homogenates and/or spray drying of the homogenates are expected to be applicable to a variety of oily seeds including, but not limited to, white sesame, red sesame, black sesame, nigella, peanuts, pistachios, almonds, Brazil nuts, macadamia nuts, hazelnuts, pecans, cashews, olives (with pits removed), sunflower seeds, corn kernels, wheat kernels, soybeans, rapeseeds, cottonseeds, flaxseeds, safflower seeds, mustard seeds, hemp seeds, poppy seeds, castor seeds, pumpkin seeds, Niger seeds, palm kernel, coconuts, perilla seeds, camelina seeds, chia seeds, black cumin seeds, sacha inchi seeds, moringa seeds, karanja seeds, watermelon seeds, coriander seeds, pomegranate seeds, grape seeds, prickly pear seeds, baobab seeds, tomato seeds, and red raspberry seeds

According to various exemplary embodiments of the invention, these seeds are ground using their natural oil, optionally with the addition of oil from another (vegetarian or not) source that may be either cold-pressed oil or refined oil.

### Exemplary Use Scenarios

Spray-dried powder produced from homogenates of sesame seeds and/or other oily seeds is expected to find utility as a substitute for powdered milk and/or powdered eggs in a wide variety of commercial food products including, but not limited to, chocolate, cookies, candy, bread, ground meat and pasta.

Chocolate tablets and chocolate commonly include spray-dried milk powder as an ingredient. Any substitute for spray-dried milk powder should have a similar PSD (i.e., 90%<30 μm). Further decreases in particle size contribute to increased smoothness of the resultant chocolate. The PSD of spray-dried tahini suggests it is an acceptable substitute for milk powder in the preparation of chocolate (See Table 3). In some embodiments of the invention, chocolate is manufactured using spray-dried tahini as a substitute for powdered milk.

Alternatively, or additionally, in some embodiments, spray-dried tahini is mixed with sugar(s) and/or flavorings (e.g., vanilla, cacao, nuts) to produce halva. Alternatively, or additionally, in some embodiments spray-dried tahini serves as a substitute for powdered milk in chocolate spread. Alternatively, or additionally, in some embodiments, spray-dried tahini is added to nut butters (e.g., peanut butter, almond butter, chestnut paste). Alternatively, or additionally, according to various exemplary embodiments of the invention spray-dried tahini powder serves as an ingredient in prepared cake frosting and/or powdered soup mix and/or seasoning mixes and/or powdered salad dressings and/or prepared salads and/or Hummus by adding Hummus powder and lemon, salt and spices and/or mayonnaise and/or mayonnaise substitutes.

### Comparison to Previously Available Alternatives

While there are spray dried products derived from nuts and oily seeds in the marketplace, these previously available alternatives contain only about 50% nuts/secds. The remainder of the product is bulking agent(s) such as maltodextrin. In sharp contrast, maltodextrin and/or other bulking agents are not required in powdered products derived from nuts and oily seeds according to exemplary embodiments of the invention.

### Exemplary Health Considerations

Microfluidization 110 (FIG. 1A) is known to disrupt bacterial cell walls and/or cell membranes, inactivating the bacteria. As a result, microfluidization of tahini (or comparable products prepared from other oily seeds or nuts) obviates a need for pasteurization or other heat treatments. Obviation of the need for pasteurization or other heat treatment contributes to the simplification of industrial-scale processes.

### Microfluidization of Crude Tahini Influences Emulsion Stability in Prepared Tahini

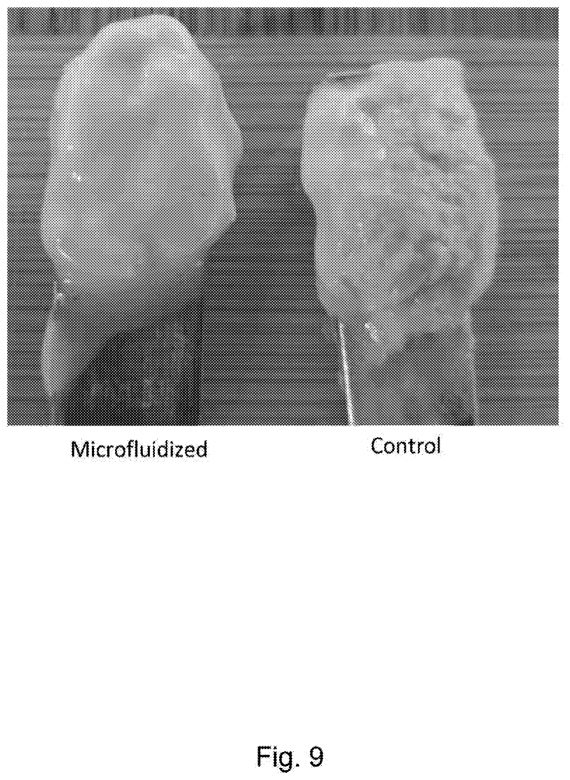

FIG. 9 is a photograph of samples of prepared tahini made from microfluidized crude tahini according to an exemplary embodiment of the invention, and prepared tahini made from control crude tahini after heating. Briefly 6.5 grams of microfluidized crude tahini and 6.5 grams of control crude tahini were each mixed with 4.5 grams of water to produce prepared tahini. The two prepared tahinis were each placed in a 90° C. water bath for 4 minutes. Samples were taken with a metal spatula, placed side by side and photographed. FIG. 9 clearly shows that the emulsion of the prepared tahini produced from microfluidized crude tahini remained intact after heating while the emulsion of the prepared tahini produced from control crude tahini broke down.

### Exemplary Reduced Fat Crude Tahini

In some exemplary embodiments of the invention, the change in PSD caused by microfluidization and/or the resultant reduction in viscosity contribute to an ability to remove oil from the crude tahini to produce a reduced fat crude tahini. According to various exemplary embodiments of the invention, the reduced fat crude tahini has 10%, 20%, 30%, 35%, or intermediate or greater percentages less fat/oil than the crude tahini from which it is prepared. In some embodiments the reduced fat crude tahini remains liquid and can be used just like conventional (full fat/oil) crude tahini. In some exemplary embodiments of the invention, the reduced fat/oil crude tahini has sufficiently low viscosity to be amenable to use in a squeeze bottle. This is in contrast to conventional crude tahini where oil removal contributes to a dramatic increase in viscosity which makes the reduced fat product virtually unusable.

Exemplary fat reduction methods include, but are not limited to:
(A) Pressing of roasted sesame seeds to remove the desired amount of oil followed by conventional grinding (ball mill and/or millstones/Macintyre/Reifiner Conche) followed by microfluidization according to an exemplary embodiment of the invention.
(B) Removal of the desired amount of oil from microfluidized crude tahini according to an exemplary embodiment of the invention by centrifugation and/or microfiltration.

The same strategy can be employed to prepare reduced fat/oil versions of other oily seed pastes (e.g., peanut butter or almond butter).

In some exemplary embodiments of the invention there is provided a method including: (a) microfluidizing crude tahini to produce microfluidized crude tahini; and (b) removing oil from the microfluidized crude tahini. In some embodiments, removing oil includes centrifuging the microfluidized crude tahini. Alternatively, or additionally, in some embodiments the removing oil removes at least 10% of the oil.

In some exemplary embodiments of the invention there is provided a reduced fat/oil microfluidized crude tahini composition having a viscosity cp SC4-21 at 11 RPM of 2296 or less. Alternatively, or additionally, in some exemplary embodiments of the invention there is provided a reduced fat microfluidized crude tahini composition having a viscosity cP SC4-21 at 5 RPM of 2756 or less.

It is expected that during the life of this patent many grinding and milling machines will be developed and the scope of the invention is intended to include all such new technologies a priori.

As used herein the term “about” refers to +10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use, and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively, or additionally, various exemplary embodiments of the invention exclude any specific feature, part, component, module, process or element which is not specifically disclosed herein.

Specifically, the invention has been described in the context of tahini but might also be used in the context of any oily seed paste, such as peanut butter, almond butter or other nut butters, and bean pastes (e.g., humus, black bean paste, or refried beans).

The Nature of the Fibrous Material in Microfluidized-Process Tahini and in Tahini Processed without Microfluidization

In order to study and better understand the nature of the fibrous material in a crude tahini subjected to a microfluidization process and in a crude tahini processed without microfluidization, the following samples were tested, and their PSD and fiber shape characteristics were analyzed:
1. “From 2021 Process 1” (refers to the crude tahini referred to in Table 1A as “Har Bracha 3”)—microfluidization process applied several times.
2. “Homogenaze Processing End 2 Homo No MFL”—grinding through stone Macintyre, and homogenizer, without microfluidization.
3. “MFL 87 4” (refers to the crude tahini referred to in Table 1A as “Har Bracha 0”)-microfluidization applied at the end of processing (200 μm entrance/87 μm exit).
4. “Regular Tahini 5”—regular processing with stone grinding.
5. “MFL Homo 6”—grinding through stone, Macintyre, and homogenizer, followed by one microfluidization step.
6. “Before MFL USA Homo (1) 7”—grinding through stone, Macintyre, and homogenizer, prior to the processing used for “MFL Homo 6”.
7. “M21” whole grain (with hulls) crude tahini after regular stone (refers to the sample referred to as 11A in Table 5B).
8. “M6 21” whole grain (with hulls) crude tahini after microfluidization process applied several times (refers to the sample referred to as 11D in Table 5B). The analyses were done on May-June 2026 by Sympatec GmbH (Germany).

The measurements were carried out using a high-speed image analysis instrument (QICPIC, Sympatec GmbH, Germany). As used herein, “QICPIC” refers to a dynamic image analysis instrument configured to determine particle size and/or particle shape characteristics by high-speed optical imaging of dispersed particles. Both the QICPIC dynamic image analysis system and the Malvern Mastersizer laser diffraction system (used in the Experimental section herein for measuring PSD) may be used to characterize particle size distributions, but they operate on different principles and provide different types of information. The Malvern Mastersizer measures PSD by laser diffraction, in which a laser beam is passed through a dispersion of particles and the resulting diffraction pattern is analyzed mathematically using optical models to infer an equivalent spherical PSD. In contrast, the QICPIC system operates by dynamic image analysis, in which high-speed cameras capture direct images of individual particles, and software processes those images to extract both size and shape information. Accordingly, while the Malvern Mastersizer primarily provides PSD data expressed as equivalent spherical diameters, the QICPIC system can additionally provide morphological descriptors such as particle length (LEFI), particle thickness (DIFI), straightness, elongation, aspect ratio, and other shape-related parameters that are useful for characterizing non-spherical, elongated, or fiber-like particles. In some embodiments of the present invention, both types of analysis are employed: laser diffraction using a Malvern Mastersizer or equivalent instrument is used to characterize bulk PSD, and dynamic image analysis using a QICPIC or equivalent instrument is used to characterize particle morphology and the presence of fiber-like or elongated particle structures.

When evaluating the fiber shape characteristics of the samples, reference was thus made to the terms: LEFI, DIFI, straightness, and elongation.

Details of the measurement procedure and the measurement results are summarized below. In addition to the characteristic values of the PSDs and averaged distribution curves presented as cumulative distribution Qᵣ(x) and distribution density q_{rig}, the shape descriptors and representative particle images are shown. The nomenclature and the presentation of the measurement results were in accordance with ISO 9276.

### Measurement Procedure

A measuring range designated M3 was selected for the analysis, with physical limits of 0.6-1126 μm (lower limit corresponds to the pixel; upper limit results from the number of pixel and size of frame), and ISO limits of 0.6-375 μm. Evaluation limits according to ISO 13322-2.

Dispersion. Particle dispersion was carried out using the wet disperser LIXELL (Sympatec GmbH). Isopar-G® was used as the dispersing liquid.

Sample preparation. A defined mass of each sample material was removed from the supplied container using a spatula. Prior to analysis, the samples were mixed thoroughly to ensure homogenization.

Measurement performance. Partial samples of each material were measured three times each in order to confirm repeatability of the QICPIC system and the quality of the applied sampling and dispersing technique. The sizes of the samples tested were as follows:
Sample “M21”—94.00, 74.00, or 114.00 mg
Sample “M6 21”—210.50, 263.00 or 158 mg
Sample “From 2021 Process 1”—0.10 ml
Sample “Homogenaze Processing End 2 Homo No MFL”—0.10 ml
Sample “MFL 87 4”—0.10 ml
Sample “Regular Tahini 5”—0.10 ml
Sample “MFL Homo 6”—0.10 ml
Sample “Before MFL USA Homo (1) 7”—0.10 ml

Particle size distribution based on LEFI and DIFI. Characteristic values (×10, ×50, and ×90) of the average cumulative distribution curves and the evaluation methods for the samples are set out in Table 8.

TABLE 8
Characteristic values of PSD x_{q}: size of Q % of total particle volume

| Sample | | x₁₀/μm | x₅₀/μm | x₉₀/μm |
|---|---|---|---|---|
| From 2021 Process 1 | LEFI | 24.07 | 39.82 | 72.93 |
| | DIFI | 2.04 | 2.78 | 4.47 |
| Homogenaze Processing End 2 | LEFI | 25.68 | 44.20 | 95.06 |
| Homo No MFL | DIFI | 2.16 | 3.39 | 7.45 |
| Regular Tahini | LEFI | 25.62 | 49.48 | 109.37 |
| | DIFI | 2.20 | 3.86 | 9.26 |
| MFL Homo 6 | LEFI | 24.37 | 39.51 | 75.41 |
| | DIFI | 2.08 | 2.98 | 5.15 |
| Before MFL USA Homo (1) 7 | LEFI | 25.26 | 43.57 | 96.64 |
| | DIFI | 2.15 | 3.35 | 7.45 |
| M21 | LEFI | 30.49 | 62.40 | 124.62 |
| | DIFI | 2.55 | 4.46 | 8.74 |
| M6 21 | LEFI | 28.00 | 62.16 | 124.73 |
| | DIFI | 2.34 | 3.97 | 8.01 |

Evaluation method. For evaluation of the measured data, a USER filter was applied based on the LEFI calculation mode in combination with the shape parameters elongation and straightness. This evaluation filter allows a fiber-oriented evaluation, in which particles having elongated and less compact fiber-like structure are preferentially observed, and may be adjusted and changed at any time. The evaluated particles were characterized using the shape descriptors straightness and elongation. A volume-based size distribution (Q₃, indicating cumulative distribution by volume; and q_{31g}, indicating volume-weighted distribution density curve plotted with particle size on a logarithmic scale (q₃ indicates distribution density by volume; and lg indicates logarithmic scale for the particle size axis)) and a cylindrical-volume-model were used for evaluation.

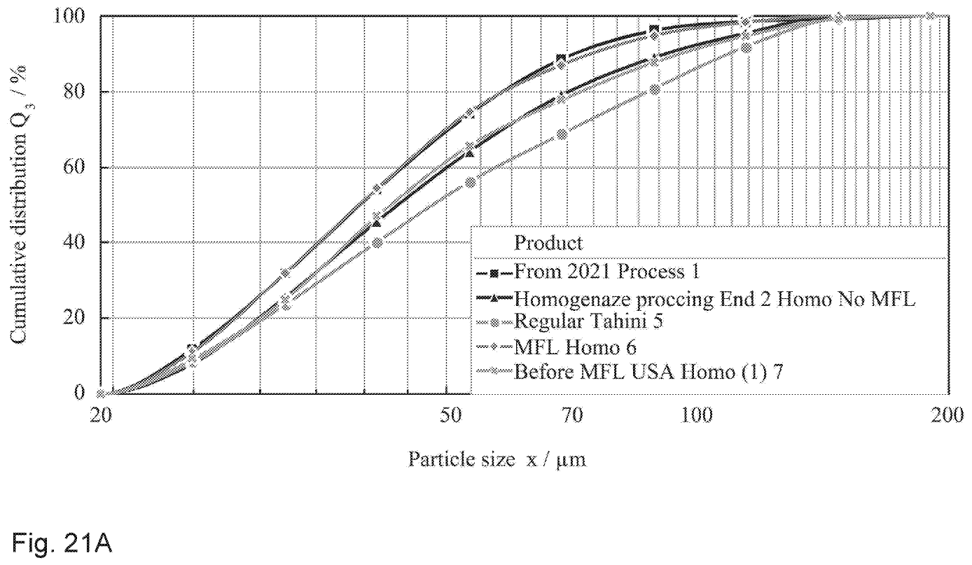

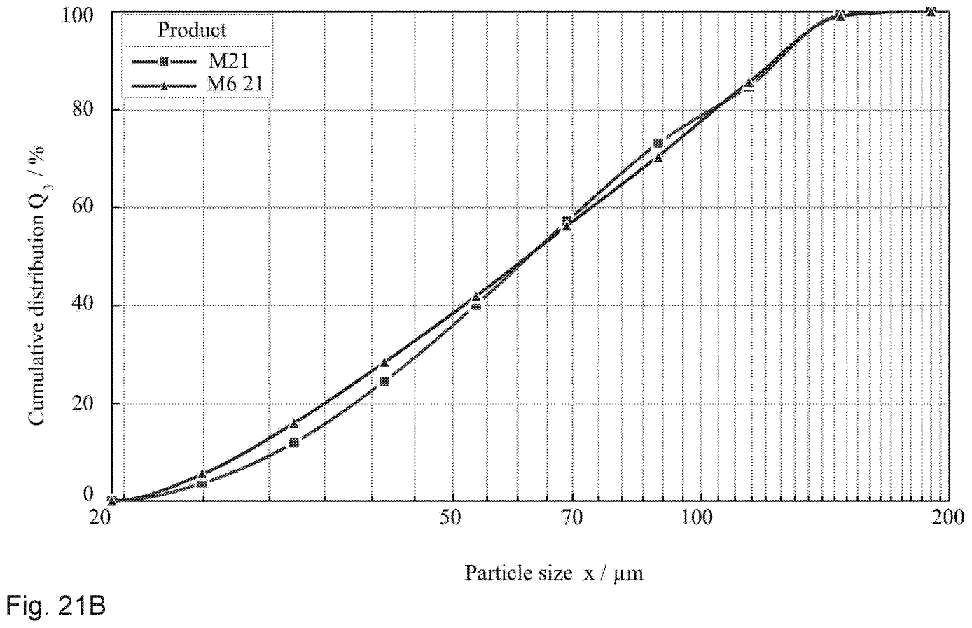

FIG. 21A shows the cumulative PSD curves Q3(×) in % for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7”, where particle size is expressed as LEFI, i.e., the length of the particle. Evaluation of LEFI showed that the length values generally followed the same trend observed for particle length. In particular, “MFL Homo 6” and “From 2021 Process 1” exhibited shorter fiber-like particles than “Before MFL USA Homo (1) 7” and “Homogenaze Processing End 2 Homo No MFL”, and the latter two exhibited thinner fiber-like particles than “Regular Tahini 5”.

FIG. 21B shows the cumulative PSD curves Q₃(×) for the whole grain (with hulls) crude tahini samples referred to herein as “M21” and “M6 21”, where particle size is expressed as LEFI. As shown, the samples have a similar distribution of the fiber-like particles, where the sample “M6 21” shows a slightly increased fraction of particles with shorter length values (LEFI) in the range of 25-55 μm compared to sample “M21”.

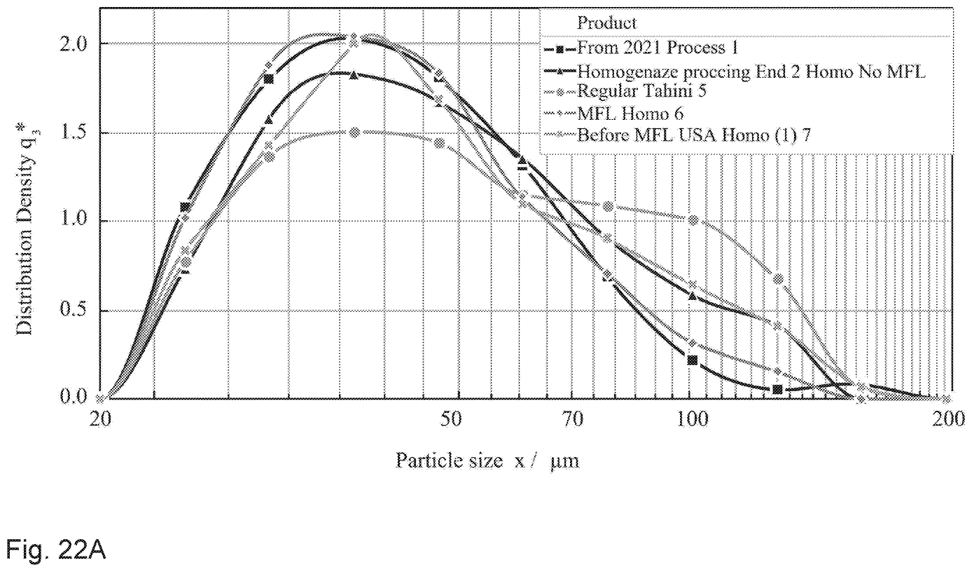

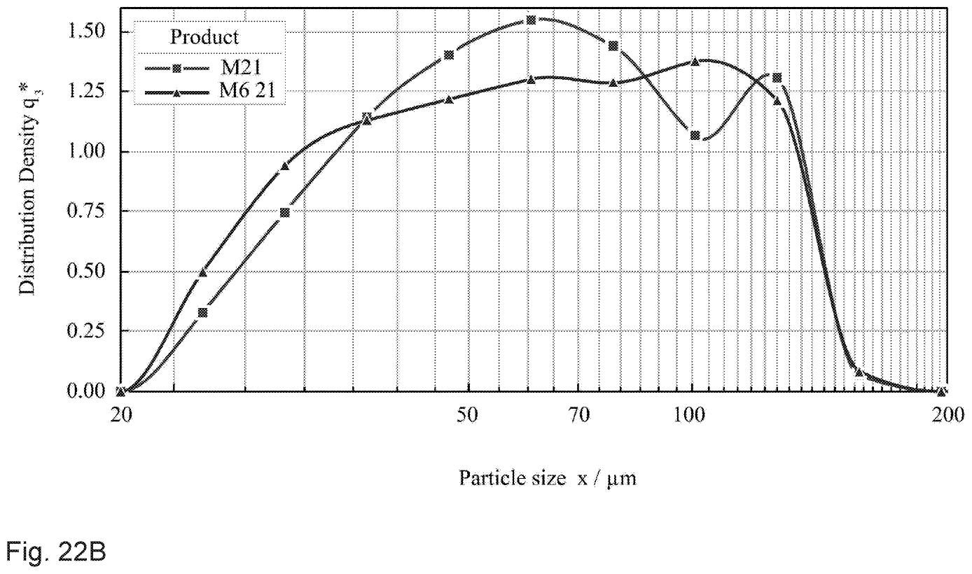

FIG. 22A shows the corresponding density distribution curves q_{31g} (×) for the crude tahini samples shown in FIG. 21A, likewise based on LEFI. As shown, the samples “From 2021 Process 1” and “MFL Homo 6” exhibited shorter fiber-like particles than “Before MFL USA Homo (1) 7” and “Homogenaze Proccing End 2 Homo No MFL”, and the latter two exhibited thinner fiber-like particles than “Regular Tahini 5”.

FIG. 22B shows the corresponding density distribution curves q_{31g} (×) for the whole grain crude tahini samples shown in FIG. 21B, likewise based on LEFI. As shown, sample “M6 21” showed the shortest fiber-like particles, while sample “M21” showed the longest fiber-like particles.

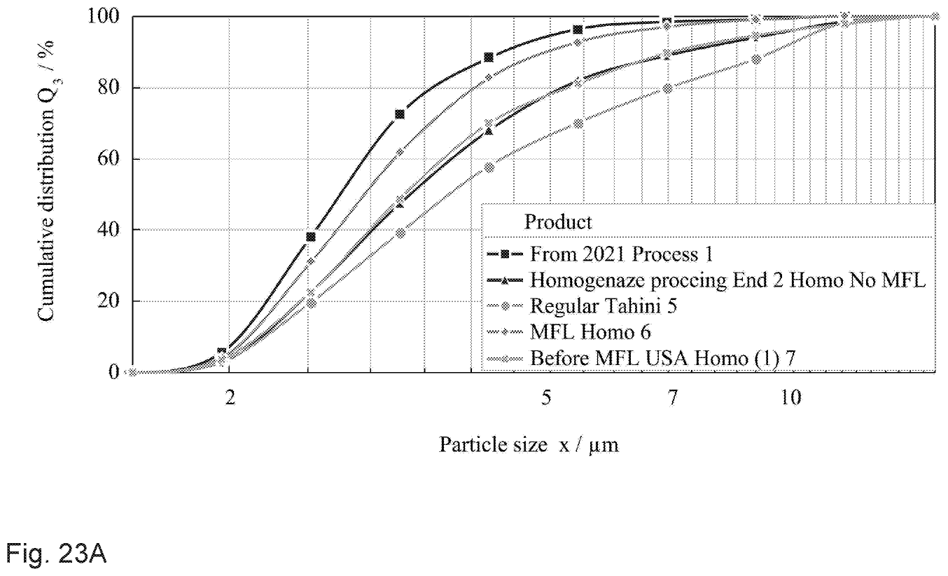

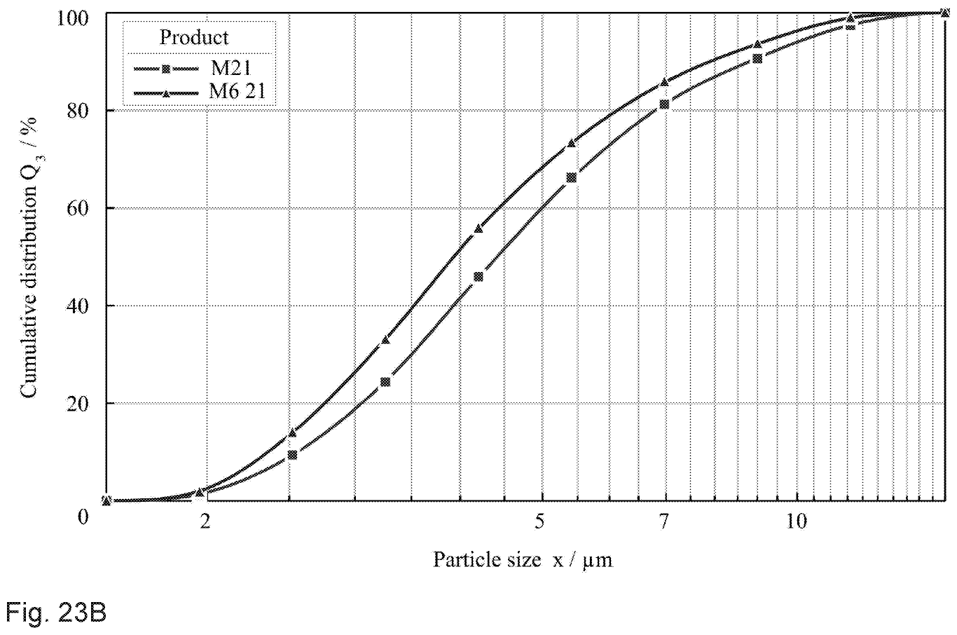

Thickness of fiber-like particles based on DIFI. FIG. 23A shows the cumulative PSD curves Q₃(×) for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7”, where particle size is expressed as DIFI, i.e., the thickness of the fiber-like particle. Evaluation of DIFI showed that the thickness pattern generally followed the same trend observed for particle length. In particular, “MFL Homo 6” and “From 2021 Process 1” exhibited thinner fiber-like particles than “Before MFL USA Homo (1) 7” and “Homogenaze Processing End 2 Homo No MFL”, and the latter two exhibited thinner fiber-like particles than “Regular Tahini 5”.

FIG. 23B shows the cumulative PSD curves Q₃(×) in % for the whole grain crude tahini samples referred to herein as “M21” and “M6 21”, where particle size is expressed as DIFI. The particle size in μm describes the thickness of the observed particles in each sample, i.e., the thickness of the fiber-like particles. Evaluation of DIFI showed that the thickness pattern generally followed the same trend observed for particle length. In particular, “M6 21” exhibited thinner fiber-like particles than “M21”.

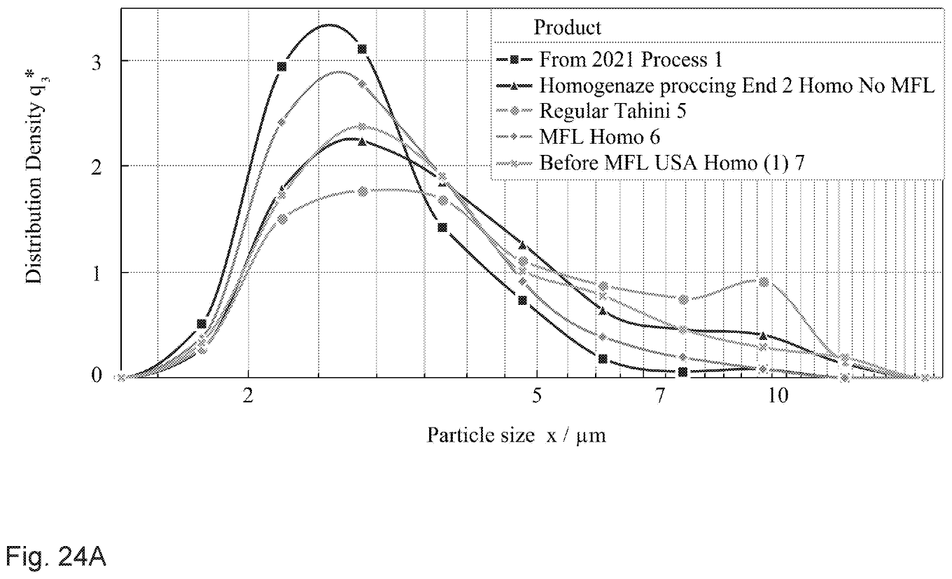

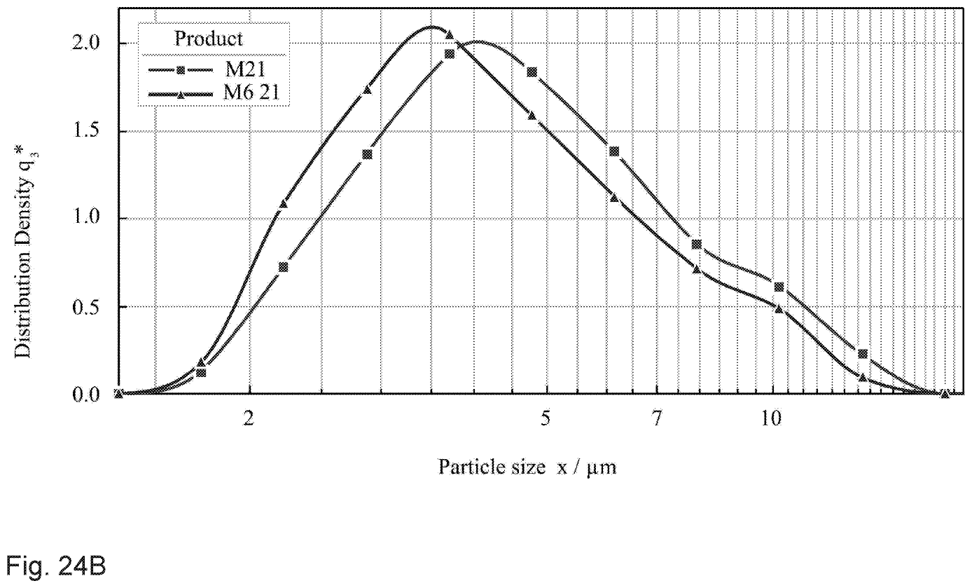

FIGS. 24A and 24B show the density distribution curves q_{31g} (×) for the crude tahini samples referred to herein as “From 2021 Process 1”, “Homogenaze Processing End 2 Homo No MFL”, “Regular Tahini 5”, “MFL Homo 6”, and “Before MFL USA Homo (1) 7” (24A); and for the whole grain crude tahini samples referred to herein as “M21” and “M6 21” (24B), where particle size is expressed as DIFI (the thickness of the particle).

Straightness and curled particles. The cumulative distribution of straightness values was used to compare the extent of curliness of the observed particles. Straightness is a parameter describing how curled the particles appear in the captured images. A value of 1, or close to 1, indicates a relatively straight fiber, whereas lower values indicate more curled structures.

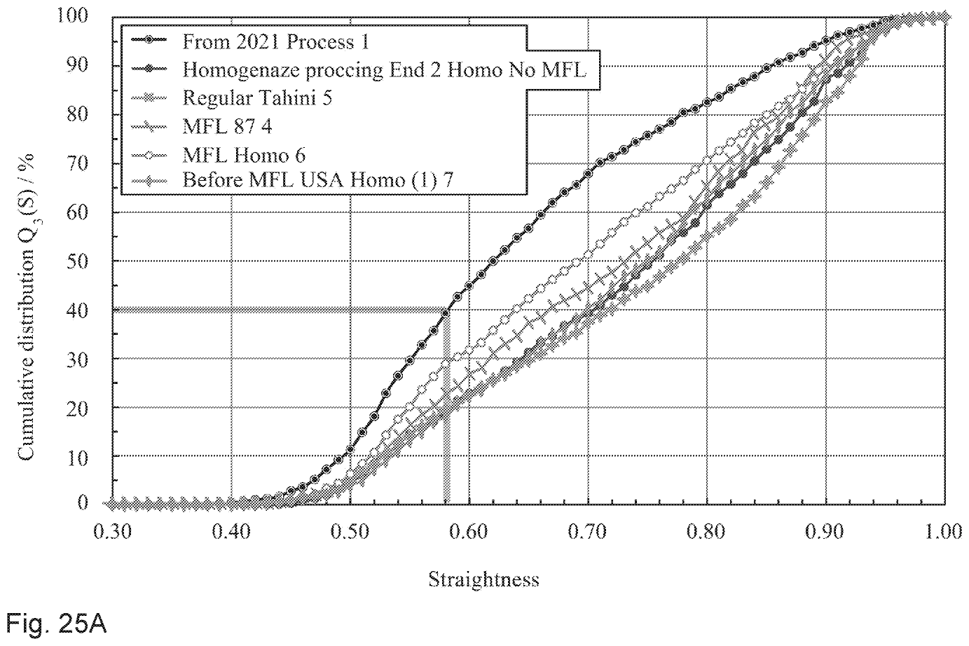

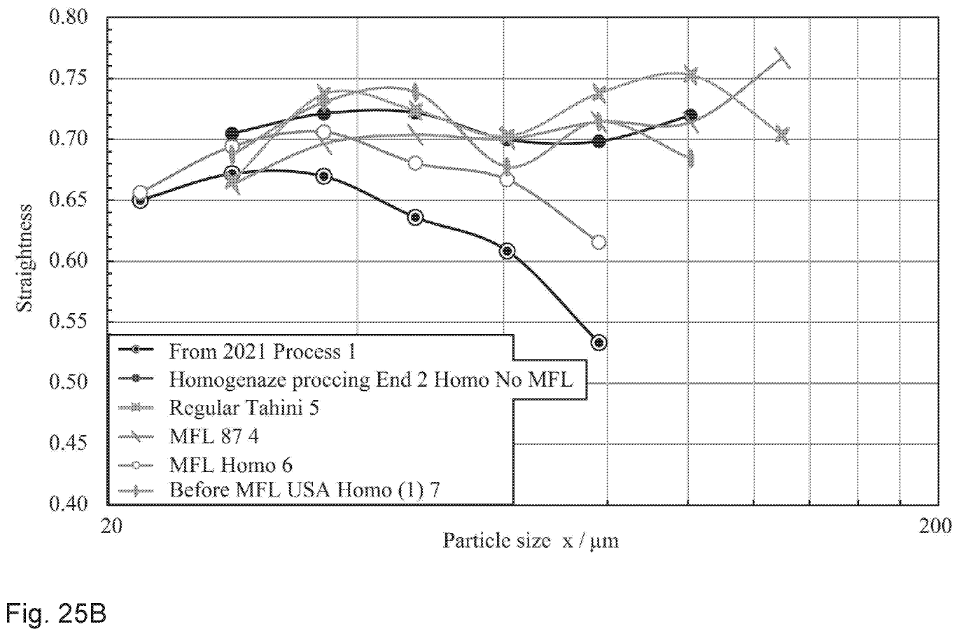

FIG. 25A shows the cumulative distribution of straightness values observed for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7”, together with an example illustrating the straightness value at 40% of the particle volume for one sample; and FIG. 25B shows the straightness value over particle size (LEFI) observed for said samples.

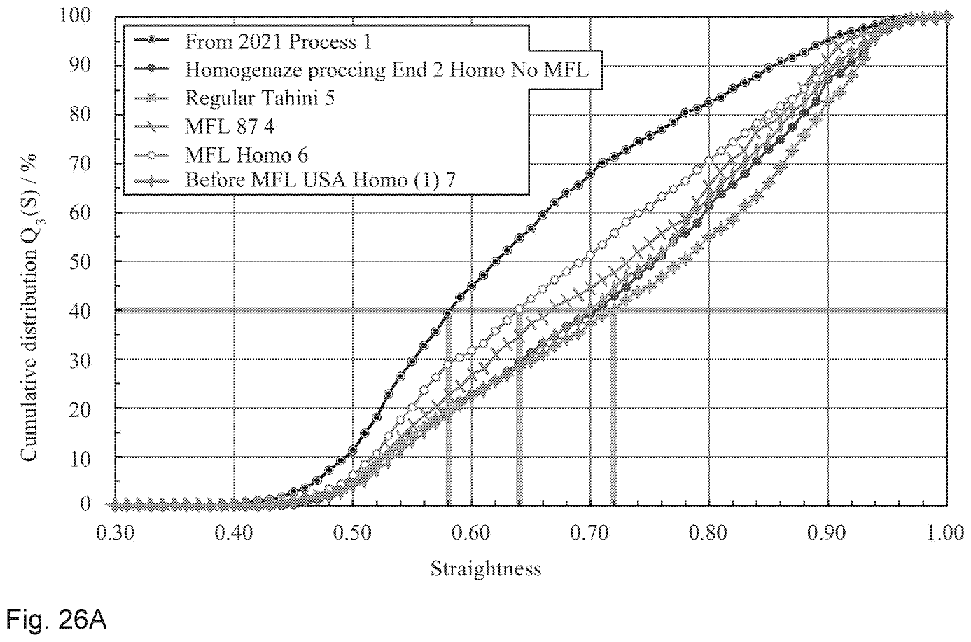

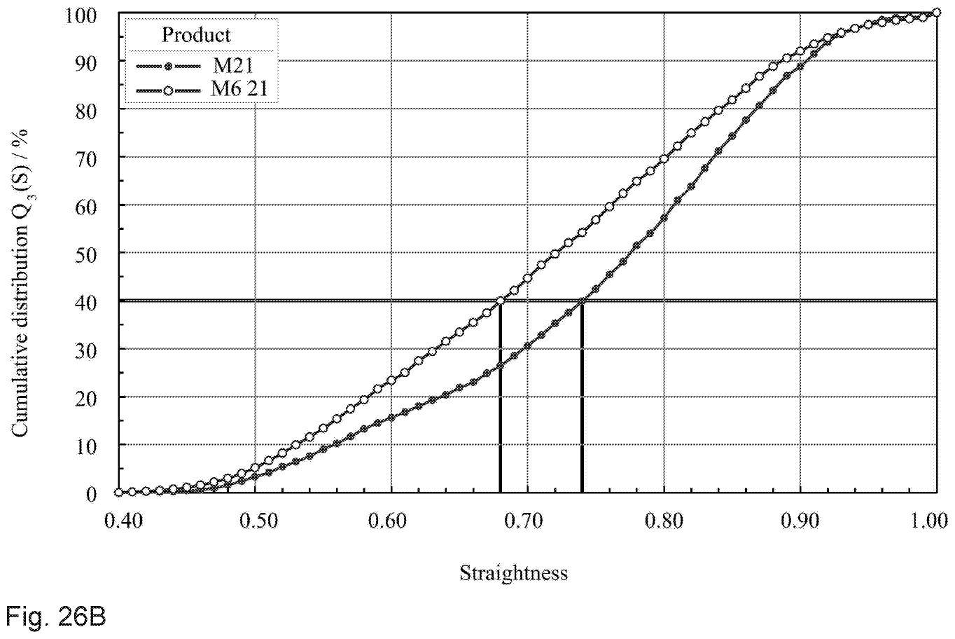

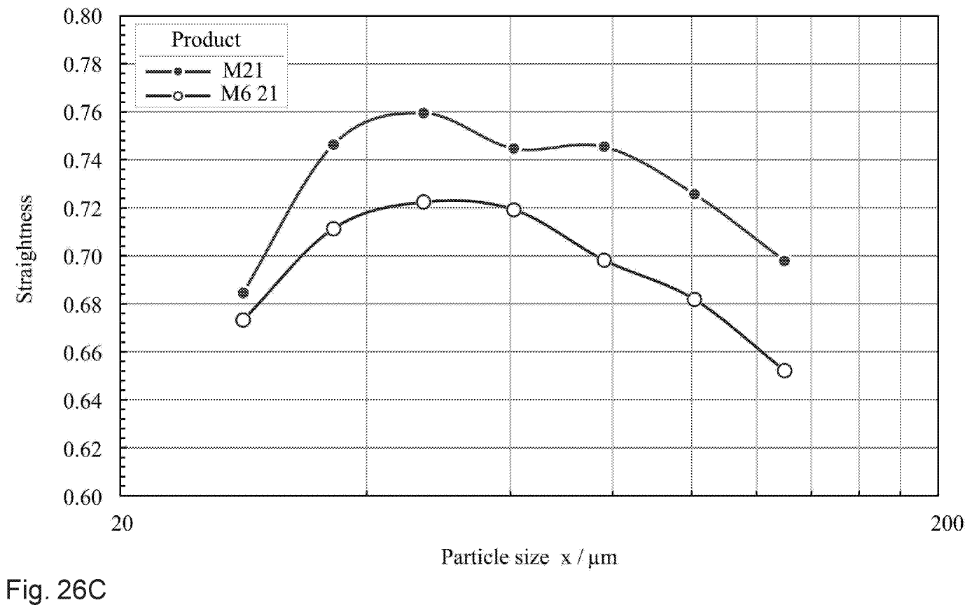

FIG. 26A shows the cumulative distribution of straightness values for the crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7”, with a horizontal reference line at 40% particle volume and vertical reference lines indicating corresponding straightness values for selected samples. As shown, “Homogenaze Processing End 2 Homo No MFL” and “Before MFL USA Homo (1) 7” exhibited generally similar straightness values, which was less than that observed for “Regular Tahini 5”, whereas “MFL Homo 6” and “From 2021 Process 1” tended to have curlier fiber-like particles with lower straightness values. For example, at 40% of the cumulative particle volume, the straightness values for the samples “From 2021 Process 1”, “MFL Homo 6”, “MFL 87 4”, and “Regular Tahini 5” were 0.58, 0.64, 0.66, and 0.72, respectively (thus, for straightness at this cumulative fraction: “Regular Tahini 5”> “MFL Homo 6”> “From 2021 Process 1”). As these relationships were observed throughout the relevant range of the cumulative distribution for these samples, it may be concluded that the particles observed in “Regular Tahini 5” were straighter than those in “MFL 87 4”, which were straighter than those in “MFL Homo 6”, which were straighter than those in “From 2021 Process 1”.

FIG. 26B shows the cumulative distribution of straightness values for the whole grain (with hulls) crude tahini samples referred to herein as “M21” and “M6 21”, with a horizontal reference line at 40% particle volume and vertical reference lines indicating the corresponding straightness values. As shown, “M6 21” exhibited generally less straightness values compared to “M21”, whereas “M6 21” tended to have curlier fiber-like particles with lower straightness values. For example, at 40% of the cumulative particle volume, the straightness values for “M6 21” and “M21” were 0.68 and 0.74, respectively (thus, for straightness at this cumulative fraction: “M21”> “M6 21”).

As further noted, curlier fibers were not necessarily longer than straighter fibers. Fibers may have the same measured length while differing in observed morphology, such that one particle appears more curled than another without a corresponding increase in particle length. FIG. 26C shows the straightness over particle size (LEFI) observed for said whole grain crude tahini samples.

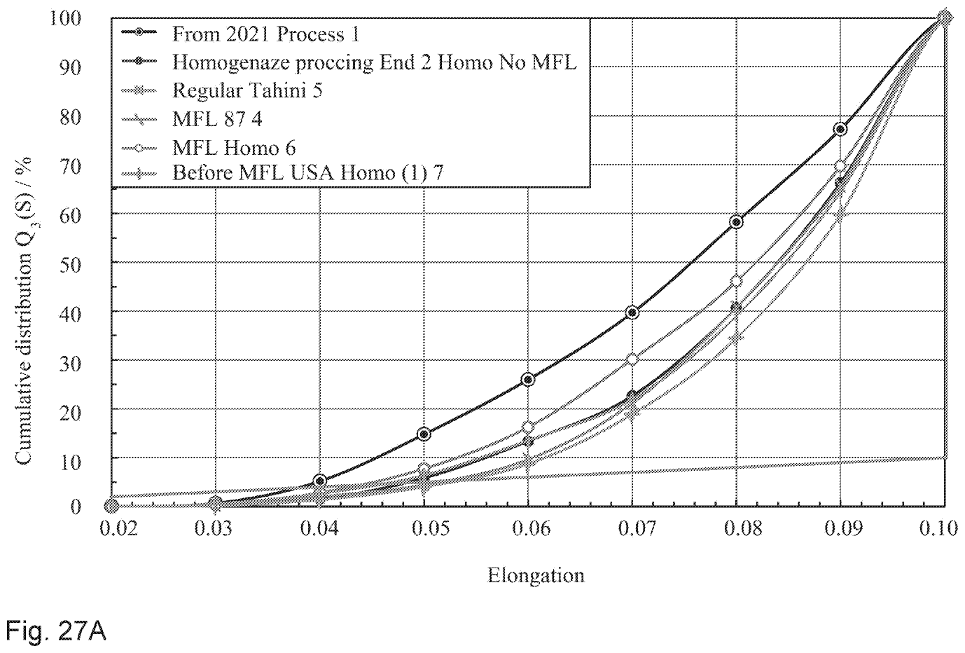

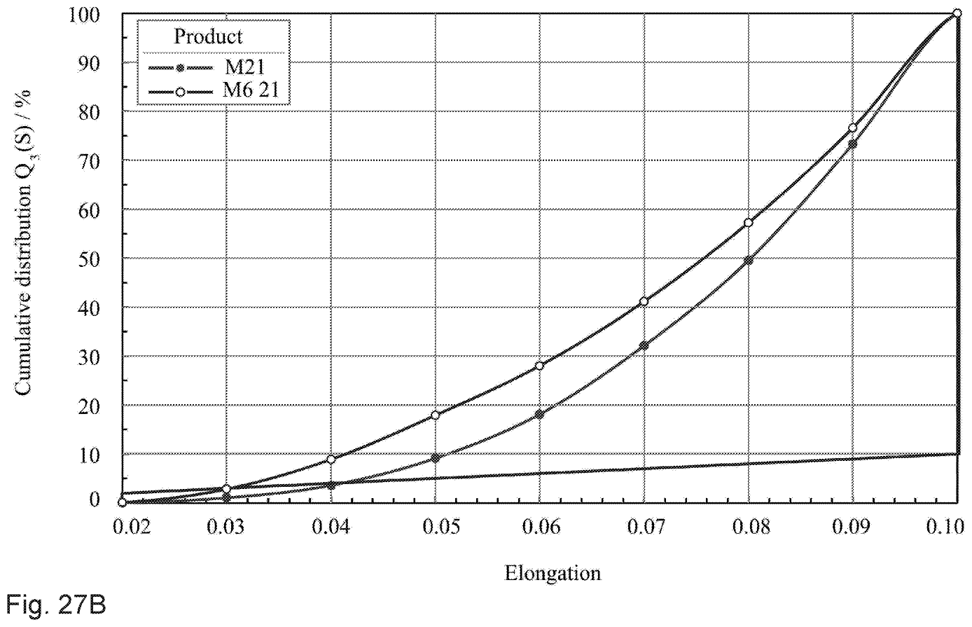

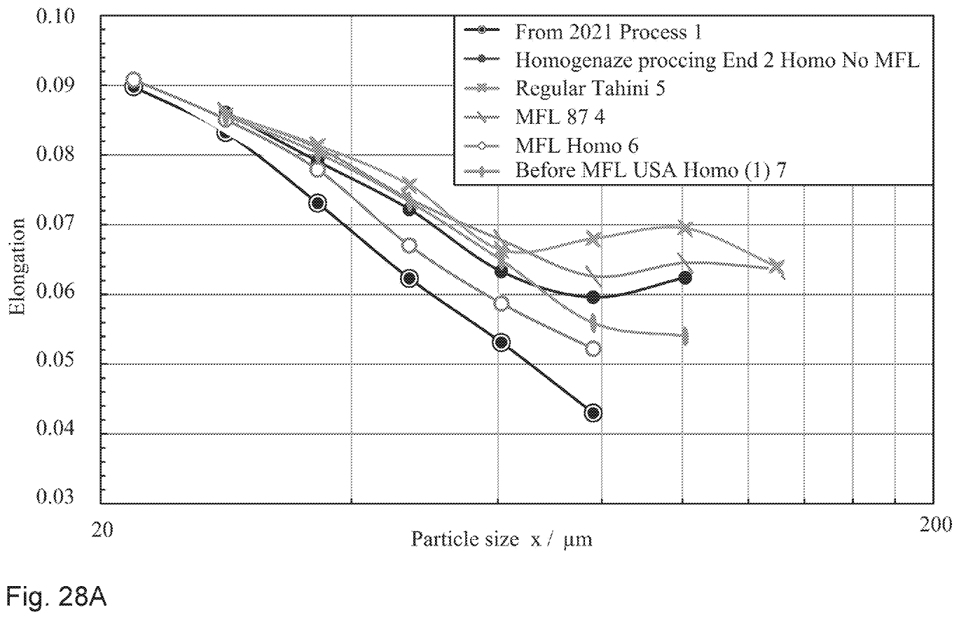

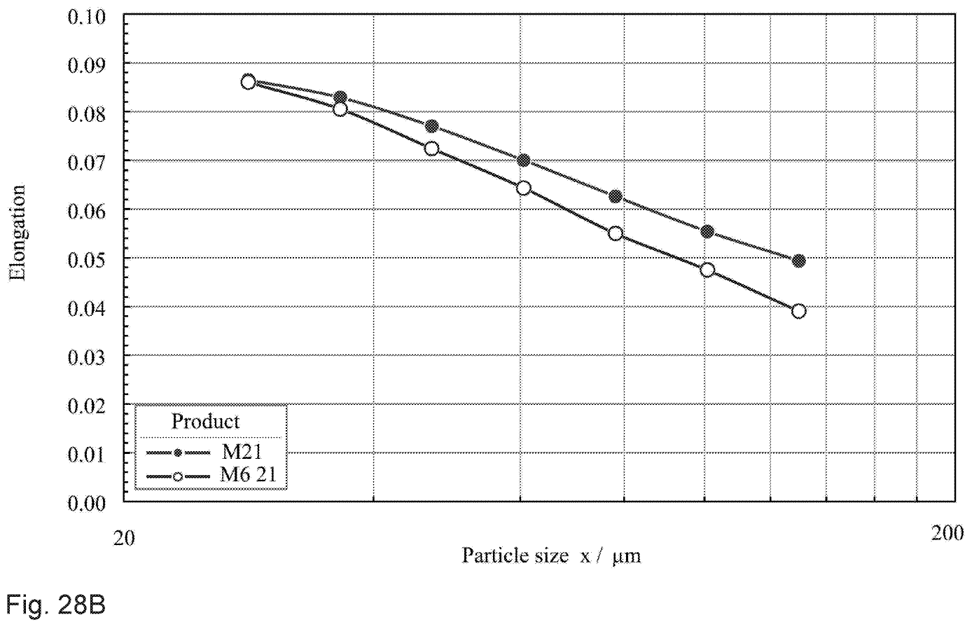

FIGS. 27A and 27B show the cumulative distribution of elongation values observed for the tested crude tahini samples referred to herein as “From 2021 Process 1”, “Homogenaze Processing End 2 Homo No MFL”, “Regular Tahini 5”, “MFL 87 4”, “MFL Homo 6”, and “Before MFL USA Homo (1) 7”; and for the whole grain (with hulls) crude tahini samples referred to herein as “M21” and “M6 21”, respectively. FIG. 28A shows the elongation over particle sizes x/μm of values for said crude tahini samples, and FIG. 28B shows the elongation over particle sizes x/μm of values for all said whole grain (with hulls) crude tahini samples.

TABLE 9
Characteristic values of the cumulative distribution
of shape descriptor, s_{q} -
value (straightness and elongation) of the shape
descriptor for which Q % of all particles
have a value of smaller or equal value (for FIGS. 25-28)

| | Shape | s₁₀ | s₅₀ | s₉₀ |
|---|---|---|---|---|
| Sample | descriptor | s₁₀ | s₅₀ | s₉₀ |
| From 2021 Process 1 | Straightness | 0.493 | 0.620 | 0.851 |
| | Elongation | 0.046 | 0.076 | 0.096 |
| Homogenaze Processing End 2 | Straightness | 0.530 | 0.752 | 0.918 |
| Homo No MFL | Elongation | 0.055 | 0.084 | 0.097 |
| MFL 87 4 | Straightness | 0.524 | 0.728 | 0.892 |
| | Elongation | 0.060 | 0.083 | 0.097 |
| Regular Tahini | Straightness | 0.529 | 0.777 | 0.922 |
| | Elongation | 0.061 | 0.086 | 0.097 |
| NFL Homo 6 | Straightness | 0.516 | 0.692 | 0.904 |
| | Elongation | 0.053 | 0.082 | 0.097 |
| Before MFL USA Homo (1) 7 | Straightness | 0.535 | 0.748 | 0.908 |
| | Elongation | 0.056 | 0.084 | 0.097 |
| M21 | Straightness | 0.559 | 0.777 | 0.904 |
| | Elongation | 0.051 | 0.080 | 0.096 |
| M6 21 | Straightness | 0.530 | 0.721 | 0.888 |
| | Elongation | 0.041 | 0.076 | 0.096 |

The results shown in FIG. 27A and FIG. 28A reflect the observed PSD, where the samples “From 2021 Process 1”, “MFL Homo 6” and “MFL 87 4” are shorter than “Before MFL USA Homo (1) 7”, “Homogenase Processing End 2 Homo No MFL” and “Regular Tahini 5”, meaning they show the least compact and elongated particles, less than 0.084 at s50 which correspond to short fiber-like shapes. On the other hand, the “Regular Tahini 5” shows higher values for this value corresponding to longer fiber-like particles. The observed PSD, where the samples “M6 21” are shorter than “M21” show the least compact and elongated particles less than 0.076 at s50 compared to “M21” 0.080 at s50, which correspond to short fiber-like shapes.

Both samples at FIG. 27A and FIG. 28A show similar profiles for the observed shape descriptors, whereas the sample “From 2021 Process 1”, “MFL Homo 6” and “MFL 87 4” are shorter than “Before MFL USA Homo (1) 7”, “Homogenase Processing End 2 Homo No MFL”, and “Regular Tahini 5”, and have lower values for both straightness and elongation. This is an indication of particles with a straighter shape in comparison to samples “From 2021 Process 1”, “MFL Homo 6” and “MFL 87 4”.

Both samples at FIG. 27B and FIG. 28B show similar profiles for the observed shape descriptors, whereas the sample “M6 21” has lower values for both straightness and elongation. This is an indication of particles with a straighter shape in comparison to sample “M21”.

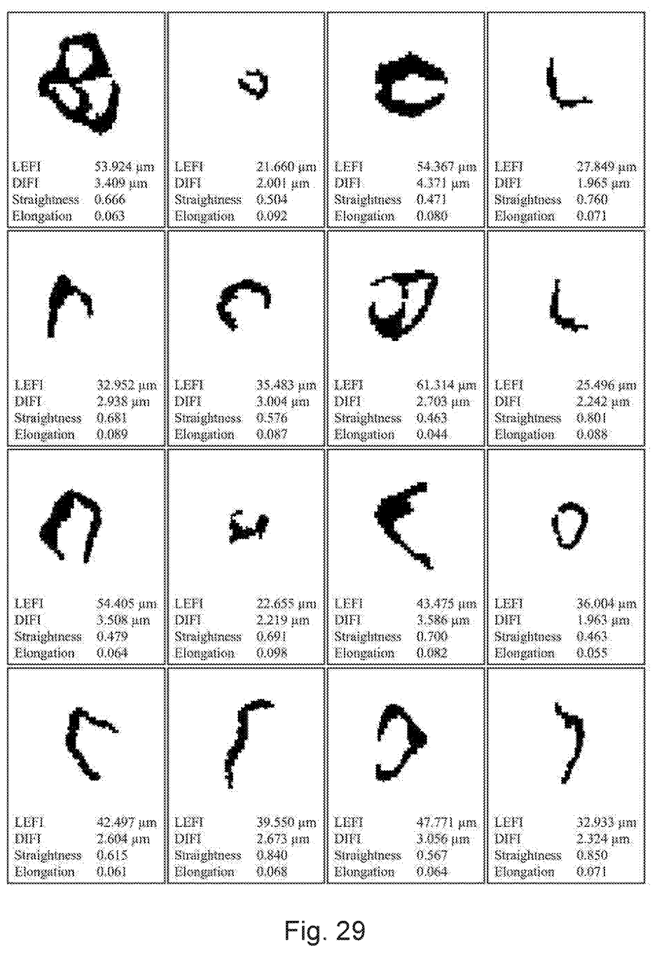

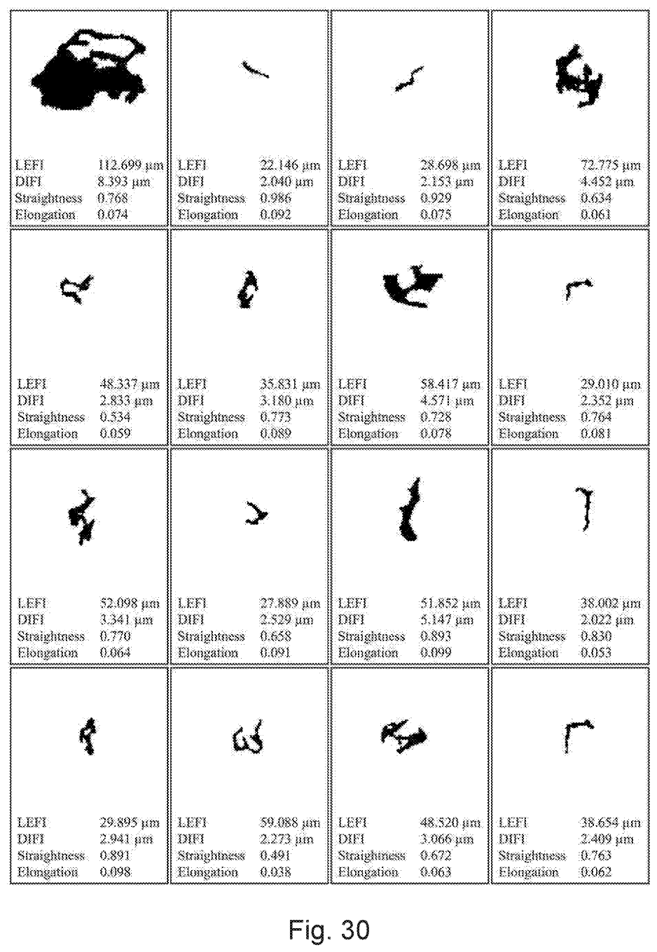

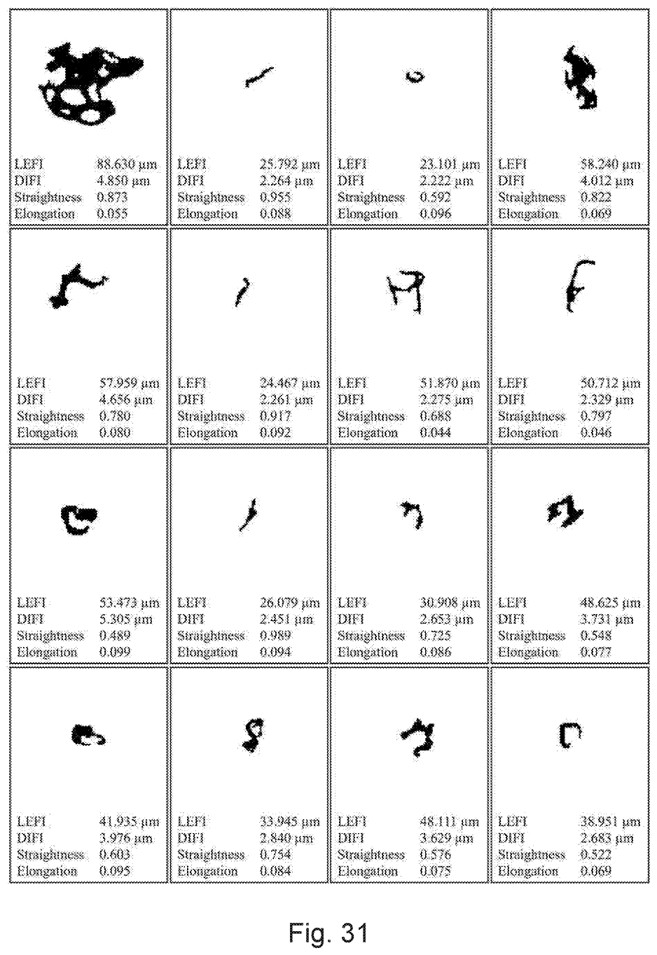

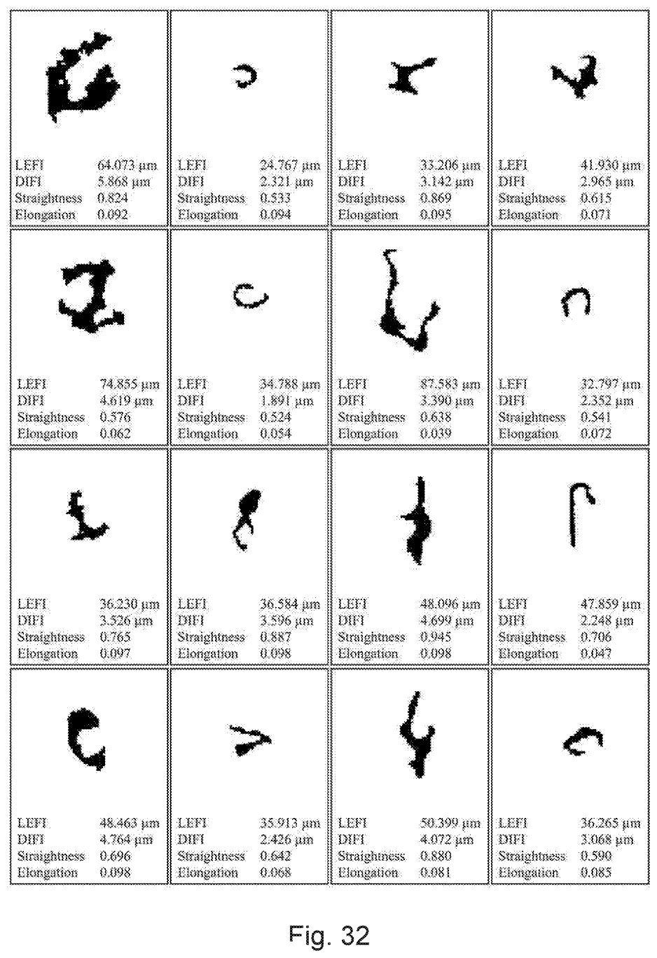

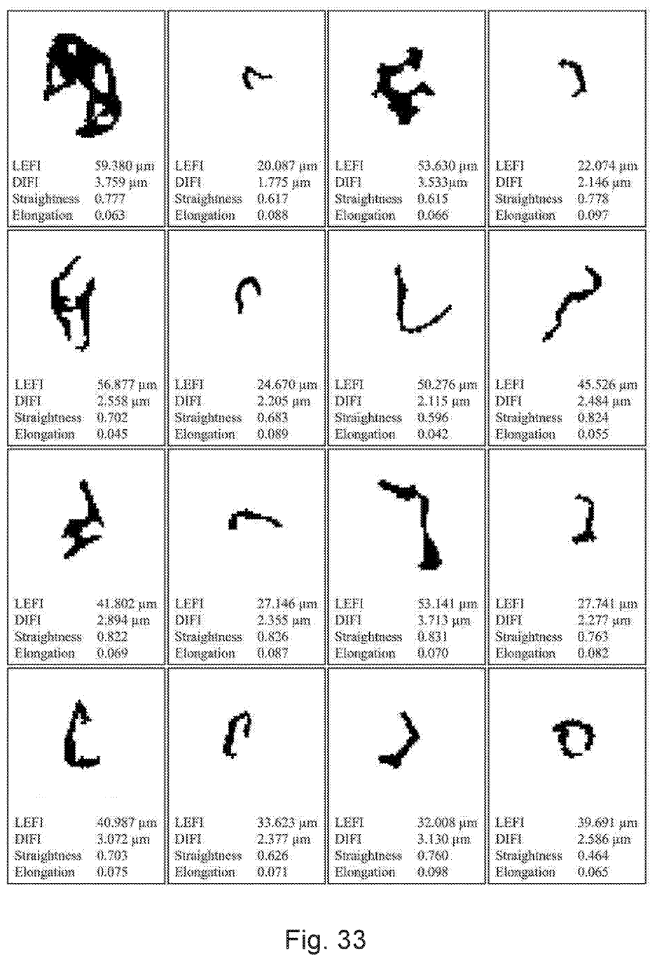

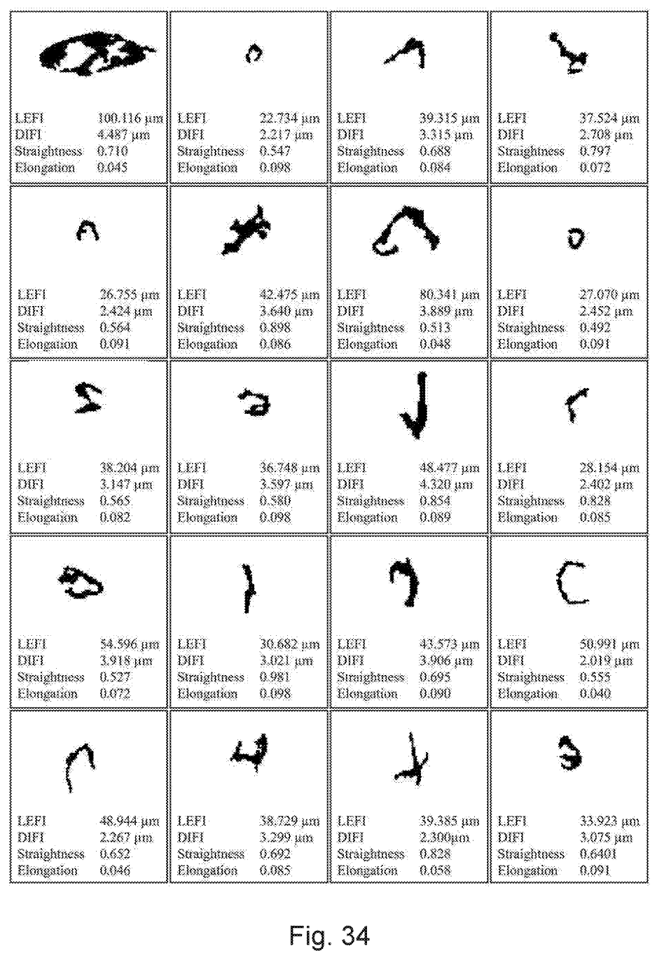

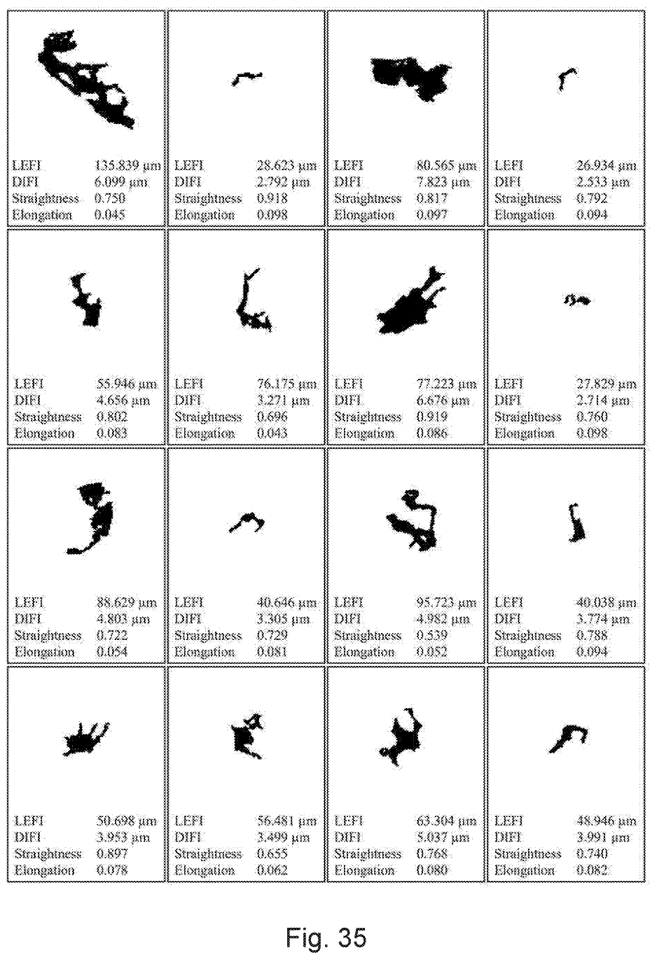

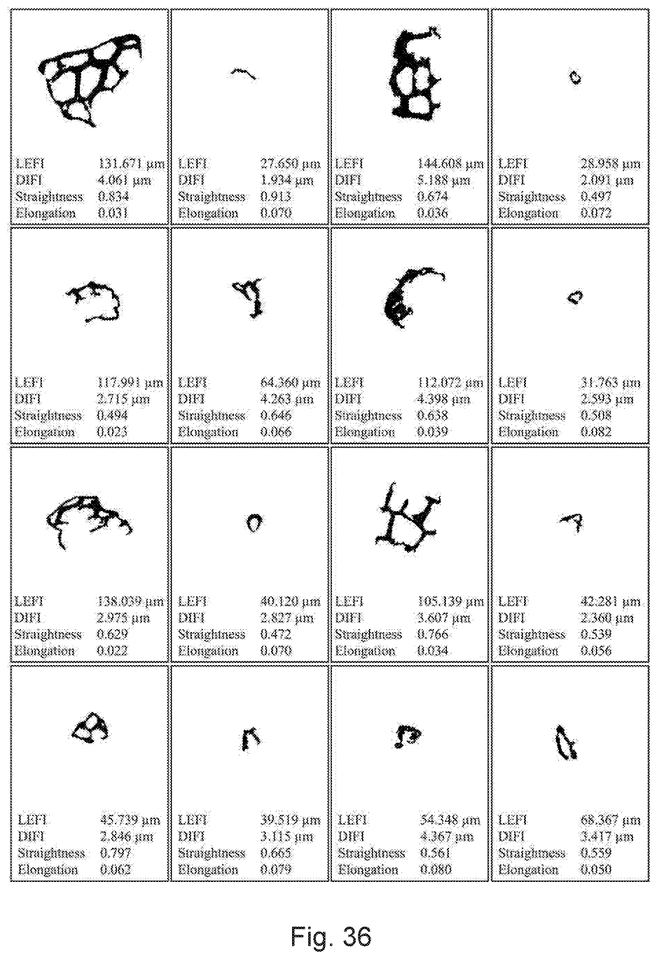

The particle size and shape distributions were calculated based on binary images recorded with the QICPIC instrument. The stored images can be exported, played or converted into a video format with the PAQXOS software. These stored raw data of a measurement on the one hand allow a re-evaluation among other points of view, and on the other hand the selection of specific particles from a particle gallery by individually selectable filter criteria. FIGS. 29-34 demonstrate excerpts from the particle gallery, showing fiber-like particles observed in the cases of the samples “From 2021 Process 1” (FIG. 29), “Homogenaze Processing End 2 Homo No MFL” (FIG. 30), “MFL 87 4” (FIG. 31), “Regular Tahini 5” (FIG. 32), “MFL Homo 6” (FIG. 33), “Before MFL USA Homo (1) 7” (FIG. 34), “M21” (FIG. 35), and “M6 21” (FIG. 36).

Average number of particles observed. The average number of particles detected by the software and included in the size evaluation for each sample is listed in Table 10.

TABLE 10
The average number of particles detected by the software
and included in the size evaluation for each sample

| | Average number of |
|---|---|
| Sample | particles observed |
| From 2021 Process 1 | 324 |
| Homogenaze Processing End 2 | 251 |
| Homo No MFL | |
| MFL 87 4 | 201 |
| Regular Tahini 5 | 222 |
| MFL Homo 6 | 328 |
| Before MFL USA Homo (1) 7 | 308 |
| M21 | 834 |
| M6 21 | 1485 |

Limitations of the analysis. The analytical system used in this study enabled conclusions regarding particle size distributions and shape characteristics only. It did not provide information regarding the individual solubility of the particles present in the samples. In addition, the measurements were performed in Isopar G (oil), and therefore no information was obtained regarding particle behaviour in water. It was observed that measurements in water were not feasible due to poor dispersion.

The relationship between a fiber's “curly” shape and its solubility. Without being bound by a particular theory, it is postulated that the morphology of fiber-like particles or fiber-containing structures in processed sesame-derived material may influence the solubility, hydration behavior, and accessibility of associated components. On a molecular level, fibers or fiber-like structures having a flexible, helical, or curled spatial configuration are generally associated with soluble fiber characteristics, whereas fibers having a straight, rigid, and tightly packed crystalline structure are generally associated with insoluble fiber characteristics.

In the case of straight and rigid structures, such as cellulose, the molecular chains are linear and bind tightly to one another through hydrogen bonding, forming a dense crystalline lattice. This compact packing substantially excludes water penetration, rendering the material largely insoluble. In contrast, fibers or polysaccharide structures having a curled, branched, or helical configuration, such as beta-glucan or pectin, exhibit irregular chain conformations often referred to as random coils. Because these chains are bent, kinked, or irregularly arranged, they cannot pack tightly together, and interstitial spaces remain open. Water molecules can thus readily enter these spaces, causing the fiber to swell and form a viscous gel, which is characteristic of soluble dietary fibers.

In certain embodiments of the present invention, processing of sesame-based paste utilizing a microfluidizer, or any similar homogenization technology capable of reaching shear force of at least 1,000,000 l/sec, thus contributes to changes in the morphology of fiber-like particles or fiber-containing structures. Such changes may include shortening of elongated structures, increased curliness or irregularity, breakdown of aggregates, chain scission, or combinations thereof. As a result of these morphological changes, the processed material may exhibit altered interstitial spacing, increased exposed surface area, enhanced water absorption capacity, modified gel-forming behavior, or improved accessibility of fiber-associated components.

In certain exemplary embodiments, the fiber-associated components include lignans, polyphenols, phytoestrogens, antioxidants, and related sesame-derived bioactive compounds. Part of the polyphenols are non-extractable, as they are closely linked to, or “seized”, by other molecules, and are therefore not easily detectable. Without being bound by a theory, it is believed that the presence of curled, irregular fibers, that exhibit thinner or less densely packed fiber-like structures, facilitates interaction between such components and water, digestive enzymes, microorganisms, or fermentation media. In particular such embodiments, this enhanced interaction contributes to increased bioaccessibility, increased release of bound polyphenols, enhanced fermentation by probiotic bacteria if present in the processed material (e.g., processed sesame-derived material), production of sesame-derived polyphenol metabolites, or combinations thereof.

As has already been disclosed, the morphological changes in the fiber-like particles or fiber-containing structures referred to above alter how gut bacteria break down the fiber. This breakdown creates short-chain (C1-C6) fatty acids (SCFAs), which are capable of avoiding or limiting infections in the gut (Vinelli et al., Effects of dietary fibers on short-chain fatty acids and gut microbiota composition in healthy adults: A systematic review. Nutrients, 2022, 14 (13), 2559).

In this respect, a reference should be made to U.S. patent application Ser. No. 18/307,761 (US20240090557) of the same Applicant, directed to a composition comprising tahina and probiotic bacteria, formulated for oral administration, wherein said tahina has been microfluidized by passing through a fixed-geometry homogenization channel at a pressure of at least 5000 PSI. As has surprisingly been found at the time and disclosed in US20240090557, a composition as disclosed therein, comprising microfluidized tahina, Lactobacillus Plantarum, grape seed extract (GSE) and green tea extract (GTE), was stable in storage, wherein the probiotic Lactobacillus not only showed stability in the smooth tahina emulsion, but amazingly even propagated in the composition despite the known inhibitory effects of a minimal (very limited) amount of moisture as well as of sesame antioxidants (polyphenols) on bacterial growth (Kumar et al., Bioactive lignans from sesame (Sesamum indicum L.): evaluation of their antioxidant and antibacterial effects for food applications. J. Food Sci. Technol., 2015, 52 (5), 2934-2941). Without being limited by any particular theory, the inventor noted at the time that the bacteria, which is generally known as a beneficial part of various food products, are well preserved in the composition, and in fact metabolize some of the materials present supposedly including the polyphenols/antioxidants, which seems to be the reason for the increased bacterial count within the composition during the first week of storage. Based on this observation, it has been postulated that additional polyphenol metabolites are produced by said bacteria, including metabolites having molecular weights lower than that of the original polyphenols, which are probably more easily spread in the subject's body and penetrate the blood brain barrier as well. As further postulated by the inventor, some of the polyphenol metabolites produced by said bacteria may also affect the astrocytes, a specific type of glial cells found in the central nervous system (that are more susceptible to oxidative damage than neurons), which cleanse the brain by removing toxins, proteins and unwanted molecules, thus help forming and maintaining the blood-brain barrier.

The effect of mechanical processing on fiber structure and molecular weight is also supported by scientific literature. For example, Kivelä et al., 2010 (Influence of homogenization on the solution properties of oat β-glucan, Food Hydrocolloids, 2010. 24 (6-7), 611-618) compared the impact of three homogenization techniques—including a pilot scale colloid mill, a two-stage high-pressure valve homogenizer, and a lab scale microfluidizer—on the structure and characteristics of oat beta-glucan. The authors observed a clear and irreversible decline in molecular weight, viscosity, and shear-thinning behavior, whereas the colloid mill did not significantly affect these parameters. The authors attributed the decrease in molecular weight to chain scission, breakdown of aggregates, or both. This finding supports the inventor's view that microfluidization, especially on very hard and strong fiber, is an efficient method for modifying polysaccharide structure and enhancing structural stability and mechanical fragmentation during storage and processing.

Thus, in certain embodiments of the present invention, the morphological changes observed in microfluidized sesame paste, including the presence of shorter, thinner, and curlier fiber-like particles, are consistent with processing-induced chain scission, aggregate breakdown, and structural modification analogous to those reported in the scientific literature for other polysaccharide and fiber-containing systems. As postulated by the inventor, the shorter, curled fibers resulting from the microfluidization process drastically slow down the oiling off process during process, and consequently, in sharp contrast to regular (i.e., non-microfluidized) crude tahini and whole grain crude tahini, the microfluidized variant does not form a hard sediment at the bottom of the container during storage.

In certain exemplary embodiments, the curly or irregular morphology observed in processed sesame-derived material is associated with improved functional properties. For example, curled fiber-like particles may permit better (facilitates excellent) dispersion in aqueous formulations with highly restricted water content (i.e., enable enhanced dispersion in low-moisture aqueous media), facilitate formation of stable emulsions, enable closer contact between probiotic bacteria (if present in the processed material) and fiber-associated antioxidants or polyphenols, or contribute to production of fermentation-derived metabolites having enhanced bioavailability. In certain particular such embodiments, such metabolites may be capable of crossing physiological barriers, including the blood-brain barrier, and reaching target tissues such as mitochondria.

Accordingly, in certain embodiments, the present invention provides processed sesame-derived compositions characterized by fiber-like particles or fiber-containing structures exhibiting morphological features associated with enhanced solubility, hydration, accessibility, or fermentation behavior. Such morphological features may include increased curliness, reduced straightness, shorter fiber length, reduced particle thickness, and combinations thereof, as determined by dynamic image analysis or a similar available technique.

The relationship between fiber morphology and solubility characteristics is supported by established principles of nutritional biochemistry, polymer chemistry, and food science. The spatial configuration of polysaccharide chains, often referred to as chain conformation, determines whether a fiber will exhibit soluble or insoluble behavior. Scientific literature on polysaccharide structure and solubility establishes that chain flexibility, branching, and the presence of kinks or bends in the molecular structure prevent tight crystallization and thereby permit water entry and fiber dissolution.

For example, Ramandeep Kaur et al., 2020 (Structural features, modification, and functionalities of beta-glucan, Fibers, 2020, 8 (1), 1) discloses that soluble fibers such as cereal beta-glucan contain a mixture of β(1→3) and β(1→4) glycosidic linkages, and that the β(1→3) linkages introduce kinks or angles into the chain, preventing tight packing and creating an extended random coil configuration. This spacious arrangement allows hydroxyl groups to bind water, rendering the fiber soluble and viscous. Similar principles are discussed in journals such as Biomacromolecules and Food Hydrocolloids, which frequently publish studies on the relationship between polysaccharide chain structure and hydration behavior.

In contrast, insoluble fibers such as cellulose are characterized by uniform β(1→4) glycosidic linkages that form perfectly linear, straight chains. As described in standard biochemistry textbooks such as Lehninger Principles of Biochemistry, and in publications such as McNamara et al., 2015 (A molecular description of cellulose biosynthesis, Annu Rev Biochem, 2015, 84, 895-921) cellulose chains align in a dense, parallel, crystalline lattice held together by strong hydrogen bonds, completely excluding water and rendering the material highly insoluble.

An exception to the general rule that helical or coiled structures are soluble is resistant starch, which is discussed in publications such as Nissar et al., 2017 (Resistant starch-chemistry and nutritional properties, International Journal of Food Science and Nutrition, 2017, 2 (6), 95-108) and related review articles such as Clarkson et al., 2013 (The relationships among isokinetic endurance, initial strength level, and fiber type, Research Quarterly for Exercise and Sport, 2013, 53, 15-19). Resistant starch molecules such as amylose naturally form helical structures, but during retrogradation (cooling after cooking) these helices pack together tightly into double helices within a dense crystalline structure, blocking water and enzyme penetration and behaving functionally as an insoluble fiber despite the helical origins.

### a Whole Grain Crude Tahini

In another aspect thus disclosed herein is a whole grain crude tahini comprising fiber-like particles, wherein when measured by dynamic image analysis using a QICPIC instrument with a USER filter based on LEFI in combination with elongation and straightness for selecting fiber-like particles for evaluation, in a wet dispersion in Isopar G, using a volume-based size distribution and a cylindrical-volume model for the particles, said whole grain crude tahini is characterized by a fiber-like particle population having straightness s50 value lower than 0.777, e.g., ≤0.775, ≤0.770, ≤0.765, ≤0.760, ≤0.755, ≤0.750, ≤0.745, ≤0.740, ≤0.735, ≤0.730, ≤0.725, ≤0.720, ≤0.715, ≤0.710, ≤0.705, ≤0.700, ≤0.695, ≤0.690, ≤0.685, ≤0.680, ≤0.675, ≤0.670, ≤0.665, ≤0.660, ≤0.655, ≤0.650, ≤0.645, ≤0.640, ≤0.635, ≤0.630, ≤0.625, ≤0.620, ≤0.615, ≤0.610, ≤0.605, ≤0.600, ≤0.595, ≤0.590, ≤0.585, or ≤0.580.

The term “fiber-like particle” as used herein refers to a particle or particle-like structure observed in dynamic image analysis, that exhibits an elongated, non-spherical morphology characterized by a measurable length and thickness, and is distinguishable from compact or spherical particles. In some embodiments, fiber-like particles are identified and characterized using a fiber-oriented evaluation filter that preferentially detects particles having an elongated and less compact structure. In some embodiments, fiber-like particles are characterized by at least one of the parameters: particle length (LEFI), particle thickness (DIFI), straightness, elongation, aspect ratio, and curliness. Fiber-like particles may exhibit varying degrees of straightness or curliness. Fiber-like particles are typically evaluated using a cylindrical volume model rather than a spherical volume model, reflecting their elongated geometry. In the context of the present invention, fiber-like particles are observed in sesame-derived materials, including tahini, crude tahini, and whole grain crude tahini, as well as in related seed-based pastes and compositions.

As used herein in connection with dynamic image analysis using a QICPIC instrument or equivalent system, a “USER filter” refers to a user-defined or customizable evaluation filter that may be configured to selectively evaluate particles based on one or more specified criteria, including particle size parameters and/or shape descriptors. In some embodiments, a USER filter is configured to perform a fiber-oriented evaluation by preferentially detecting and analyzing particles having an elongated and less compact, fiber-like morphology, while optionally excluding or de-emphasizing particles having a compact, spherical, or irregular non-elongated morphology. In some embodiments, the USER filter is based on a calculation mode such as LEFI in combination with one or more shape parameters, including elongation and straightness, wherein the filter criteria may be adjusted to define threshold values, ranges, or combinations of parameters that identify particles of interest. For example, a USER filter may be configured to select particles having an elongation value above a specified threshold and a straightness value within a specified range, thereby enriching the analysis for elongated fiber-like structures. The use of a USER filter enables targeted evaluation of particle populations having specific morphological characteristics, and permits comparison among samples with respect to the presence, abundance, size distribution, and shape characteristics of fiber-like particles. The filter parameters can be adjusted and changed at any time to accommodate different sample types, processing conditions, or analytical objectives.

The term “LEFI” as used herein in connection with dynamic image analysis, refers to the length of a fiber-like particle or elongated particle as determined by image analysis. In some embodiments, LEFI represents the longest dimension of an observed particle and is used to characterize the particle size distribution of elongated or fiber-like structures. As used herein, “LEFI ×50” refers to the median particle length, i.e., the particle length value at which 50% of the cumulative particle volume distribution consists of particles having a length equal to or less than that value. Similarly, “LEFI ×10” and “LEFI ×90” refer to the particle length values at which 10% and 90%, respectively, of the cumulative particle volume distribution consists of particles having a length equal to or less than the stated value.

The term “DIFI” as used herein in connection with dynamic image analysis, refers to the thickness of a fiber-like particle or elongated particle as determined by image analysis. In some embodiments, DIFI represents a measure of the shortest dimension or diameter of an observed particle perpendicular to its length, and is used to characterize the thickness distribution of elongated or fiber-like structures. As used herein, “DIFI ×50” refers to the median particle thickness, i.e., the particle thickness value at which 50% of the cumulative particle volume distribution consists of particles having a thickness equal to or less than that value. Similarly, “DIFI ×10” and “DIFI ×90” refer to the particle thickness values at which 10% and 90%, respectively, of the cumulative particle volume distribution consists of particles having a thickness equal to or less than the stated value.

The term “straightness” as used herein in connection with dynamic image analysis, refers to a shape descriptor that quantifies the extent to which an observed particle exhibits a straight or curled morphology. Straightness is expressed as a numerical value, wherein a value of 1, or close to 1, indicates a relatively straight particle, and progressively lower values indicate increasingly curled, bent, or irregular particle morphologies. In some embodiments, straightness is used to distinguish among samples having differing degrees of fiber curliness or particle irregularity. As used herein, “straightness s50” refers to the median straightness value, i.e., the straightness value at which 50% of the cumulative particle volume distribution consists of particles having a straightness equal to or less than that value. Similarly, “straightness s10” and “straightness s90” refer to the straightness values at which 10% and 90%, respectively, of the cumulative particle volume distribution consists of particles having a straightness equal to or less than the stated value. Because straightness is inversely related to curliness, a lower s50 value indicates a particle population that is more curled, whereas a higher s50 value indicates a particle population that is straighter.

The term “elongation” as used herein in connection with dynamic image analysis, refers to a shape descriptor that quantifies the extent to which an observed particle exhibits an elongated form. In some embodiments, elongation is related to the aspect ratio of the particle. Elongation is used, optionally in combination with straightness, to identify and characterize fiber-like particles and to distinguish such particles from more compact or spherical particle morphologies. As used herein, “elongation s50” refers to the median elongation value, i.e., the elongation value at which 50% of the cumulative particle volume distribution consists of particles having an elongation equal to or less than that value. Similarly, “elongation s10” and “elongation s90” refer to the elongation values at which 10% and 90%, respectively, of the cumulative particle volume distribution consists of particles having an elongation equal to or less than the stated value. Higher elongation values generally indicate particles with a higher aspect ratio or more elongated morphology, whereas lower elongation values indicate particles that are less elongated or more compact.

In some embodiments, LEFI, DIFI, straightness, and elongation are determined using a fiber-oriented evaluation filter in combination with a cylindrical volume model and are reported as characteristic values of cumulative distributions, including ×10, ×50, ×90 for LEFI and DIFI, and s10, s50, s90 for straightness and elongation. As used herein, a “cylindrical volume model” refers to a computational model used in dynamic image analysis in which the volume of an observed elongated or fiber-like particle is calculated by approximating the particle as a cylinder. In some embodiments, the volume is calculated using the measured LEFI and DIFI according to the formula for the volume of a cylinder. The cylindrical volume model is particularly suitable for characterizing elongated, fiber-like, or non-spherical particles, and permits generation of volume-based particle size distributions (Q₃, q_{31g}) that more accurately reflect the true volume contribution of such particles than would a spherical volume model.

In certain embodiments, disclosed herein is a whole grain crude tahini comprising fiber-like particles as defined above, wherein said fiber-like particle population has straightness s50 value of from 0.620 to 0.776, e.g., from 0.630 to 0.760, from 0.640 to 0.750, from 0.650 to 0.740, from 0.660 to 0.730, from 0.670 to 0.720, from 0.680 to 0.710; or from 0.690 to 0.700; or lower than 0.620, e.g., ≤0.615, ≤0.610, ≤0.605, ≤0.600, ≤0.595, ≤0.590, ≤0.585, ≤0.580, ≤0.575, ≤0.570, ≤0.565, ≤0.560, ≤0.555, or ≤0.550. In particular embodiments, said fiber-like particle population has straightness s10 value lower than 0.559, and/or a straightness s90 value lower than 0.904. In certain particular such embodiments, said fiber-like particle population has LEFI ×50 value lower than 62.40 μm, e.g., from 20.00 μm to 62.00 μm, from 22.00 μm to 60.00 μm, from 24.00 μm to 58.00 μm, from 26.00 μm to 56.00 μm, from 28.00 μm to 54.00 μm, from 30.00 μm to 52.00 μm, from 32.00 μm to 50.00 μm, from 34.00 μm to 48.00 μm, from 36.00 μm to 46.00 μm, from 38.00 μm to 44.00 μm, or from 40.00 μm to 42.00 μm; and/or elongation s50 value lower than 0.080, e.g., ≤0.079, ≤0.078, ≤0.077, ≤0.076, ≤0.075, ≤0.074, ≤0.073, ≤0.072, ≤0.071, ≤0.070, ≤0.069, ≤0.068, ≤0.067, or ≤0.066, such as from 0.071 to 0.079; and/or DIFI s50 value lower than 4.46 μm, e.g., ≤4.44, ≤4.42, ≤4.40, ≤4.38, ≤4.36, ≤4.34, ≤4.32, ≤4.30 μm, ≤4.28, ≤4.26, ≤4.24, ≤4.22, ≤4.20, ≤4.18, ≤4.16, ≤4.14, ≤4.12, ≤4.10, ≤4.08, ≤4.06, ≤4.04, ≤4.02, ≤4.00, or ≤3.98 μm, and optionally DIFI s10 value lower than 2.55 μm and/or DIFI s90 value lower than 8.74 μm.

In certain embodiments, disclosed herein is a whole grain crude tahini comprising fiber-like particles according to any one of the embodiments above, wherein said whole grain crude tahini has been prepared by a process comprising microfluidization of a paste made of (a) unhulled sesame seeds, i.e., sesame seeds in their natural state with their shells intact; (b) hulled sesame seeds, i.e., sesame seeds after removal of their shells (husks), in combination with sesame hulls; or (c) a combination of unhulled sesame seeds, hulled sesame seeds, and optionally sesame hulls, at a pressure of at least 5,000 PSI, e.g., at least 10,000 PSI, at least 15,000 PSI, at least 20,000 PSI, at least 25,000 PSI, at least 30,000 PSI, at least 35,000 PSI, or at least 40,000 PSI. In particular such embodiments, said paste has been prepared by grinding (a) unhulled sesame seeds, or (b) hulled sesame seeds in combination with sesame hulls, or (c) a combination of unhulled sesame seeds, hulled sesame seeds, and optionally sesame hull s. Such grinding may be carried out using any suitable technology, e.g., using a ball mill, millstones, Macintyre grinder, Reifiner Conche, homogenizer (including rotor-stator homogenizer), ultrasound, a homogenization technology capable of reaching shear force of at least 1,000,000 l/sec, or a combination thereof.

In certain embodiments, disclosed herein is a whole grain crude tahini comprising fiber-like particles according to any one of the embodiments above, prepared by a process comprising microfluidization of a paste made of (a) unhulled sesame seeds, (b) hulled sesame seeds in combination with sesame hulls, or (c) a combination of unhulled sesame seeds, hulled sesame seeds, and optionally sesame hulls, at a pressure of at least 5,000 PSI, wherein under the same measurement conditions, said crude tahini exhibits straightness s50 value that is lower than that of a reference whole grain crude tahini (also referred to hereinbelow as “reference crude tahini”), wherein said whole grain crude tahini and said reference whole grain crude tahini have both been prepared from the same paste referred to hereinabove, and the reference whole grain crude tahini differs from said whole grain crude tahini only in not having been subjected to microfluidization. In particular such embodiments, the crude tahini disclosed exhibits straightness s50 value that is at least 0.001, at least 0.002, or at least 0.003, lower than that of said reference crude tahini. Such a crude tahini may further exhibit LEFI ×50 value and/or elongation s50 value and/or DIFI s50 value, each being lower than that of said reference crude tahini, e.g., LEFI ×50 value that is at least 0.01 μm, at least 0.02 μm, at least 0.03 μm, or at least 0.04 μm, lower than that of said reference crude tahini; and/or elongation s50 value that is at least 0.001, at least 0.002, at least 0.003, or at least 0.004, lower than that of said reference crude tahini; and/or the DIFI s50 value that is at least 0.01 μm, at least 0.02 μm, at least 0.03 μm, or at least 0.04 μm, lower than that of said reference crude tahini.

In certain embodiments, disclosed herein is a whole grain crude tahini comprising fiber-like particles according to any one of the embodiments above, prepared by a process comprising microfluidization of a paste made of (a) unhulled sesame seeds, (b) hulled sesame seeds in combination with sesame hulls, or (c) a combination of unhulled sesame seeds, hulled sesame seeds, and optionally sesame hulls, at a pressure of at least 5,000 PSI, wherein said crude tahini has a viscosity lower than that of said reference crude tahini. The viscosity of the crude tahini disclosed may be measured using any suitable technology, e.g., at room temperature using a rotational viscometer having a small sample adapter with a spindle having coaxial cylinder geometry, or a rheometer, as exemplified herein.

In certain embodiments, disclosed herein is a whole grain crude tahini comprising fiber-like particles according to any one of the embodiments above, wherein said crude tahini is free of stable sediment upon storage of at least 3, 6, 9, or 12 months, or 2, 3, 4, or 5 years, and wherein any sediment formed during said storage is readily redispersible, i.e., may be easily removed, upon gentle shaking or mixing (blending).

### An Oily Seed Product

In yet another aspect, disclosed herein is an oily seed product comprising fiber-like particles, wherein said product has been prepared by a process comprising microfluidization of an oily seed paste at a pressure of at least 5,000 PSI, e.g., at least 10,000 PSI, at least 15,000 PSI, at least 20,000 PSI, at least 25,000 PSI, at least 30,000 PSI, at least 35,000 PSI, or at least 40,000 PSI, wherein when measured by dynamic image analysis using a QICPIC instrument with a USER filter based on LEFI in combination with elongation and straightness for selecting fiber-like particles for evaluation, in a wet dispersion in Isopar G, using a volume-based size distribution and a cylindrical-volume model for the particles, said product is characterized by a fiber-like particle population having straightness s50 value lower than that of a reference oily seed product (also referred to hereinbelow as “reference product”) measured under the same measurement conditions, wherein said product and said reference oily seed product have both been prepared from the same starting oily seeds (i.e., the same oily seed paste), and the reference oily seed product differs from said product only in not having been subjected to microfluidization.

In certain embodiments, disclosed herein is an oily seed product comprising fiber-like particles as defined above, wherein said fiber-like particle population has straightness s50 value that is at least 0.001, 0.002, 0.003, or 0.004 lower than that of said reference product.

In certain embodiments, disclosed herein is an oily seed product comprising fiber-like particles as defined above, wherein said fiber-like particle population has LEFI ×50 value and/or elongation s50 value and/or DIFI s50 value, each being lower than that of said reference product. In particular such embodiments, said fiber-like particle population has LEFI ×50 value that is at least 0.01 μm, at least 0.02 μm, at least 0.03 μm, or at least 0.04 μm, lower than that of said reference product; and/or elongation s50 value that is at least 0.001, at least 0.002, at least 0.003, or at least 0.004, lower than that of said reference product; and/or DIFI s50 value that is at least 0.01 μm, at least 0.02 μm, at least 0.03 μm, or at least 0.04 μm, lower than that of said reference product.

In certain embodiments, disclosed herein is an oily seed product comprising fiber-like particles according to any one of the embodiments above, wherein said oily seed product has a viscosity lower than that of said reference oily seed product. The viscosity of the oily seed product disclosed may be measured using any suitable technology, e.g., at room temperature using a rotational viscometer having a small sample adapter with a spindle having coaxial cylinder geometry, or a rheometer, as exemplified herein.

In certain embodiments, disclosed herein is an oily seed product comprising fiber-like particles as defined above, wherein said oily seed paste has been prepared by grinding said oily seeds. Such grinding may be carried out using any suitable technology, e.g., using a ball mill, millstones, Macintyre grinder, Reifiner Conche, homogenizer (including rotor-stator homogenizer), ultrasound, a homogenization technology capable of reaching shear force of at least 1,000,000 l/sec, or a combination thereof.

In certain embodiments, disclosed herein is an oily seed product comprising fiber-like particles according to any one of the embodiments above, wherein said oily seeds are selected from white sesame, red sesame, black sesame, nigella, peanuts, pistachios, almonds, nuts, Brazil nuts, macadamia nuts, hazelnuts, pecans, cashews, olives, sunflower seeds, corn kernels, wheat kernels, soybeans, rapeseeds, cottonseeds, flaxseeds, safflower seeds, mustard seeds, hemp seeds, poppy seeds, castor seeds, pumpkin seeds, Niger seeds, palm kernel, coconuts, perilla seeds, camelina seeds, chia seeds, black cumin seeds, sacha inchi seeds (Inca peanuts), moringa seeds (such as Moringa oleifera seeds), karanja seeds (Pongamia pinnata seeds), watermelon seeds, coriander seeds, pomegranate seeds, grape seeds, prickly pear seeds (Opuntia species), baobab seeds (Adansonia species), tomato seeds, and red raspberry seeds.

In certain particular embodiments, said oily seeds are sesame seeds such as white sesame, red sesame, black sesame, wherein said seeds are hulled and said oily seed product is thus a crude tahini. In more particular such embodiments, said crude tahini is characterized by a fiber-like particle population having straightness s50 value lower than 0.748; and/or LEFI ×50 value lower than 43.57 μm; and/or elongation s50 value lower than 0.084; and/or DIFI s50 value lower than 3.35 μm.

In other particular embodiments, said oily seeds are sesame seeds as referred to hereinabove, wherein said seeds are (a) unhulled sesame seeds; (b) hulled sesame seeds in combination with sesame hulls; or (c) hulled sesame seeds in combination with unhulled sesame seeds and optionally sesame hulls, and said oily seed product is thus a whole grain crude tahini. In more particular such embodiments, said whole grain crude tahini is characterized by a fiber-like particle population having straightness s50 value lower than 0.777, e.g., ≤0.775, ≤0.770, ≤0.765, ≤0.760, ≤0.755, ≤0.750, ≤0.745, ≤0.740, ≤0.735, ≤0.730, ≤0.725, ≤0.720, ≤0.715, ≤0.710, ≤0.705, ≤0.700, ≤0.695, ≤0.690, ≤0.685, ≤0.680, ≤0.675, ≤0.670, ≤0.665, ≤0.660, ≤0.655, ≤0.650, ≤0.645, ≤0.640, ≤0.635, ≤0.630, ≤0.625, ≤0.620, ≤0.615, ≤0.610, ≤0.605, ≤0.600, ≤0.595, ≤0.590, ≤0.585, or ≤0.580; and/or LEFI ×50 value lower than 62.40 μm, e.g., from 20.00 μm to 62.00 μm, from 22.00 μm to 60.00 μm, from 24.00 μm to 58.00 μm, from 26.00 μm to 56.00 μm, from 28.00 μm to 54.00 μm, from 30.00 μm to 52.00 μm, from 32.00 μm to 50.00 μm, from 34.00 μm to 48.00 μm, from 36.00 μm to 46.00 μm, from 38.00 μm to 44.00 μm, or from 40.00 μm to 42.00 μm; and/or elongation s50 value lower than 0.080, e.g., ≤0.079, ≤0.078, ≤0.077, ≤0.076, ≤0.075, ≤0.074, ≤0.073, ≤0.072, ≤0.071, ≤0.070, ≤0.069, ≤0.068, ≤0.067, or ≤0.066; and/or DIFI s50 value lower than 4.46 μm, e.g., ≤4.44, ≤4.42, ≤4.40, ≤4.38, ≤4.36, ≤4.34, ≤4.32, ≤4.30 μm, ≤4.28, ≤4.26, ≤4.24, ≤4.22, ≤4.20, ≤4.18, ≤4.16, ≤4.14, ≤4.12, ≤4.10, ≤4.08, ≤4.06, ≤4.04, ≤4.02, ≤4.00, or ≤3.98 μm.

In further particular embodiments, said oily seeds are olives, and said product is a processed olive product.

In certain embodiments, disclosed herein is an oily seed product comprising fiber-like particles as defined above, wherein said oily seed product is a crude tahini or a whole grain crude tahini, and said oily seed product is free of stable sediment upon storage of at least 3, 6, 9, or 12 months, or 2, 3, 4, or 5 years, and wherein any sediment formed during said storage is readily redispersible, i.e., may be easily removed, upon gentle shaking or mixing (blending).

### a Composition of Whole Grain Crude Tahini

The present invention further provides a composition comprising (a) a whole grain crude tahini comprising fiber-like particles; or (b) an oily seed product comprising fiber-like particles, each according to any one of the embodiments above, formulated for oral administration.

In a further aspect thus disclosed herein is a composition comprising a whole grain crude tahini comprising fiber-like particles according to any one of the embodiments above, and probiotic bacteria, formulated for oral administration.

The term “probiotic bacteria” as used herein refers to live bacteria, e.g., Lactobacillus and Bifidobacterium, which when administered to a subject in adequate amounts confer a health benefit on the subject, generally by improving or restoring the gut flora.

In certain embodiments, disclosed herein is a composition comprising a whole grain crude tahini comprising fiber-like particles as defined above, wherein said probiotic bacteria comprised within the composition disclosed herein is a Lactobacillus species such as Lactobacillus acidophilus, Lactobacillus casei, and Lactobacillus plantarum; a Bifidobacterium species such as Bifidobacterium pseudocatenulatum, e.g., Bifidobacterium pseudocatenulatum B7003, Bifidobacterium animalis, e.g., Bifidobacterium animalis ssp. lactis LAFTI(a)B94, Bifidobacterium bifidum, Bifidobacterium longum, Bifidobacterium infantis, and Bifidobacterium breve; Enterococcus species, Streptococcus species, Pediococcus species, Leuconostoc species, Bacillus species, Escherichia species, or a combination thereof. In a particular embodiment as exemplified herein, the probiotic bacteria comprised within the composition disclosed herein is Lactobacillus plantarum, e.g., Lactobacillus plantarum R1012-150 (Institut Rosell, Canada), formulated as lyophilized powder originally containing 1.5×10¹¹ bacteria.

In certain embodiments, disclosed herein is a composition comprising a whole grain crude tahini comprising fiber-like particles according to any one of the embodiments above, wherein said composition further comprises at least one polyphenol originating from a plant source other than sesame seeds. As used herein, the term “plant source” refers to any material, specimen, or derivative obtained from a member of the plant kingdom. The polyphenol originating from a plant source may be provided in any suitable form, including but not limited to, whole plant matter, chopped or ground plant material, juices, concentrates, distillates, or purified or semi-purified plant extracts.

In certain embodiments, said at least one polyphenol originating from a plant source other than sesame seeds is a compound isolated and purified from a polyphenol-containing plant extract, or a synthetic compound. Examples of such polyphenols include, without being limited to, catechin, catechin gallate, gallocatechin gallate, epicatechin, epigallocatechin, epicatechin gallate, epigallocatechin gallate (EGCG, most abundant catechin in tea), quercetin, caffeine, and resveratrol. In other embodiments, said at least one polyphenol comprises an extract from at least one of seeds, beans, whole grains, nuts, fruits, and leaves of a polyphenol-containing plant. Examples of such extracts include, without being limited to, those from grapes, e.g., Californian grape varieties including Ruby red grape variety, tea, pomegranates, dates, berries, olives, coffee beans, e.g., Coffea arabica beans and Coffea canephora beans, and cocoa beans.

The term “extract” as used hereinabove refers to a polyphenol-containing extract obtained from a polyphenol-containing plant, by extracting at least one of seeds, beans, whole grains, nuts, fruits, and leaves of said plant with a suitable (preferably edible) solvent capable of extracting polyphenols from said plant. The extraction process may be carried out following any procedure known in the art, optionally under pressure higher than the ambient pressure, and at a temperature lower than the boiling temperature of said solvent, such that the polyphenols extracted are not damaged. Examples of suitable solvents for carrying out such an extraction process include, without limiting, inorganic solvents such as fresh water, tap water, saline, and salt water; organic solvents such as methanol, ethanol, propanol, isopropanol, butanol, and t-butyl alcohol; and combinations thereof. In particular embodiments, the solvent used for extracting the polyphenols from said polyphenol-containing plant is ethanol or a combination of ethanol and water.

In particular embodiments, said at least one polyphenol originating from a plant source other than said sesame seeds comprises a GTE, GSE, or a combination thereof. In more particular such embodiments, said at least one polyphenol comprises EGCG.

Sesame seeds and oil are rich in polyphenols including the lignans sesamin and sesamolin (also known as sesaminol), and sesamol. In certain embodiments thus disclosed herein is a composition comprising a whole grain crude tahini comprising fiber-like particles according to any one of the embodiments above, wherein said crude tahini comprises sesamin in an amount of from about 200 to about 11000 microgram/gram (mcg/g), e.g., from about 600 to about 10900 mcg/g, from about 1000 to about 10800 mcg/g, from about 1400 to about 10700 mcg/g, from about 1800 to about 10600 mcg/g, from about 2200 to about 10500 mcg/g, from about 2400 to about 10000 mcg/g, from about 2600 to about 9500 mcg/g, from about 2800 to about 9000 mcg/g, from about 3000 to about 8500 mcg/g, from about 3200 to about 8000 mcg/g, from about 3400 to about 7500 mcg/g, from about 3600 to about 7000 mcg/g, from about 3800 to about 6500 mcg/g, from about 4000 to about 6000 mcg/g, from about 4200 to about 5500 mcg/g, or from about 4400 to about 5000 mcg/g; sesamolin in an amount of from about 100 to about 8500 mcg/g, e.g., from about 200 to about 8400 mcg/g, from about 300 to about 8300 mcg/g, from about 400 to about 8200 mcg/g, from about 500 to about 8100 mcg/g, from about 600 to about 8000 mcg/g, from about 700 to about 7500 mcg/g, from about 800 to about 7000 mcg/g, from about 900 to about 6500 mcg/g, from about 1000 to about 6000 mcg/g, from about 1100 to about 5500 mcg/g, from about 1200 to about 5000 mcg/g, from about 1300 to about 4500 mcg/g, from about 1400 to about 4000 mcg/g, from about 1500 to about 3500 mcg/g, from about 1600 to about 3000 mcg/g, from about 1800 to about 2500 mcg/g, or from about 1900 to about 2000 mcg/g; and sesamol in an amount of from about 10 to about 5000 mcg/g, e.g., from about 50 to about 4500 mcg/g, from about 100 to about 4000 mcg/g, from about 150 to about 3500 mcg/g, from about 200 to about 3000 mcg/g, from about 250 to about 2500 mcg/g, from about 300 to about 2000 mcg/g, from about 400 to about 1500 mcg/g, or from about 500 to about 1000 mcg/g. In particular such embodiments, said crude tahini comprises sesamin in an amount of from about 3000 to about 4000 mcg/g, e.g., about 3330 mcg/g as exemplified herein; sesamolin in an amount of from about 1000 to about 2000 mcg/g, e.g., about 1320 mcg/g as exemplified herein; and sesamol.

In certain embodiments, disclosed herein is a composition comprising a whole grain crude tahini comprising fiber-like particles as defined above, wherein said crude tahini comprises sesamin in an amount of from about 200 to about 11000 mcg/g; sesamolin in an amount of from about 100 to about 8500 mcg/g; and sesamol in an amount of from about 10 to about 5000 mcg/g; and wherein said probiotic bacteria are selected from a Lactobacillus species (such as Lactobacillus acidophilus, Lactobacillus casei, and Lactobacillus plantarum), Bifidobacterium species (such as Bifidobacterium pseudocatenulatum, Bifidobacterium animalis, Bifidobacterium bifidum, Bifidobacterium longum, Bifidobacterium infantis, and Bifidobacterium breve), Enterococcus species, Streptococcus species, Pediococcus species, Leuconostoc species, Bacillus species, Escherichia species, and a combination thereof. In particular such embodiments, said composition further comprises at least one polyphenol originating from a plant source other than sesame seeds. In certain more particular such embodiments, said at least one polyphenol comprises an extract from at least one item selected from seeds, beans, whole grains, nuts, fruits, and leaves, of a plant, e.g., an extract from grapes, tea, pomegranates, dates, berries, olives, coffee beans, and/or cocoa beans. In other more particular such embodiments, said at least one polyphenol comprises GSE, GTE, or a combination thereof. In more specific such embodiments, said GTE is an aqueous ethanol extract obtained from Camellia sinensis leaves; and/or said GSE is an aqueous extract obtained from Californian grape varieties including Ruby red grape variety; and/or said at least one polyphenol comprises epigallocatechin gallate (EGCG).

### Composition of an Oily Seed Product

In yet a further aspect, disclosed herein is a composition comprising an oily seed product comprising fiber-like particles according to any one of the embodiments above, and probiotic bacteria as defined hereinabove, formulated for oral administration.

In certain embodiments, disclosed herein is a composition comprising an oily seed product comprising fiber-like particles according to any one of the embodiments above, wherein said composition further comprises at least one polyphenol originating from a plant source other than said oily seeds, as defined hereinabove.

The compositions disclosed herein, regardless of whether comprising a whole grain crude tahini comprising fiber-like particles or an oily seed product comprising fiber-like particles, are formulated for oral administration. Such compositions may be in the form of a liquid, e.g., a solution in an edible solvent such as ethanol, tincture, syrup, or elixir; a semi-solid; or a solid such as hard or soft capsules, tablets, caplets, pills, troches, lozenges, dispersible powder or granules, and sachets.

In certain embodiments, the composition disclosed is in the form of matrix tablets, wherein the release of the components, i.e., at least one of said whole grain crude tahini or oily seed product, said probiotic bacteria, and said polyphenol(s) when present, is controlled by having said components diffuse through a gel formed after the swelling of a hydrophilic polymer brought into contact with dissolving liquid (in vitro) or gastro-intestinal fluid (in vivo). Many polymers have been described as capable of forming such gel, e.g., derivatives of cellulose, in particular the cellulose ethers such as hydroxypropyl cellulose, hydroxymethyl cellulose, methylcellulose or methyl hydroxypropyl cellulose, and among the different commercial grades of these ethers are those showing fairly high viscosity. In other embodiments, the tablets are formulated as bi- or multi-layer tablets, made up of two or more distinct layers of granulation compressed together with the individual layers lying one on top of another, with each separate layer containing one or more of the components, and the layers are optionally separated by an intermediate, i.e., an inactive layer such as a layer comprising one or more disintegrants.

The composition disclosed may be formulated so as to inhibit the release of one or more of the components in the stomach, i.e., delay the release of said components(s) until at least a portion of the dosage form has traversed the stomach, in order to avoid the acidity of the gastric contents from hydrolyzing the component(s). Particular such compositions are those wherein the component(s) is coated by a pH-dependent enteric-coating polymer, also referred to herein as “acid-resistant coating”, or a combination thereof. Examples of suitable pH-dependent enteric-coating polymers include, without being limited to, HPMC, hydroxypropyl methylcellulose phthalate (HPMCP), Eudragit® S (poly(methacrylicacid, methylmethacrylate), 1:2), Eudragit® L 55 (poly (methacrylicacid, ethylacrylate), 1:1), Kollicoat® (poly(methacrylicacid, ethylacrylate), 1:1), alginates, and carboxymethyl cellulose. The pH-dependent enteric-coating polymer may be present in the composition in an amount from about 5 or 10% to about 95% by weight of the entire composition.

In certain embodiments, the composition disclosed, according to any one of the embodiments above, is thus an oral dosage form comprising a pH-dependent enteric-coating polymer, e.g., one of those listed above, capable of protecting said composition from gastric (stomach) acidity. In particular embodiments, said oral dosage is formulated as a capsule, wherein said pH-dependent enteric-coating polymer is HPMC. In a more particular such embodiment, as exemplified herein, the composition of the invention is formulated as capsules, more specifically filled within DRCAPS® capsules, which are commercially available HPMC capsules capable of protecting dietary supplement ingredients from stomach acidity.

In certain embodiments, the composition disclosed, according to any one of the embodiments above, is formulated as a capsule, wherein said capsule is airtight so as to prevent the components from oxidizing, and thus protect the full potential of the combined healing effects of all components. The airtight feature may be attained by employing aluminum seal or aluminum laminate seal for each capsule, or alternatively by employing airtight packaging of multiple capsules, such as using sealed plastic bags.

Compositions for oral administration, regardless of their specific formulation, may further comprise one or more agents selected from sweetening agents, flavoring agents, coloring agents and preserving agents in order to provide elegant and palatable preparations. In addition, said compositions may comprise one or more acceptable excipients. For example, a tablet may comprise at least one filler such as lactose, ethylcellulose, microcrystalline cellulose, and silicified microcrystalline cellulose; at least one disintegrant such as cross-linked polyvinylpyrrolidinone; at least one binder such as polyvinylpyridone, hydroxypropylmethyl cellulose; at least one surfactant such as sodium laurylsulfate; at least one glidant such as colloidal silicon dioxide; and/or at least one anti-caking agent such as magnesium stearate and silicon dioxide.

### a Food Product, Food (Nutrition) Additive or Supplement, or Medical Food

In still a further aspect, disclosed herein is a food product, food (nutrition) additive or supplement, or medical food (i.e., a highly specific, legally defined category of food designed for the dietary management of a specific disease or medical condition), comprising a composition as defined above, i.e., a composition comprising a whole grain crude tahini comprising fiber-like particles or a composition comprising an oily seed product comprising fiber-like particles, probiotic bacteria, and optionally at least one polyphenol originating from a plant source, formulated for oral administration.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include” and “have”, and their conjugates, as used herein mean “including but not necessarily limited to”.

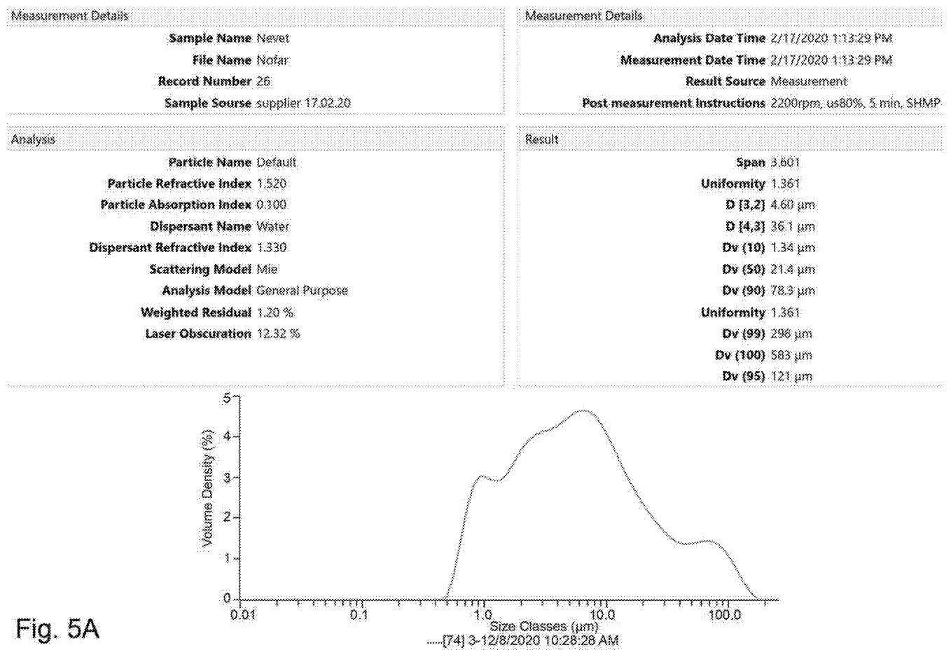

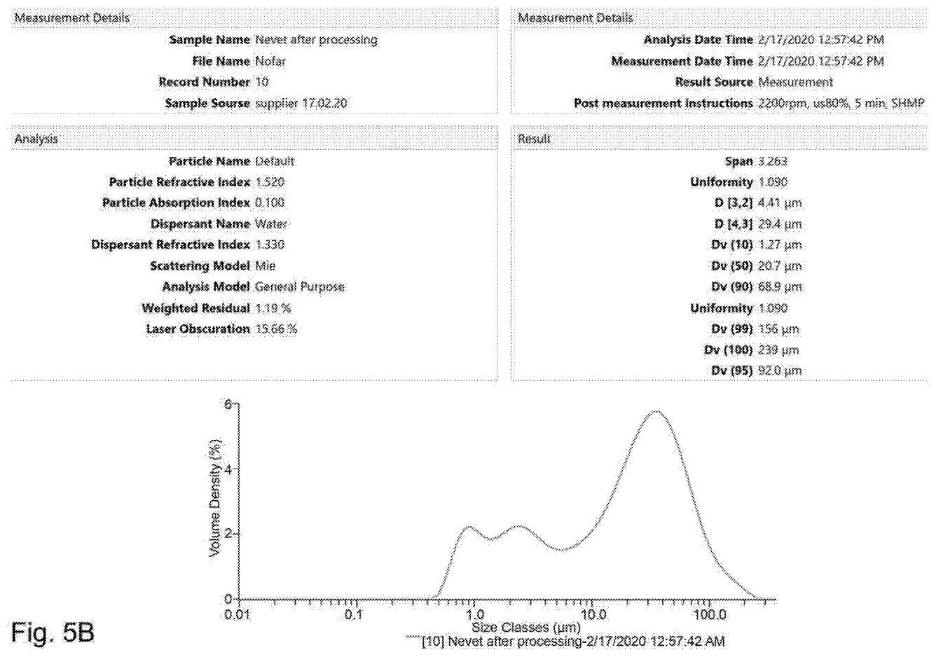

### Source Data for Particle Size Distribution Plots

| Source data for | | Source date for | | Source data for | |
|---|---|---|---|---|---|
| FIG. 1B | | FIG. 1C | | FIG. 2A | |
| Size (μm) | % Volume Under | Size (μm) | % Volume Under | % Volume Under | Size (μm) |
| 0.523 | 0 | 0.523 | 0 | 0 | 0.523 |
| 0.594 | 0.43 | 0.594 | 0.25 | 0.11 | 0.594 |
| 0.675 | 1.53 | 0.675 | 1.15 | 0.6 | 0.675 |
| 0.767 | 3.3 | 0.767 | 2.88 | 1.62 | 0.767 |
| 0.872 | 3.48 | 0.872 | 5.25 | 3.08 | 0.872 |
| 0.991 | 7.75 | 0.991 | 7.87 | 4.75 | 0.991 |
| 1.13 | 9.84 | 1.13 | 10.37 | 6.4 | 1.13 |
| 1.28 | 11.7 | 1.28 | 12.62 | 7.94 | 1.28 |
| 1.45 | 13.43 | 1.45 | 14.59 | 9.4 | 1.45 |
| 1.65 | 15.24 | 1.65 | 16.85 | 10.92 | 1.65 |
| 1.88 | 17.3 | 1.88 | 19.33 | 12.62 | 1.88 |
| 2.13 | 19.68 | 2.13 | 22.3 | 14.59 | 2.13 |
| 2.42 | 22.42 | 2.42 | 25.84 | 16.84 | 2.42 |
| 2.75 | 25.45 | 2.75 | 29.89 | 19.39 | 2.75 |
| 3.12 | 28.72 | 3.12 | 34.33 | 22.21 | 3.12 |
| 3.55 | 32.16 | 3.55 | 39.04 | 25.33 | 3.55 |
| 4.03 | 35.74 | 4.03 | 43.9 | 28.73 | 4.03 |
| 4.58 | 39.41 | 4.38 | 48.86 | 32.41 | 4.58 |
| 5.21 | 43.13 | 5.21 | 53.82 | 36.3 | 5.21 |
| 5.92 | 46.82 | 5.92 | 58.72 | 40.29 | 5.92 |
| 6.72 | 50.41 | 6.72 | 63.46 | 44.23 | 6.72 |
| 7.64 | 53.81 | 7.64 | 67.95 | 47.98 | 7.64 |
| 8.68 | 56.94 | 8.68 | 72.09 | 51.38 | 8.68 |
| 9.86 | 59.73 | 9.86 | 75.8 | 54.35 | 9.86 |
| 11.2 | 62.16 | 11.2 | 79.02 | 56.85 | 11.2 |
| 12.7 | 64.26 | 12.7 | 81.76 | 58.93 | 12.7 |
| 14.5 | 66.06 | 14.5 | 84.03 | 60.68 | 14.5 |
| 16.4 | 67.67 | 16.4 | 85.92 | 62.23 | 16.4 |
| 18.7 | 69.15 | 18.7 | 87.52 | 63.71 | 18.7 |
| 21.2 | 70.59 | 21.2 | 88.94 | 65.23 | 21.2 |
| 24.1 | 72.03 | 24.1 | 90.28 | 66.85 | 24.1 |
| 27.4 | 73.48 | 27.4 | 91.64 | 68.59 | 27.4 |
| 31.1 | 74.93 | 31.1 | 93.05 | 70.43 | 31.1 |
| 35.3 | 76.35 | 35.3 | 94.52 | 72.34 | 35.3 |
| 40.1 | 77.72 | 40.1 | 95.98 | 74.25 | 40.1 |
| 45.6 | 79.02 | 45.6 | 97.36 | 76.15 | 45.6 |
| 51.6 | 80.26 | 51.8 | 98.51 | 78.02 | 51.8 |
| 58.9 | 81.51 | 58.9 | 99.35 | 79.88 | 58.9 |
| 66.9 | 82.84 | 66.9 | 99.83 | 81.78 | 66.9 |
| 76 | 84.34 | 76 | 100 | 83.78 | 76 |
| 86.4 | 86.11 | | | 85.93 | 86.4 |
| 98.1 | 88.17 | | | 88.26 | 98.1 |
| 111 | 90.51 | | | 90.73 | 111 |
| 127 | 92.98 | | | 93.21 | 127 |
| 144 | 95.36 | | | 95.53 | 144 |
| 163 | 97.41 | | | 97.48 | 163 |
| 186 | 98.91 | | | 99.91 | 186 |
| 211 | 99.77 | | | 99.75 | 211 |
| 240 | 100 | | | 100 | 240 |

| Source data for | | Source data for | | | |
|---|---|---|---|---|---|
| FIG. 2B | | FIG. 3A | | | |
| % Volume Under | Size (μm) | % Volume Under | Size (μm) | % Volume Under | Size (μm) |
| 0 | 0.523 | 0 | 0.523 | 98.11 | 211 |
| 0.16 | 0.594 | 0.38 | 0.594 | 98.8 | 240 |
| 0.82 | 0.675 | 1.39 | 0.675 | 99.31 | 272 |
| 2.16 | 0.767 | 3.08 | 0.767 | 99.67 | 310 |
| 4.06 | 0.872 | 5.22 | 0.872 | 99.89 | 352 |
| 6.22 | 0.991 | 7.54 | 0.991 | 100 | 400 |
| 8.35 | 1.13 | 9.8 | 1.13 | | |
| 10.33 | 1.28 | 11.99 | 1.28 | | |
| 12.22 | 1.45 | 14.2 | 1.45 | | |
| 14.21 | 1.65 | 16.57 | 1.65 | | |
| 16.47 | 1.88 | 19.2 | 1.88 | | |
| 19.11 | 2.13 | 22.11 | 2.13 | | |
| 22.15 | 2.42 | 25.24 | 2.42 | | |
| 25.58 | 2.75 | 28.49 | 2.75 | | |
| 29.35 | 3.12 | 31.81 | 3.12 | | |
| 33.43 | 3.55 | 35.15 | 3.55 | | |
| 37.76 | 4.03 | 38.53 | 4.03 | | |
| 42.29 | 4.58 | 41.98 | 4.58 | | |
| 46.96 | 5.21 | 45.52 | 5.21 | | |
| 51.62 | 5.92 | 49.15 | 5.92 | | |
| 56.17 | 6.72 | 52.84 | 6.72 | | |
| 60.47 | 7.64 | 56.51 | 7.64 | | |
| 64.42 | 8.68 | 60.09 | 8.68 | | |
| 67.92 | 9.86 | 63.49 | 9.86 | | |
| 70.99 | 11.2 | 66.65 | 11.2 | | |
| 73.65 | 12.7 | 69.52 | 12.7 | | |
| 75.94 | 14.5 | 72.11 | 14.5 | | |
| 77.96 | 16.4 | 74.42 | 16.4 | | |
| 79.78 | 18.7 | 76.5 | 18.7 | | |
| 81.47 | 21.2 | 78.39 | 21.2 | | |
| 83.1 | 24.1 | 80.11 | 24.1 | | |
| 84.72 | 27.4 | 81.68 | 27.4 | | |
| 86.39 | 31.1 | 83.11 | 31.1 | | |
| 88.17 | 35.3 | 84.4 | 35.3 | | |
| 90.09 | 40.1 | 85.56 | 40.1 | | |
| 92.13 | 45.6 | 86.61 | 45.6 | | |
| 94.21 | 51.8 | 87.56 | 51.8 | | |
| 96.19 | 58.9 | 88.45 | 58.9 | | |
| 97.88 | 66.9 | 89.3 | 66.9 | | |
| 99.12 | 76 | 90.16 | 76 | | |
| 99.82 | 86.4 | 91.06 | 86.4 | | |
| 100 | 98.1 | 92.03 | 98.1 | | |
| | | 93.06 | 111 | | |
| | | 94.15 | 127 | | |
| | | 95.24 | 144 | | |
| | | 96.3 | 163 | | |
| | | 97.27 | 186 | | |
| Source data for | | Source data for | | | |
| FIG. 3B | | FIG. 4A | | | |
| % Volume Under | Size (μm) | % Volume Under | Size (μm) | % Volume Under | Size (μm) |
| 0 | 0.523 | 0 | 0.523 | 84.94 | 211 |
| 0.47 | 0.594 | 0.26 | 0.594 | 86.52 | 240 |
| 1.73 | 0.675 | 1 | 0.675 | 88.13 | 272 |
| 3.81 | 0.767 | 2.27 | 0.767 | 89.77 | 310 |
| 6.45 | 0.872 | 3.93 | 0.872 | 91.41 | 352 |
| 9.31 | 0.991 | 5.77 | 0.991 | 93.02 | 400 |
| 12.13 | 1.13 | 7.61 | 1.13 | 94.55 | 454 |
| 14.87 | 1.28 | 9.4 | 1.28 | 95.98 | 516 |
| 17.66 | 1.45 | 11.22 | 1.45 | 97.24 | 586 |
| 20.66 | 1.65 | 13.15 | 1.65 | 98.29 | 666 |
| 24.01 | 1.88 | 15.27 | 1.88 | 99.08 | 756 |
| 27.72 | 2.13 | 17.57 | 2.13 | 99.62 | 859 |
| 31.71 | 2.42 | 20.01 | 2.42 | 99.93 | 976 |
| 35.84 | 2.75 | 22.53 | 2.75 | 100 | 1110 |
| 40 | 3.12 | 25.1 | 3.12 | | |
| 44.11 | 3.55 | 27.71 | 3.55 | | |
| 48.16 | 4.03 | 30.38 | 4.03 | | |
| 52.15 | 4.58 | 33.15 | 4.58 | | |
| 56.12 | 5.21 | 36.03 | 5.21 | | |
| 60.07 | 5.92 | 39.01 | 5.92 | | |
| 63.97 | 6.72 | 42.05 | 6.72 | | |
| 67.77 | 7.64 | 45.08 | 7.64 | | |
| 71.41 | 8.68 | 48.02 | 8.58 | | |
| 74.79 | 9.86 | 50.79 | 9.86 | | |
| 77.86 | 11.2 | 53.32 | 11.2 | | |
| 80.58 | 12.7 | 55.59 | 12.7 | | |
| 82.95 | 14.5 | 57.59 | 14.5 | | |
| 85 | 16.4 | 59.35 | 16.4 | | |
| 86.78 | 18.7 | 60.92 | 18.7 | | |
| 88.35 | 21.2 | 62.34 | 21.2 | | |
| 89.76 | 24.1 | 63.65 | 24.1 | | |
| 91.04 | 27.4 | 64.9 | 27.4 | | |
| 92.25 | 31.1 | 66.1 | 31.1 | | |
| 93.4 | 35.3 | 67.28 | 35.3 | | |
| 94.5 | 40.1 | 68.46 | 40.1 | | |
| 95.55 | 45.6 | 69.63 | 45.6 | | |
| 96.55 | 51.8 | 70.8 | 51.8 | | |
| 97.45 | 58.9 | 71.98 | 58.9 | | |
| 98.24 | 66.9 | 73.16 | 66.9 | | |
| 98.88 | 76 | 74.35 | 76 | | |
| 99.36 | 86.4 | 75.54 | 86.4 | | |
| 99.7 | 98.1 | 76.76 | 98.1 | | |
| 99.9 | 111 | 78 | 111 | | |
| 100 | 127 | 79.28 | 127 | | |
| | | 80.6 | 144 | | |
| | | 81.98 | 163 | | |
| | | 83.43 | 186 | | |
| Source data for | | Source data for | | | |
| FIG. 4B | | FIG. 5A | | | |
| % Volume Under | Size (μm) | % Volume Under | Size (μm) | % Volume Under | Size (μm) |
| 0 | 0.523 | 0 | 0.523 | 97.9 | 211 |
| 0.44 | 0.594 | 0.39 | 0.594 | 98.36 | 240 |
| 1.57 | 0.675 | 1.3 | 0.675 | 98.76 | 272 |
| 3.43 | 0.797 | 2.72 | 0.767 | 99.1 | 310 |
| 5.79 | 0.872 | 4.46 | 0.872 | 99.37 | 352 |
| 8.34 | 0.991 | 6.25 | 0.991 | 99.6 | 400 |
| 10.84 | 1.13 | 7.92 | 1.13 | 99.78 | 454 |
| 13.26 | 1.28 | 9.43 | 1.28 | 99.91 | 516 |
| 15.68 | 1.45 | 10.88 | 1.45 | 100 | 586 |
| 18.25 | 1.65 | 12.39 | 1.65 | | |
| 21.06 | 1.88 | 14.03 | 1.88 | | |
| 24.13 | 2.13 | 15.82 | 2.13 | | |
| 27.39 | 2.42 | 17.71 | 2.42 | | |
| 30.76 | 2.75 | 19.61 | 2.75 | | |
| 34.18 | 3.12 | 21.42 | 3.12 | | |
| 37.64 | 3.55 | 23.1 | 3.55 | | |
| 41.16 | 4.03 | 24.62 | 4.03 | | |
| 44.77 | 4.58 | 26.03 | 4.58 | | |
| 48.5 | 5.21 | 27.35 | 5.21 | | |
| 52.33 | 5.92 | 28.64 | 5.92 | | |
| 56.22 | 6.72 | 29.95 | 6.72 | | |
| 60.09 | 7.64 | 31.32 | 7.64 | | |
| 63.84 | 8.68 | 32.79 | 8.68 | | |
| 67.4 | 9.86 | 34.41 | 9.86 | | |
| 70.69 | 11.2 | 36.21 | 11.2 | | |
| 73.69 | 12.7 | 38.25 | 12.7 | | |
| 76.38 | 14.5 | 40.58 | 14.5 | | |
| 78.81 | 16.4 | 43.26 | 16.4 | | |
| 80.98 | 18.7 | 46.32 | 18.7 | | |
| 82.94 | 21.2 | 49.78 | 21.2 | | |
| 84.7 | 24.1 | 53.63 | 24.1 | | |
| 86.27 | 27.4 | 57.82 | 27.4 | | |
| 87.67 | 31.1 | 62.26 | 31.1 | | |
| 88.94 | 35.3 | 66.85 | 35.3 | | |
| 90.12 | 40.1 | 71.44 | 40.1 | | |
| 91.25 | 45.6 | 75.88 | 45.6 | | |
| 92.39 | 51.8 | 80.01 | 51.8 | | |
| 93.56 | 58.9 | 83.72 | 58.9 | | |
| 94.76 | 66.9 | 86.9 | 66.9 | | |
| 95.96 | 76 | 89.52 | 76 | | |
| 97.11 | 86.4 | 91.59 | 86.4 | | |
| 98.13 | 98.1 | 93.19 | 98.1 | | |
| 98.96 | 111 | 94.41 | 111 | | |
| 99.54 | 127 | 95.37 | 127 | | |
| 99.87 | 144 | 96.14 | 144 | | |
| 100 | 163 | 96.8 | 163 | | |
| | | 97.38 | 186 | | |

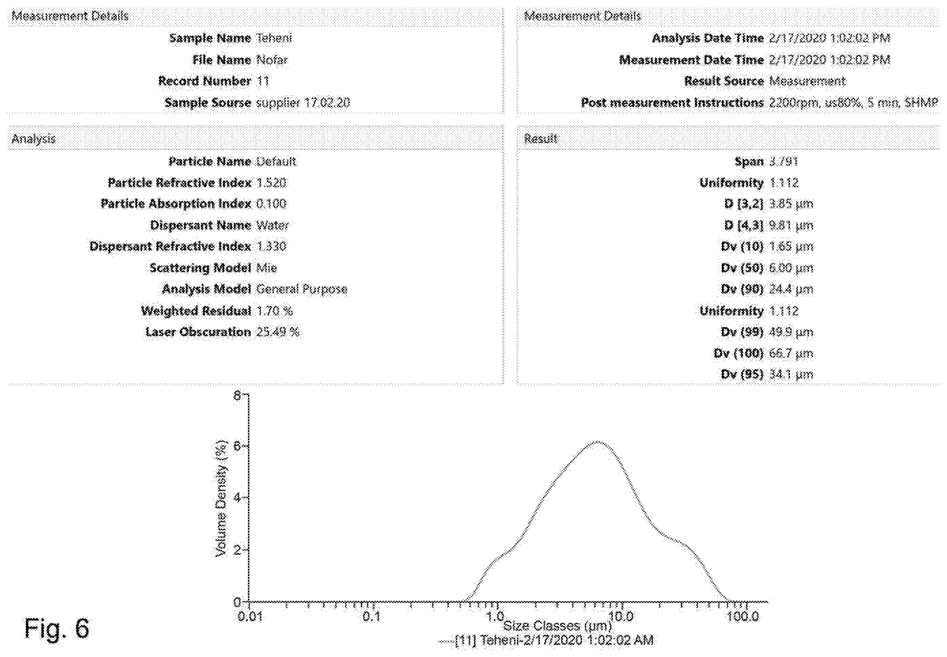

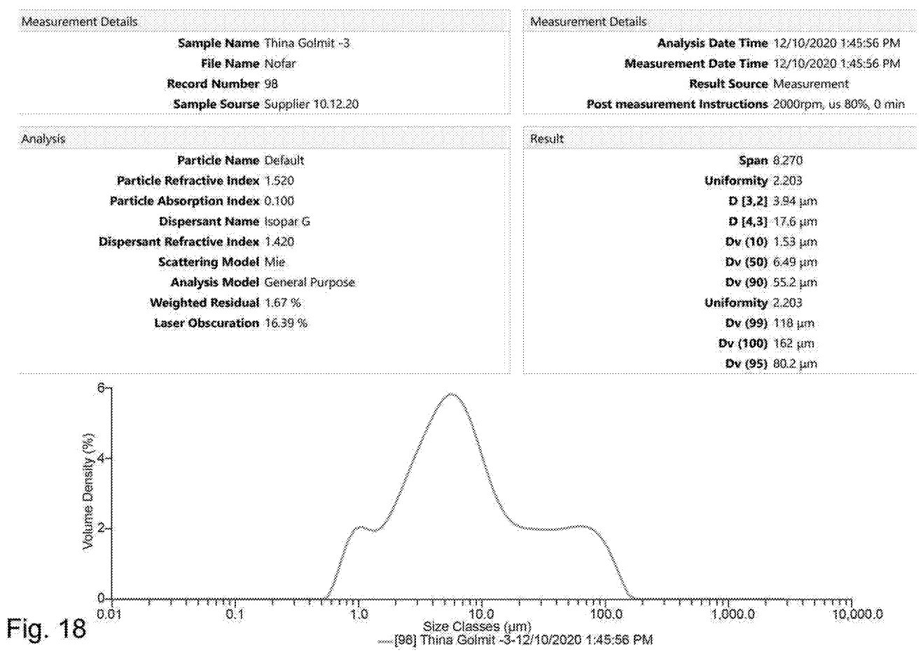

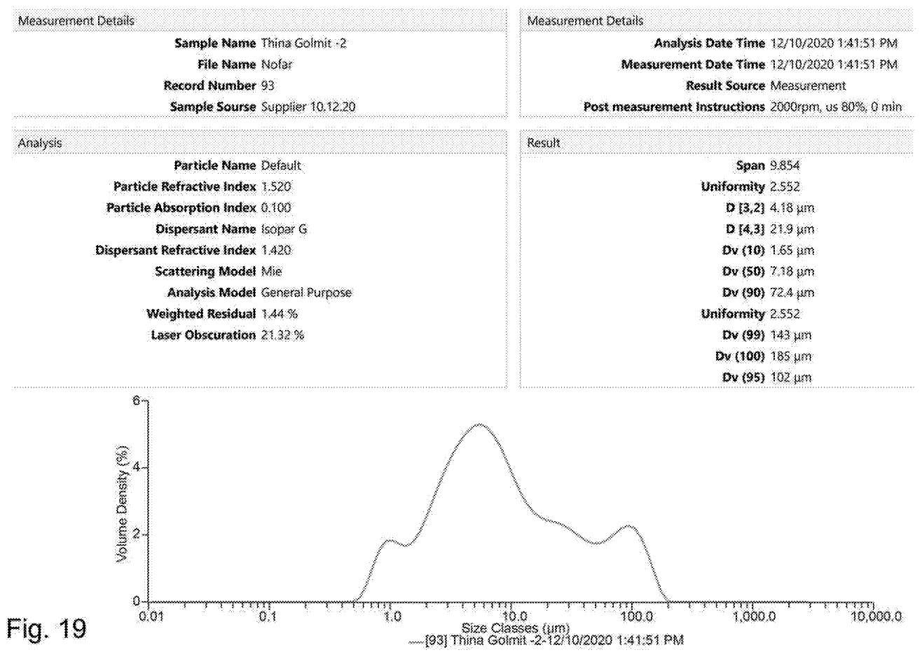

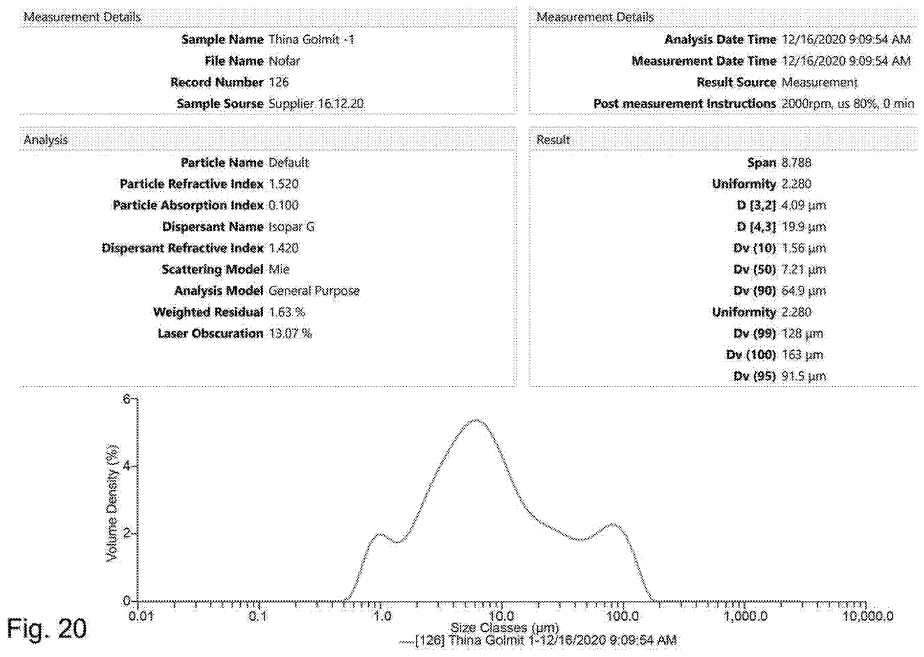

Source data for
FIG. 5B

| % Volume Under | Size (μm) | % Volume Under | Size (μm) |
|---|---|---|---|
| 0 | 0.46 | 99.59 | 186 |
| 0.08 | 0.523 | 99.86 | 211 |
| 0.52 | 0.594 | 100 | 240 |
| 1.51 | 0.675 | | |
| 3.02 | 0.767 | | |
| 4.84 | 0.872 | | |
| 6.71 | 0.991 | | |
| 8.46 | 1.13 | | |
| 10.05 | 1.28 | | |
| 11.56 | 1.45 | | |
| 13.11 | 1.65 | | |
| 14.79 | 1.88 | | |
| 16.59 | 2.13 | | |
| 18.47 | 2.42 | | |
| 20.34 | 2.75 | | |
| 22.11 | 3.12 | | |
| 23.73 | 3.55 | | |
| 25.2 | 4.03 | | |
| 26.56 | 4.58 | | |
| 27.84 | 5.21 | | |
| 29.09 | 5.92 | | |
| 30.38 | 6.72 | | |
| 31.74 | 7.64 | | |
| 33.21 | 8.68 | | |
| 34.84 | 9.86 | | |
| 36.66 | 11.2 | | |
| 38.74 | 12.7 | | |
| 41.13 | 14.5 | | |
| 43.89 | 16.4 | | |
| 47.05 | 18.7 | | |
| 50.65 | 21.2 | | |
| 54.67 | 24.1 | | |
| 59.05 | 27.4 | | |
| 63.7 | 31.1 | | |
| 68.51 | 35.3 | | |
| 73.31 | 40.1 | | |
| 77.94 | 45.6 | | |
| 82.25 | 51.8 | | |
| 86.1 | 58.9 | | |
| 89.39 | 66.9 | | |
| 92.08 | 76 | | |
| 94.2 | 86.4 | | |
| 95.81 | 98.1 | | |
| 97.03 | 111 | | |
| 97.95 | 127 | | |
| 98.65 | 144 | | |
| 99.19 | 163 | | |

| Source data for | | Source data for | | Source data for | |
|---|---|---|---|---|---|
| FIG. 6 | | FIG. 11A | | FIG. 11B | |
| % Volume Under | Size (μm) | % Volume Under | Size (μm) | % Volume Under | Size (μm) |
| 0 | 0.594 | 0 | 0.594 | 0 | 0.523 |
| 0.22 | 0.675 | 0.32 | 0.675 | 0.18 | 0.594 |
| 0.84 | 0.757 | 1.07 | 0.767 | 0.84 | 0.675 |
| 1.86 | 0.872 | 2.22 | 0.872 | 2.1 | 0.767 |
| 3.17 | 0.991 | 3.58 | 0.991 | 3.84 | 0.872 |
| 4.63 | 1.13 | 4.96 | 1.13 | 5.77 | 0.991 |
| 6.21 | 1.28 | 6.24 | 1.28 | 7.62 | 1.13 |
| 7.97 | 1.45 | 7.46 | 1.45 | 9.29 | 1.28 |
| 10.02 | 1.65 | 8.74 | 1.65 | 10.85 | 1.45 |
| 12.46 | 1.88 | 10.21 | 1.88 | 12.46 | 1.65 |
| 15.33 | 2.13 | 11.99 | 2.13 | 14.3 | 1.88 |
| 18.6 | 2.42 | 14.13 | 2.42 | 16.49 | 2.13 |
| 22.21 | 2.75 | 16.63 | 2.75 | 19.09 | 2.42 |
| 26.12 | 3.12 | 19.48 | 3.12 | 22.09 | 2.75 |
| 30.3 | 3.55 | 22.63 | 3.55 | 25.44 | 3.12 |
| 34.73 | 4.03 | 26.06 | 4.03 | 29.1 | 3.55 |
| 39.42 | 4.58 | 29.74 | 4.58 | 33.02 | 4.03 |
| 44.33 | 5.21 | 33.63 | 5.21 | 37.17 | 4.58 |
| 49.4 | 5.92 | 37.64 | 5.92 | 41.48 | 5.21 |
| 54.54 | 6.72 | 41.68 | 6.72 | 45.85 | 5.92 |
| 59.53 | 7.64 | 45.62 | 7.64 | 50.18 | 6.72 |
| 64.53 | 8.68 | 49.35 | 8.68 | 54.33 | 7.64 |
| 69.12 | 9.86 | 52.78 | 9.86 | 58.2 | 8.68 |
| 73.29 | 11.2 | 55.88 | 11.2 | 61.7 | 9.86 |
| 76.99 | 12.7 | 58.62 | 12.7 | 64.79 | 11.2 |
| 80.21 | 14.5 | 61.05 | 14.5 | 67.48 | 12.7 |
| 83.02 | 18.4 | 63.25 | 16.4 | 69.83 | 14.5 |
| 85.48 | 18.7 | 65.27 | 18.7 | 71.88 | 16.4 |
| 87.71 | 21.2 | 67.2 | 21.2 | 73.72 | 18.7 |
| 89.8 | 24.1 | 69.06 | 24.1 | 75.39 | 21.2 |
| 91.79 | 27.4 | 70.87 | 27.4 | 76.91 | 24.1 |
| 93.7 | 31.1 | 72.59 | 31.1 | 78.27 | 27.4 |
| 95.48 | 35.3 | 74.21 | 35.3 | 79.48 | 31.1 |
| 97.07 | 40.1 | 75.71 | 40.1 | 80.52 | 35.3 |
| 98.36 | 45.6 | 77.09 | 45.6 | 81.44 | 40.1 |
| 99.27 | 51.8 | 78.39 | 51.8 | 82.31 | 45.6 |
| 99.8 | 58.9 | 79.7 | 58.9 | 83.25 | 51.8 |
| 100 | 66.9 | 81.11 | 66.9 | 84.39 | 58.9 |
| | | 82.72 | 76 | 85.85 | 66.9 |
| | | 84.63 | 86.4 | 87.69 | 76 |
| | | 86.87 | 98.1 | 89.88 | 86.4 |
| | | 89.38 | 111 | 92.32 | 98.1 |
| | | 92.04 | 127 | 94.77 | 111 |
| | | 94.61 | 144 | 96.95 | 127 |
| | | 96.86 | 163 | 98.62 | 144 |
| | | 98.55 | 186 | 99.63 | 163 |
| | | 99.6 | 211 | 100 | 186 |
| | | 100 | 240 | | |
| Source data for | | Source data for | | Source data for | |
| FIG. 11C | | FIG. 11D | | FIG. 12 | |
| % Volume Under | Size (μm) | % Volume Under | Size (μm) | % Volume Under | Size (μm) |
| 0 | 0.523 | 0 | 0.523 | 0 | 0.594 |
| 0.25 | 0.594 | 0.07 | 0.594 | 0.28 | 0.675 |
| 1.1 | 0.675 | 0.56 | 0.675 | 0.9 | 0.767 |
| 2.66 | 0.767 | 1.7 | 0.767 | 1.82 | 0.872 |
| 4.76 | 0.872 | 3.42 | 0.872 | 2.87 | 0.991 |
| 7.05 | 0.991 | 5.43 | 0.991 | 3.85 | 1.13 |
| 9.21 | 1.13 | 7.44 | 1.13 | 4.72 | 1.28 |
| 11.13 | 1.28 | 9.3 | 1.28 | 5.47 | 1.45 |
| 12.89 | 1.45 | 11.03 | 1.45 | 6.22 | 1.65 |
| 14.71 | 1.65 | 12.82 | 1.65 | 7.09 | 1.88 |
| 15.79 | 1.88 | 14.83 | 1.88 | 8.18 | 2.13 |
| 19.28 | 2.13 | 17.21 | 2.13 | 9.52 | 2.42 |
| 22.24 | 2.42 | 20 | 2.42 | 11.1 | 2.75 |
| 25.67 | 2.75 | 23.21 | 2.75 | 12.92 | 3.12 |
| 29.51 | 3.12 | 26.79 | 3.12 | 14.94 | 3.55 |
| 33.7 | 3.55 | 30.68 | 3.55 | 17.21 | 4.03 |
| 38.2 | 4.03 | 34.85 | 4.03 | 19.77 | 4.58 |
| 42.95 | 4.58 | 39.35 | 4.58 | 22.68 | 5.21 |
| 47.88 | 5.21 | 43.83 | 5.21 | 26.02 | 5.92 |
| 52.87 | 5.92 | 48.49 | 5.92 | 29.82 | 6.72 |
| 57.8 | 6.72 | 53.13 | 6.72 | 34.1 | 7.64 |
| 62.54 | 7.64 | 57.64 | 7.64 | 38.84 | 8.68 |
| 66.94 | 8.68 | 61.9 | 8.68 | 43.96 | 9.86 |
| 70.92 | 9.86 | 65.83 | 9.86 | 49.38 | 11.2 |
| 74.4 | 11.2 | 69.38 | 11.2 | 54.93 | 12.7 |
| 77.37 | 12.7 | 72.51 | 12.7 | 60.47 | 14.5 |
| 79.85 | 14.5 | 75.33 | 14.5 | 65.82 | 16.4 |
| 81.88 | 16.4 | 77.55 | 16.4 | 70.82 | 18.7 |
| 83.52 | 18.7 | 79.54 | 18.7 | 75.33 | 21.2 |
| 84.83 | 21.2 | 81.25 | 21.2 | 79.28 | 24.1 |
| 85.85 | 24.1 | 82.76 | 24.1 | 82.61 | 27.4 |
| 86.63 | 27.4 | 84.18 | 27.4 | 85.37 | 31.1 |
| 87.22 | 31.1 | 85.63 | 31.1 | 87.64 | 35.3 |
| 87.69 | 35.3 | 87.22 | 35.3 | 89.54 | 40.1 |
| 88.12 | 40.1 | 89.04 | 40.1 | 91.21 | 45.6 |
| 88.63 | 45.6 | 91.1 | 45.6 | 92.76 | 51.8 |
| 88.33 | 51.8 | 93.33 | 51.8 | 94.27 | 58.9 |
| 90.3 | 58.8 | 95.54 | 58.9 | 95.75 | 66.9 |
| 91.61 | 66.9 | 97.49 | 66.9 | 97.12 | 76 |
| 93.21 | 76 | 98.94 | 76 | 98.31 | 86.4 |
| 94.99 | 86.4 | 99.78 | 86.4 | 99.2 | 98.1 |
| 96.75 | 98.1 | 100 | 98.1 | 99.76 | 111 |
| 98.27 | 111 | | | 100 | 127 |
| 99.36 | 127 | | | | |
| 99.93 | 144 | | | | |
| 100 | 163 | | | | |
| Source data for | | Source data for | | Source data for | |
| FIG. 13 | | FIG. 14 | | FIG. 15 | |
| % Volume Under | Size (μm) | % Volume Under | Size (μm) | % Volume Under | Size (μm) |
| 0 | 0.523 | 0 | 0.523 | 0 | 0.523 |
| 0.24 | 0.594 | 0.16 | 0.594 | 0.21 | 0.594 |
| 1.3 | 0.675 | 0.82 | 0.675 | 1.12 | 0.675 |
| 3.43 | 0.767 | 2.13 | 0.767 | 2.94 | 0.767 |
| 6.43 | 0.872 | 3.98 | 0.872 | 5.53 | 0.872 |
| 9.81 | 0.991 | 6.07 | 0.991 | 8.46 | 0.991 |
| 13.06 | 1.13 | 8.13 | 1.13 | 11.34 | 1.13 |
| 15.96 | 1.28 | 10.05 | 1.28 | 13.99 | 1.28 |
| 18.6 | 1.45 | 11.9 | 1.45 | 16.48 | 1.45 |
| 21.28 | 1.65 | 13.9 | 1.65 | 19.08 | 1.65 |
| 24.32 | 1.88 | 16.25 | 1.88 | 22.06 | 1.88 |
| 27.92 | 2.13 | 19.14 | 2.13 | 25.65 | 2.13 |
| 32.17 | 2.42 | 22.61 | 2.42 | 29.99 | 2.42 |
| 36.97 | 2.75 | 26.67 | 2.75 | 35.12 | 2.75 |
| 42.17 | 3.12 | 31.19 | 3.12 | 41.02 | 3.12 |
| 47.6 | 3.55 | 36.07 | 3.55 | 47.65 | 3.55 |
| 53.12 | 4.03 | 41.18 | 4.03 | 54.97 | 4.03 |
| 58.63 | 4.58 | 46.43 | 4.58 | 62.85 | 4.58 |
| 64.1 | 5.21 | 51.7 | 5.21 | 71.03 | 5.21 |
| 69.46 | 5.92 | 56.87 | 5.92 | 79.07 | 5.92 |
| 74.7 | 6.72 | 61.82 | 6.72 | 86.41 | 6.72 |
| 79.74 | 7.64 | 66.43 | 7.64 | 92.45 | 7.64 |
| 84.51 | 8.68 | 70.6 | 8.68 | 96.74 | 8.58 |
| 88.88 | 9.86 | 74.25 | 9.86 | 99.14 | 9.86 |
| 92.69 | 11.2 | 77.36 | 11.2 | 100 | 11.2 |
| 95.77 | 12.7 | 79.94 | 12.7 | | |
| 98 | 14.5 | 82.07 | 14.5 | | |
| 99.37 | 16.4 | 83.84 | 16.4 | | |
| 100 | 18.7 | 85.35 | 18.7 | | |
| | | 86.7 | 21.2 | | |
| | | 87.98 | 24.1 | | |
| | | 89.25 | 27.4 | | |
| | | 90.55 | 31.1 | | |
| | | 91.9 | 35.3 | | |
| | | 93.3 | 40.1 | | |
| | | 94.73 | 45.6 | | |
| | | 96.12 | 51.8 | | |
| | | 97.41 | 58.9 | | |
| | | 98.49 | 66.9 | | |
| | | 99.3 | 76 | | |
| | | 99.79 | 86.4 | | |
| | | 100 | 98.1 | | |
| Source data for | | Source data for | | Source data for | |
| FIG. 18 | | FIG. 19 | | FIG. 20 | |
| % Volume Under | Size (μm) | % Volume Under | Size (μm) | % Volume Under | Size (μm) |
| 0 | 0.594 | 0 | 0.523 | 0 | 0.523 |
| 0.38 | 0.675 | 0.07 | 0.594 | 0.07 | 0.594 |
| 1.28 | 0.767 | 0.47 | 0.675 | 0.51 | 0.675 |
| 2.68 | 0.872 | 1.36 | 0.767 | 1.48 | 0.767 |
| 4.35 | 0.991 | 2.68 | 0.872 | 2.91 | 0.872 |
| 6.07 | 1.13 | 4.22 | 0.991 | 4.58 | 0.991 |
| 7.71 | 1.28 | 5.75 | 1.13 | 6.23 | 1.13 |
| 9.31 | 1.45 | 7.18 | 1.28 | 7.75 | 1.28 |
| 11 | 1.65 | 8.56 | 1.45 | 9.18 | 1.45 |
| 12.92 | 1.88 | 10.03 | 1.65 | 10.67 | 1.65 |
| 15.18 | 2.13 | 11.76 | 1.88 | 12.4 | 1.88 |
| 17.84 | 2.42 | 13.87 | 2.13 | 14.47 | 2.13 |
| 20.91 | 2.75 | 16.42 | 2.42 | 16.93 | 2.42 |
| 24.36 | 3.12 | 19.4 | 2.75 | 19.78 | 2.75 |
| 28.18 | 3.55 | 22.77 | 3.12 | 22.98 | 3.12 |
| 32.36 | 4.03 | 26.48 | 3.55 | 26.49 | 3.55 |
| 36.87 | 4.58 | 30.47 | 4.03 | 30.29 | 4.03 |
| 41.63 | 5.21 | 34.69 | 4.58 | 34.36 | 4.58 |
| 46.51 | 5.92 | 39.06 | 5.21 | 38.66 | 5.21 |
| 51.33 | 6.72 | 43.48 | 5.92 | 43.11 | 5.92 |
| 55.93 | 7.64 | 47.84 | 6.72 | 47.6 | 6.72 |
| 60.15 | 8.68 | 32 | 7.64 | 51.99 | 7.64 |
| 63.87 | 9.86 | 55.86 | 8.68 | 56.16 | 8.68 |
| 67.07 | 11.2 | 59.34 | 9.86 | 59.99 | 9.86 |
| 69.76 | 12.7 | 62.43 | 11.2 | 63.42 | 11.2 |
| 72.04 | 14.5 | 65.14 | 12.7 | 66.42 | 12.7 |
| 74.03 | 16.4 | 67.56 | 14.5 | 69.05 | 14.5 |
| 75.83 | 18.7 | 69.77 | 16.4 | 71.39 | 16.4 |
| 77.54 | 21.2 | 71.86 | 18.7 | 73.51 | 18.7 |
| 79.21 | 24.1 | 73.89 | 21.2 | 75.49 | 21.2 |
| 80.87 | 27.4 | 75.88 | 24.1 | 77.38 | 24.1 |
| 82.52 | 31.1 | 77.81 | 27.4 | 79.19 | 27.4 |
| 84.17 | 35.3 | 79.66 | 31.1 | 80.91 | 31.1 |
| 85.81 | 40.1 | 81.4 | 35.3 | 82.54 | 35.3 |
| 87.47 | 45.6 | 83.01 | 40.1 | 84.09 | 40.1 |
| 89.16 | 51.8 | 84.51 | 45.6 | 85.59 | 45.6 |
| 90.87 | 58.9 | 85.95 | 51.8 | 87.11 | 51.8 |
| 92.59 | 66.9 | 87.41 | 58.9 | 88.7 | 58.9 |
| 94.31 | 76 | 88.95 | 66.9 | 90.41 | 66.9 |
| 95.94 | 86.4 | 90.64 | 76 | 92.25 | 76 |
| 97.42 | 98.1 | 92.46 | 86.4 | 94.15 | 86.4 |
| 95.63 | 111 | 94.37 | 98.1 | 96.01 | 98.1 |
| 99.48 | 127 | 96.22 | 111 | 97.66 | 111 |
| 99.93 | 144 | 97.83 | 127 | 98.92 | 127 |
| 100 | 163 | 99.04 | 144 | 99.7 | 144 |
| | | 99.76 | 163 | 100 | 163 |
| | | 100 | 186 | | |

What is claimed is:

1. A whole grain crude tahini, wherein when measured by dynamic image analysis using a QICPIC instrument with a USER filter based on LEFI in combination with elongation and straightness for selecting fiber-like particles for evaluation, in a wet dispersion in Isopar G, using a volume-based size distribution and a cylindrical-volume model for the particles, said whole grain crude tahini is characterized by a fiber-like particle population having straightness s50 value lower than 0.777.

2. The crude tahini of claim 1, wherein said fiber-like particle population has straightness s50 value lower than 0.620, or from 0.620 to 0.760.

3. The crude tahini of claim 1, wherein said fiber-like particle population has straightness s10 value lower than 0.559, and/or straightness s90 value lower than 0.904.

4. The crude tahini of claim 1, wherein said fiber-like particle population has (a) LEFI ×50 value lower than 62.40 μm; and/or (b) elongation s50 value lower than 0.080; and/or (c) DIFI s50 value lower than 4.46.

5. The crude tahini of claim 4, wherein said fiber-like particle population has (a) LEFI ×50 value from 20.00 μm to 62.00 μm; and/or (b) elongation s50 value from 0.071 to 0.079; and/or (c) DIFI s10 value lower than 2.55, and/or DIFI s90 value lower than 8.74.

6. The crude tahini of claim 1, wherein said crude tahini has been prepared by a process comprising microfluidization of a paste made of (a) unhulled sesame seeds; (b) hulled sesame seeds in combination with sesame hulls; or (c) a combination of unhulled sesame seeds, hulled sesame seeds, and optionally sesame hulls, at a pressure of at least 5,000 PSI.

7. The crude tahini of claim 6, wherein said crude tahini has been prepared by a process comprising microfluidization of said paste at a pressure of at least 20,000 PSI.

8. The crude tahini of claim 6, wherein said paste has been prepared by grinding (a) unhulled sesame seeds; (b) hulled sesame seeds in combination with sesame hulls; or (c) a combination of unhulled sesame seeds, hulled sesame seeds, and optionally sesame hulls.

9. The crude tahini of claim 8, wherein said grinding is carried out using a ball mill, millstones, Macintyre grinder, Reifiner Conche, homogenizer, rotor-stator homogenizer, ultrasound, a homogenization technology capable of reaching shear force of at least 1,000,000 l/sec, or a combination thereof.

10. The crude tahini of claim 6, wherein under the same measurement conditions, said crude tahini exhibits straightness s50 value that is lower than that of a reference crude tahini, wherein said crude tahini and said reference crude tahini have both been prepared from the same paste, and the reference crude tahini differs from said crude tahini only in not having been subjected to microfluidization.

11. The crude tahini of claim 10, wherein the straightness s50 value of said crude tahini is at least 0.001 lower than that of said reference crude tahini.

12. The crude tahini of claim 10, wherein said crude tahini further exhibits LEFI ×50 value and/or elongation s50 value and/or DIFI s50 value, each being lower than that of said reference crude tahini.

13. The crude tahini of claim 12, wherein the LEFI ×50 value of said crude tahini is at least 0.02 μm lower than that of said reference crude tahini; and/or the elongation s50 value of said crude tahini is at least 0.001 lower than that of said reference crude tahini; and/or the DIFI s50 value of said crude tahini is at least 0.02 μm lower than that of said reference crude tahini.

14. The crude tahini of claim 10, wherein said crude tahini has a viscosity lower than that of said reference crude tahini.

15. The crude tahini of claim 1, wherein said crude tahini is free of stable sediment upon storage of at least 2 years, and wherein any sediment formed during said storage is readily redispersible upon gentle shaking or mixing.

16. An oily seed product, wherein said product has been prepared by a process comprising microfluidization of an oily seed paste at a pressure of at least 5,000 PSI,
wherein when measured by dynamic image analysis using a QICPIC instrument with a USER filter based on LEFI in combination with elongation and straightness for selecting fiber-like particles for evaluation, in a wet dispersion in Isopar G, using a volume-based size distribution and a cylindrical-volume model for the particles, said product is characterized by a fiber-like particle population having straightness s50 value lower than that of a reference product measured under the same measurement conditions, wherein said product and said reference product have both been prepared from the same starting oily seeds, and the reference product differs from said product only in not having been subjected to microfluidization.

17. The product of claim 16, wherein said fiber-like particle population has straightness s50 value that is at least 0.002 lower than that of said reference product.

18. The product of claim 16, wherein said fiber-like particle population has LEFI ×50 value and/or elongation s50 value and/or DIFI s50 value, each being lower than that of said reference product.

19. The product of claim 18, wherein said fiber-like particle population has LEFI ×50 value that is at least 0.02 μm lower than that of said reference product; and/or elongation s50 value that is at least 0.001 lower than that of said reference product; and/or DIFI s50 value that is at least 0.02 μm lower than that of said reference product.

20. The product of claim 16, wherein said product has a viscosity lower than that of said reference product.

21. The product of claim 16, wherein said product has been prepared by a process comprising microfluidization of said oily seed paste at a pressure of at least 20,000 PSI.

22. The product of claim 16, wherein said oily seed paste has been prepared by grinding said oily seeds.

23. The product of claim 22, wherein said grinding is carried out using a ball mill, millstones, Macintyre grinder, Reifiner Conche, homogenizer, rotor-stator homogenizer, ultrasound, a homogenization technology capable of reaching shear force of at least 1,000,000 l/sec, or a combination thereof.

24. The product of claim 16, wherein said oily seeds are selected from the group consisting of white sesame, red sesame, black sesame, nigella, peanuts, pistachios, almonds, nuts, Brazil nuts, macadamia nuts, hazelnuts, pecans, cashews, olives, sunflower seeds, corn kernels, wheat kernels, soybeans, rapeseeds, cottonseeds, flaxseeds, safflower seeds, mustard seeds, hemp seeds, poppy seeds, castor seeds, pumpkin seeds, Niger seeds, palm kernel, coconuts, perilla seeds, camelina seeds, chia seeds, black cumin seeds, sacha inchi seeds, moringa seeds, karanja seeds, watermelon seeds, coriander seeds, pomegranate seeds, grape seeds, prickly pear seeds, baobab seeds, tomato seeds, and red raspberry seeds.

25. The product of claim 24, wherein:
(a) said oily seeds are hulled sesame seeds, and said product is a crude tahini; or
(b) said oily seeds are unhulled sesame seeds; hulled sesame seeds in combination with sesame hulls; or a combination of unhulled sesame seeds, hulled sesame seeds, and optionally sesame hulls, and said product is whole grain crude tahini; or
(c) said oily seeds are olives, and said product is a processed olive product.

26. The product of claim 25, wherein:
(a) said product is a crude tahini, which is characterized by a fiber-like particle population having straightness s50 value lower than 0.748; and/or LEFI ×50 value lower than 43.57 μm; and/or elongation s50 value lower than 0.084; and/or DIFI s50 value lower than 3.35 μm; or
(b) said product is a whole grain crude tahini, which is characterized by a fiber-like particle population having straightness s50 value lower than 0.777; and/or LEFI ×50 value lower than 62.40 μm; and/or elongation s50 value lower than 0.080; and/or DIFI s50 value lower than 4.46 μm.

27. The product of claim 25, wherein said paste is crude tahini or whole grain crude tahini, and said paste is free of stable sediment upon storage of at least 2 years, and wherein any sediment formed during said storage is readily redispersible upon gentle shaking or mixing.

28. A composition comprising a whole grain crude tahini according to claim 1 and probiotic bacteria, formulated for oral administration.

29. The composition of claim 28, wherein said probiotic bacteria are selected from the group consisting of a Lactobacillus species, Bifidobacterium species, Enterococcus species, Streptococcus species, Pediococcus species, Leuconostoc species, Bacillus species, Escherichia species, and a combination thereof.

30. The composition of claim 29, wherein said Lactobacillus species is Lactobacillus acidophilus, Lactobacillus casei, or Lactobacillus plantarum; and said Bifidobacterium species is selected from the group consisting of Bifidobacterium pseudocatenulatum, Bifidobacterium animalis, Bifidobacterium bifidum, Bifidobacterium longum, Bifidobacterium infantis, and Bifidobacterium breve.

31. The composition of claim 28, further comprising at least one polyphenol originating from a plant source other than sesame seeds.

32. The composition of claim 31, wherein said at least one polyphenol comprises an extract from at least one item selected from the group consisting of seeds, beans, whole grains, nuts, fruits, and leaves, of a plant.

33. The composition of claim 32, wherein said polyphenol comprises an extract from grapes, tea, pomegranates, dates, berries, olives, coffee beans, and/or cocoa beans.

34. The composition of claim 32, wherein said polyphenol comprises a green tea extract (GTE), grape seed extract (GSE), or a combination thereof.

35. The composition of claim 34, wherein said GTE is an aqueous ethanol extract obtained from Camellia sinensis leaves; and/or said GSE is an aqueous extract obtained from Californian grape varieties including Ruby red grape variety; and/or said polyphenol comprises epigallocatechin gallate (EGCG).

36. The composition of claim 28, wherein said whole grain crude tahini comprises sesamin in an amount of from about 200 to about 11000 mcg/g; sesamolin in an amount of from about 100 to about 8500 mcg/g; and sesamol in an amount of from about 10 to about 5000 mcg/g.

37. The composition of claim 28, in the form of a liquid, semi-solid, or solid; or being an oral dosage form comprising a pH-dependent enteric-coating polymer capable of protecting said composition from gastric (stomach) acidity.

38. The composition of claim 37, wherein said pH-dependent enteric-coating polymer is selected from the group consisting of hydroxypropyl methylcellulose (HPMC), hydroxypropyl methylcellulose phthalate (HPMCP), poly(methacrylicacid, methylmethacrylate, 1:2, poly(methacrylicacid, ethylacrylate, 1:1, poly(methacrylicacid, ethylacrylate, 1:1, alginates, carboxymethylcellulose, and combinations thereof.

39. A composition comprising an oily seed product according to claim 16 and probiotic bacteria, formulated for oral administration.

40. The composition of claim 39, further comprising at least one polyphenol originating from a plant source other than said oily seeds.

41. A food product, food (nutrition) additive or supplement, or medical food, comprising a composition according to claim 28.

42. A food product, food (nutrition) additive or supplement, or medical food, comprising a composition according to claim 39.
